(19) United States
(12) Patent Application Publication
(10) Pub. No.: US 2012/0001839 A1
(43) Pub. Date: Jan. 5, 2012

(54) ACTIVE MATRIX SUBSTRATE, LIQUID CRYSTAL PANEL, LIQUID CRYSTAL DISPLAY DEVICE, LIQUID CRYSTAL DISPLAY UNIT, AND TELEVISION RECEIVER

(75) Inventor: Toshihide Tsubata, Osaka (JP)

(73) Assignee: SHARP KABUSHIKI KAISHA, Osaka (JP)

(21) Appl. No.: 13/254,788

(22) PCT Filed: Oct. 30, 2009
(86) PCT No.: PCT/JP2009/068713

§ 371 Date: Sep. 2, 2011

(30) Foreign Application Priority Data
Mar. 5, 2009 (JP) 2009-052593

(51) Int. Cl. G09G 3/36

(52) U.S. Cl. 345/90

(57) ABSTRACT

Disclosed is a liquid crystal panel that includes a scan signal line (16x), a data signal line (15x), and a transistor (12a), where a single pixel (101) has pixel electrodes (17a and 17b). The pixel electrode (17a) is connected to the data signal line (15x) through the transistor (12a). A capacitance electrode (37a) provided in the pixel (101) is connected to one of the pixel electrodes (17a) through first and second contact holes (41a and 42a), and forms a capacitance with the other of the pixel electrodes (17b). The drain electrode (9a) of the transistor (12a) is connected to the pixel electrode (17a) through a third contact hole (67a). Consequently, the production yield of the active matrix substrate of the capacitance coupling type pixel division system and the liquid crystal panel having such an active matrix substrate can be improved without lowering the aperture ratio.

### TECHNICAL FIELD

The present invention relates to an active matrix substrate having a plurality of pixel electrodes in a single pixel region, and also relates to a liquid crystal display device (pixel division system) using such an active matrix substrate.

### BACKGROUND ART

In order to improve the dependence of view angle of γ (gamma) characteristics of a liquid crystal display device (to suppress the display whitening problem or the like, for example), a liquid crystal display device in which a plurality of sub-pixels provided in a single pixel are controlled for different luminance levels to display halftones by area gradation of the sub-pixels (pixel division system; see Patent Document 1, for example) is being proposed.

As shown in FIG. 48, the active matrix substrate disclosed in Patent Document 1 has, in each of the pixel regions, a transistor (TFT) 156, a control electrode 157, auxiliary capacitance electrode 158, and two pixel electrodes 161a and 161b. The two pixel electrodes 161a and 161b are arranged along the data signal line 155. A source electrode 156s of the transistor (TFT) 156 is electrically connected to the control electrode 157 and the auxiliary capacitance electrode 158 via a wiring 159. The pixel electrode 161b is electrically connected to the auxiliary capacitance electrode 158 through a contact hole 160a formed in an insulating film. The pixel electrode 161a, which is electrically floating, overlaps the control electrode 157 through the insulating layer. As a result, the pixel electrode 161a is capacitively coupled with the pixel electrode 161b (capacitance coupling type pixel division system).

In the liquid crystal display device using such an active matrix substrate, the sub-pixel corresponding to the pixel electrode 161b can be a bright sub-pixel, and the sub-pixel corresponding to the pixel electrode 161a can be a dark sub-pixel. Halftone display can be conducted by area gradation of the bright and dark sub-pixels.

### RELATED ART DOCUMENTS

### Patent Documents

Patent Document 1: Japanese Patent Application Laid-Open Publication No. 2006-39290 (Publication date: Feb. 9, 2006)

### SUMMARY OF THE INVENTION

### Problems to be Solved by the Invention

In the case of the active matrix substrate of FIG. 48, however, if satisfactory connection is not established between the auxiliary capacitance electrode 158 and the pixel electrode 161b because the contact hole 160a, for example, is not fully formed in the interlayer insulating film during the manufacturing process, signal potentials from the data signal line are not accurately transmitted to the pixel electrodes 161a and 161b.

Thus, with the conventional active matrix substrate, contact failure through the contact hole can result in a defective pixel, which can reduce the production yield.

Patent Document 1 also proposes another example of the active matrix substrate configuration, which is shown in FIG. 49. The active matrix substrate shown in FIG. 49 also has two pixel electrodes 151a and 151b in a single pixel region. In FIG. 49, however, the shapes of the pixel electrodes are different from those of FIG. 48. That is, the pixel electrode 151a, which is electrically floating, is surrounded by the pixel electrode 151b. The pixel electrode 151b is electrically connected to a source electrode 116s of the transistor (TFT) 116 through two contact holes 120a and 120b and a wiring 119.

However, the wiring 119 of the active matrix substrate of FIG. 49, which is led out from the source electrode 116a of TFT 116, is long, and therefore is more likely to break. Also, because the wiring 119 stretches over a long distance on the pixel electrode, the aperture ratio is reduced accordingly.

In consideration of the issues described above, the present invention provides a configuration of the active matrix substrate of the capacitance coupling type pixel division system that can improve the production yield without lowering the aperture ratio.

### Means for Solving the Problems

The present active matrix substrate includes scan signal lines, data signal lines, and transistors connected to the scan signal lines and the data signal lines, where first and second pixel electrodes are provided in a single pixel region. The first pixel electrode is connected to the data signal line through the transistor, and a capacitance electrode is electrically connected to one of the first and second pixel electrodes. The capacitance electrode is connected to the one of the pixel electrodes through first and second contact holes, and forms a capacitance with the other one of the first and second pixel electrodes. One of the conductive electrodes of the transistor is connected to the first pixel electrode through a third contact hole.

With this configuration, the active matrix substrate of the capacitance coupling type pixel division system includes two contact holes (first and second contact holes) for one capacitance electrode that capacitively couples the first and second pixel electrodes that are provided in a single pixel region. Consequently, even if one of the contact holes is not formed properly during the manufacturing process and develop problems such as contact failure, the capacitance coupling of the first and second pixel electrodes can be maintained through the other contact hole.

Also, in the above configuration, the capacitance electrode is connected to one of the pixel electrodes through the first and the second contact holes. As a result, independent of the connection between the first pixel electrode and the data signal line through the transistor, the capacitance electrode and the pixel electrode can be connected together. Consequently, the capacitance electrode can be arranged with a higher degree of freedom. Also, because the configuration eliminates the need to make the wiring led out from the transistor long, reduction in the aperture ratio can be suppressed accordingly.

With this configuration, production yield of the present active matrix substrate and the liquid crystal panel equipped with the present active matrix substrate can be improved without lowering the aperture ratio.

For the present active matrix substrate, one of the conductive electrodes of the transistor and the capacitance electrode may be formed in the same layer. With this configuration, the layered structure and the manufacturing process of the active matrix substrate can be simplified.

The present active matrix substrate may also have a configuration in which at least a portion of the capacitance electrode overlaps with the other one of the pixel electrodes through an interlayer insulating film that covers the channel of the transistor.

The present active matrix substrate may also have a configuration in which the perimeters of the first and the second pixel electrodes are composed of a plurality of sides, one side of the first pixel electrode and one side of the second pixel electrode are adjacent to each other, and the capacitance electrode is disposed to overlap a portion of the gap between the adjacent sides, and to overlap a portion of the first pixel electrode and a portion of the second pixel electrode.

The present active matrix substrate may also have a configuration in which one of the conductive electrodes of the transistor and the capacitance electrode are isolated from each other, the capacitance electrode is connected to the first pixel electrode through the first and second contact holes, and a capacitance is formed between the capacitance electrode and the second pixel electrode.

According to the configuration described above, the aperture ratio reduction can further be suppressed, because one of the conductive electrodes of the transistor and the capacitance electrode are isolated from each other, and the conductive electrode and the capacitance electrode are connected to the first pixel electrode through different contact holes.

The present active matrix substrate may also have a configuration in which the capacitance electrode is connected to the second pixel electrode through the first and second contact holes, and a capacitance is formed between the capacitance electrode and the first pixel electrode.

The present active matrix substrate may also have a configuration in which the first and second pixel electrodes are arranged in a column direction when scan signal lines extend in a row direction.

The aforementioned active matrix substrate may also have a configuration in which the first and second pixel electrodes are arranged in the column direction when the scan signal line extends in the row direction, and the first pixel electrode in one of the two neighboring pixel regions arranged in the row direction and the second pixel electrode in the other of the two pixel regions are adjacent to each other in the row direction.

The present active matrix substrate may also have a configuration in which the first pixel electrode surrounds the second pixel electrode.

The present active matrix substrate may also have a configuration in which the second pixel electrode surrounds the first pixel electrode.

The present active matrix substrate may further include a storage capacitance wiring that forms a capacitance with the one of the pixel electrodes or a conductive body electrically connected to the one of the pixel electrodes, and that forms a capacitance with the other one of the pixel electrodes or a conductive body electrically connected to the other one of the pixel electrodes. In this case, the storage capacitance wiring can also be configured to extend in the same direction as the scan signal line, passing through the center of the pixel region. Additionally, the capacitance electrode can also be configured to form a capacitance with the storage capacitance wiring.

The interlayer insulating film of the present active matrix substrate is composed of an inorganic insulating film and an organic insulating film that is thicker than the inorganic insulating film. The present active matrix substrate may also have a configuration in which the portion of the organic insulating film that overlaps with the capacitance electrode is at least partially removed.

The present active matrix substrate may also have a configuration in which the interlayer insulating film has a thin film portion, which includes a region overlapping with a part of the capacitance electrode, and is formed by removing the organic insulating film; the capacitance electrode is disposed along the direction in which the scan signal line extends; and the capacitance electrode crosses two opposing sides of the thin film portion.

As a result, in a configuration in which a capacitance is formed between the capacitance electrode and the first or second pixel electrode, for example, even if the capacitance electrode is misaligned in the row direction, the overlapping area of the capacitance electrode and the pixel electrode in the thin film portion is likely to be maintained constant, and therefore the total of the two capacitances (coupling capacitance) is likely to remain unchanged. This is a beneficial effect.

The present active matrix substrate may also have a configuration in which the thin film portion overlaps with one of the first or the second pixel electrode.

Consequently, with a configuration in which a capacitance is formed between the capacitance electrode and the first or second pixel electrode, for example, a short circuit is less likely to occur between the capacitance electrode and the first or second pixel electrode. This is another beneficial effect that can be obtained in addition to the beneficial effect described above.

The present active matrix substrate may also have a configuration in which the gap between the first and second pixel electrodes functions as an alignment control structure.

The present active matrix substrate may also have a configuration in which: the first pixel electrode surrounds the second pixel electrode; the perimeter of the second pixel electrode includes two sides that are parallel to each other; the perimeter of the first pixel electrode includes a side facing one of the two sides through a first gap, and a side facing the other of the two sides through a second gap; and a capacitance electrode is disposed across the first gap and the second gap, overlapping with a portion of the first pixel electrode and a portion of the second pixel electrode.

This configuration provides an advantage that, even if the first and second pixel electrodes are misaligned against the capacitance electrode in a direction perpendicular to the aforementioned gap, the overlapped area of the capacitance electrode and the second pixel electrode can be maintained constant, and therefore the total value of the coupling capacitance tends to remain unchanged.

The present active matrix substrate may also have a configuration in which, in addition to the first and second pixel electrodes, a third pixel electrode that is electrically connected to the first pixel electrode is further included in the single pixel region; the capacitance electrode is connected to the first pixel electrode through first and second contact holes, and forms a capacitance with the second pixel electrode; and a second capacitance electrode is further included, which is connected to the third pixel electrode through fourth and fifth contact holes and forms a capacitance with the second pixel electrode.

The present active matrix substrate may also have a configuration in which, in addition to the first and second pixel electrodes, a third pixel electrode that is electrically connected to the first pixel electrode is further included in the single pixel region; the capacitance electrode is connected to the second pixel electrode through the first and second contact holes and forms a capacitance with the first pixel electrode; and a second capacitance electrode is further included, which is connected to the second pixel electrode through the fourth and fifth contact holes and forms a capacitance with the third pixel electrode.

The present active matrix substrate may also have a configuration in which, in addition to the first and the second pixel electrodes, a third pixel electrode is further included in the single pixel region; the capacitance electrode is connected to the first pixel electrode through the first and second contact holes and forms a capacitance with the second pixel electrode; and a second capacitance electrode is further included, which is connected to the first pixel electrode through the fourth and fifth contact holes and forms a capacitance with the third pixel electrode.

The present active matrix substrate may also have a configuration in which, in addition to the first and the second pixel electrodes, a third pixel electrode is further included in the single pixel region; the capacitance electrode is connected to the second pixel electrode through the first and second contact holes and forms a capacitance with the first pixel electrode; and a second capacitance electrode is further included, which is connected to the third pixel electrode through the fourth and fifth contact holes and forms a capacitance with the first pixel electrode.

The present active matrix substrate may also have a configuration in which first and second storage capacitance wirings are further included in the pixel region; the capacitance electrode forms a capacitance with the first storage capacitance wiring; and the second capacitance electrode forms a capacitance with the second storage capacitance wiring.

The present active matrix substrate may also have a configuration in which the capacitance electrode is formed in the same layer with the scan signal line.

The present active matrix substrate may also have a configuration in which the capacitance electrode overlaps with the other of the pixel electrodes through a gate insulating film that covers the scan signal line and an interlayer insulating film that covers the channel of the transistor.

The present active matrix substrate may also have a configuration in which a third capacitance electrode is further included, which overlaps with the capacitance electrode through the gate insulating film and is electrically connected to the other of the pixel electrodes, and the capacitance electrode forms a capacitance with the third capacitance electrode.

The present active matrix substrate may also have a configuration in which the third capacitance electrode overlaps the other of the pixel electrodes through the interlayer insulating film.

The present active matrix substrate may also have a configuration in which the third capacitance electrode is electrically connected to the other of the pixel electrodes through two contact holes.

The present active matrix substrate may also have a configuration in which the capacitance electrode and the one of the pixel electrodes are connected together through the first and the second contact holes that run through the gate insulating film and the interlayer insulating film.

A liquid crystal panel according to the present invention is characterized in that it is equipped with the aforementioned active matrix substrate. Also, a liquid crystal display unit according to the present invention is characterized in that it is equipped with the aforementioned liquid crystal panel and drivers. Additionally, a liquid crystal display device according to the present invention is characterized in that it includes the aforementioned liquid crystal display unit and a light source device. Also, a television receiver according to the present invention is characterized in that it includes the aforementioned liquid crystal display device and a tuner unit that receives the television broadcasting.

### Effects of the Invention

As described above, an aspect of the present invention is an active matrix substrate of the capacitance coupling type pixel division system in which a capacitance electrode electrically connected to one of a first or second pixel electrode is included, and the capacitance electrode is connected to the one of the pixel electrodes through first and second contact holes and forms a capacitance with the other one of the first or second pixel electrode.

Consequently, the manufacturing yield of the active matrix substrate and the liquid crystal panel equipped with the active matrix substrate can be improved without lowering the aperture ratio.

### BRIEF DESCRIPTION OF THE DRAWINGS

FIG. 1 is a circuit diagram showing the configuration of a liquid crystal panel according to Embodiment 1.

FIG. 2 is a plan view showing a specific example of the liquid crystal panel of FIG. 1.

FIG. 3 is a cross-sectional arrow view taken along the line A-B of FIG. 2.

FIG. 4 is a cross-sectional arrow view of a modified configuration of FIG. 2, taken along the line A-B.

FIG. 5 is a timing chart showing the driving method of a liquid crystal display device equipped with the liquid crystal panel of FIG. 1.

FIG. 6 is a schematic view showing the display state of respective frames when the driving method of FIG. 5 is used.

FIG. 7 is a plan view showing another specific example of the liquid crystal panel shown in FIG. 1.

FIG. 8 is a plan view showing a method of repairing the liquid crystal panel of FIG. 2.

FIG. 9 is a plan view showing another specific example of the liquid crystal panel shown in FIG. 1.

FIG. 10 is a plan view showing another specific example of the liquid crystal panel shown in FIG. 1.

FIG. 11 is a circuit diagram showing another configuration of a liquid crystal panel according to Embodiment 1.

FIG. 12 is a schematic view showing the display state of respective frames when the drive method of FIG. 5 is used for a liquid crystal display device equipped with the liquid crystal panel of FIG. 11.

FIG. 13 is a plan view showing a specific example of the liquid crystal panel shown in FIG. 11.

FIG. 14 is a circuit diagram showing another configuration of a liquid crystal panel according to Embodiment 1.

FIG. 15 is a plan view showing a specific example of the liquid crystal panel shown in FIG. 14.

FIG. 16 is a circuit diagram showing a configuration of the liquid crystal panel according to Embodiment 2.

FIG. 17 is a plan view showing a specific example of the liquid crystal panel shown in FIG. 16.

FIG. 18 is a plan view showing another specific example of the liquid crystal panel shown in FIG. 16.

FIG. 19 is a plan view showing another specific example of the liquid crystal panel shown in FIG. 16.

FIG. 20 is a plan view showing another specific example of the liquid crystal panel shown in FIG. 16.

FIG. 21 is a plan view showing another specific example of the liquid crystal panel shown in FIG. 16.

FIG. 22 is a plan view showing another specific example of the liquid crystal panel shown in FIG. 16.

FIG. 23 is a circuit diagram showing another configuration of the liquid crystal panel according to Embodiment 2.

FIG. 24 is a plan view showing a specific example of the liquid crystal panel shown in FIG. 23.

FIG. 25 is a circuit diagram showing another configuration of the liquid crystal panel according to Embodiment 2.

FIG. 26 is a plan view showing a specific example of the liquid crystal panel shown in FIG. 25.

FIG. 27 is a plan view showing another specific example of the liquid crystal panel shown in FIG. 25.

FIG. 28 is a plan view showing another specific example of the liquid crystal panel shown in FIG. 25.

FIG. 29 is a circuit diagram showing the configuration of the liquid crystal panel according to Embodiment 3.

FIG. 30 is a plan view showing a specific example of the liquid crystal panel shown in FIG. 29.

FIG. 31 is a plan view showing another specific example of the liquid crystal panel shown in FIG. 29.

FIG. 32 is a plan view showing another specific example of the liquid crystal panel shown in FIG. 29.

FIG. 33 is a circuit diagram showing another configuration of the liquid crystal panel according to Embodiment 4.

FIG. 34 is a plan view showing a specific example of the liquid crystal panel shown in FIG. 33.

FIG. 35 is a plan view showing another specific example of the liquid crystal panel shown in FIG. 33.

FIG. 36 is a plan view showing a modification example of the liquid crystal panel shown in FIG. 33.

FIG. 37 is a plan view showing the configuration of a liquid crystal panel according to Embodiment 5.

FIG. 38 is a cross-sectional arrow view taken along the line A-B of FIG. 37.

FIG. 39 is a plan view showing another configuration of the liquid crystal panel according to Embodiment 5.

FIG. 40 is a cross-sectional arrow view taken along the line A-B of FIG. 39.

FIG. 41 is a plan view showing another configuration of the liquid crystal panel according to Embodiment 5.

FIG. 42 is a cross-sectional arrow view taken along the line A-B of FIG. 41.

FIG. 43 is a schematic view showing configurations of a liquid crystal display unit according to the present invention and a liquid crystal display device according to the present invention. FIG. 43(a) shows the configuration of a present liquid crystal display unit, and FIG. 43(b) shows the configuration of a present liquid crystal display device.

FIG. 44 is a block diagram explaining the entire configuration of a present liquid crystal display device.

FIG. 45 is a block diagram explaining the functions of a present liquid crystal display device.

FIG. 46 is a block diagram explaining the functions of a television receiver according to the present invention.

FIG. 47 is an exploded perspective view showing the configuration of a present television receiver.

FIG. 48 is a plan view showing the configuration of a conventional liquid crystal panel.

FIG. 49 is a plan view showing the configuration of a conventional liquid crystal panel.

### DETAILED DESCRIPTION OF EMBODIMENTS

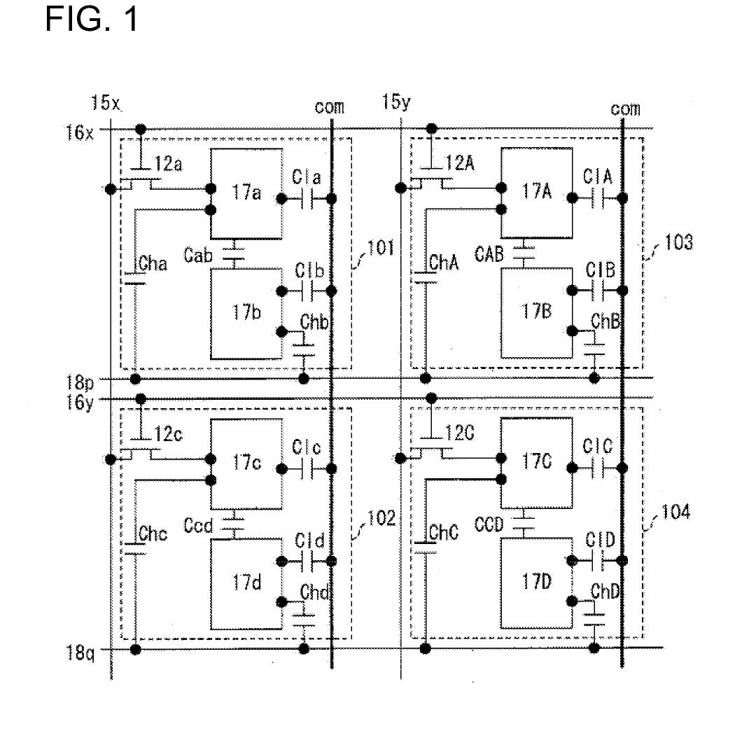

Examples of embodiments of the present invention are described below with reference to FIGS. 1 to 47. In the description below, it is assumed that the direction in which scan signal lines extend is the row direction, for convenience. Needless to say, however, when a liquid crystal display device equipped with a present liquid crystal panel (or an active matrix substrate for use in the liquid crystal panel) is in use (when viewed), the scan signal line can extend either horizontal or vertical direction. Alignment control structures formed on the liquid crystal panel are briefly described as necessary.

### Embodiment 1

FIG. 1 is an equivalent circuit diagram showing a part of the liquid crystal panel according to Embodiment 1. As shown in FIG. 1, the present liquid crystal panel includes data signal lines (15x and 15y) extending in the column direction (up/down direction in the figure), scan signal lines (16x and 16y) extending in the row direction (right/left direction in the figure), pixels (101 to 104) arranged in the row and column directions, storage capacitance wirings (18p and 18q), and a common electrode (opposite electrode) com. All pixels have the same structure. The pixel column that includes pixels 101 and 102 and the pixel column that includes pixels 103 and 104 are adjacent to each other, and the pixel row that includes pixels 101 and 103 and the pixel row that includes pixels 102 and 104 are adjacent to each other.

For the present liquid crystal panel, one data signal line and one scan signal line are provided for each of the pixels. In a single pixel, two pixel electrodes are arranged in the column direction. That is, two pixel electrodes 17a and 17b provided in pixel 101 and two pixel electrodes 17c and 17d provided in pixel 102 are arranged in a column, and two pixel electrodes 17A and 17B provided in pixel 103 and two pixel electrodes 17C and 17D provided in pixel 104 are arranged in a column. Pixel electrodes 17a and 17A, pixel electrodes 17b and 17B, pixel electrodes 17c and 17C, and pixel electrodes 17d and 17D are adjacent to each other in the row direction. The storage capacitance wiring 18p extends across the pixels 101 and 103, and the storage capacitance wiring 18q extends across the pixels 102 and 104.

In pixel 101, pixel electrodes 17a and 17b are connected together through a coupling capacitance Cab; the pixel electrode 17a is connected to the data signal line 15x through the transistor 12a connected to the scan signal line 16x; a storage capacitance Cha is formed between the pixel electrode 17a and the storage capacitance wiring 18p; a storage capacitance Chb is formed between the pixel electrode 17b and the storage capacitance wiring 18p; a liquid crystal capacitance Cla is formed between the pixel electrode 17a and the common electrode com; and a liquid crystal capacitance Clb is formed between the pixel electrode 17b and the common electrode com.

In pixel 102, which is adjacent to pixel 101 in the column direction, the pixel electrodes 17c and 17d are connected together through a coupling capacitance Ccd; the pixel electrode 17c is connected to the data signal line 15x through the transistor 12c connected to the scan signal line 16y; a storage capacitance Chc is formed between the pixel electrode 17c and the storage capacitance wiring 18q; a storage capacitance Chd is formed between the pixel electrode 17d and the storage capacitance wiring 18q; a liquid crystal capacitance Clc is formed between the pixel electrode 17c and the common electrode com; and a liquid crystal capacitance Cld is formed between the pixel electrode 17d and the common electrode com.

In pixel 103, which is adjacent to pixel 101 in the row direction; pixel electrodes 17A and 17B are connected together through a coupling capacitance CAB; the pixel electrode 17A is connected to the data signal line 15y through the transistor 12A connected to the scan signal line 16x; a storage capacitance ChA is formed between the pixel electrode 17A and the storage capacitance wiring 18p; a storage capacitance ChB is formed between the pixel electrode 17B and the storage capacitance wiring 18p; a liquid crystal capacitance ClA is formed between the pixel electrode 17A and the common electrode com; and a liquid crystal capacitance ClB is formed between the pixel electrode 17B and the common electrode com.

In the present embodiment, pixel electrodes 17a, 17A, 17c, and 17C, which are connected to corresponding data signal lines through respective transistors, correspond to first pixel electrodes, and other pixel electrodes 17b, 17B, 17d, and 17D provided in respective pixel regions correspond to second pixel electrodes. This applies to other embodiments described below unless otherwise stated.

In a liquid crystal display device equipped with the present liquid crystal panel, scan is performed sequentially, and scan signal lines 16x and 16y are selected sequentially. When the scan signal line 16x is selected, for example, the pixel electrode 17a is connected to the data signal line 15x (through the transistor 12a), and the pixel electrode 17a and the pixel electrode 17b are capacitively coupled through the coupling capacitance Cab. As a result, the relation Vb=Va×[C/(Cl+Ch+C)] is satisfied, where Cla capacitance value=Clb capacitance value=Cl, Cha capacitance value=Chb capacitance value=Ch, Cab capacitance value=C, Va is the potential of the pixel electrode 17a after the transistor 12a is turned off, and Vb is the potential of the pixel electrode 17b after the transistor 12a is turned off. That is, because |Va|≧|Vb| (where |Va|, for example, is the difference in potential between Va and the com potential (=Vcom)) is satisfied, the halftone display is conducted by the area gradation of the sub-pixel including the pixel electrode 17a, which becomes a bright sub-pixel, and the sub-pixel including the pixel electrode 17b, which becomes a dark sub-pixel. With this configuration, the view angle characteristics of the liquid crystal display device can be improved.

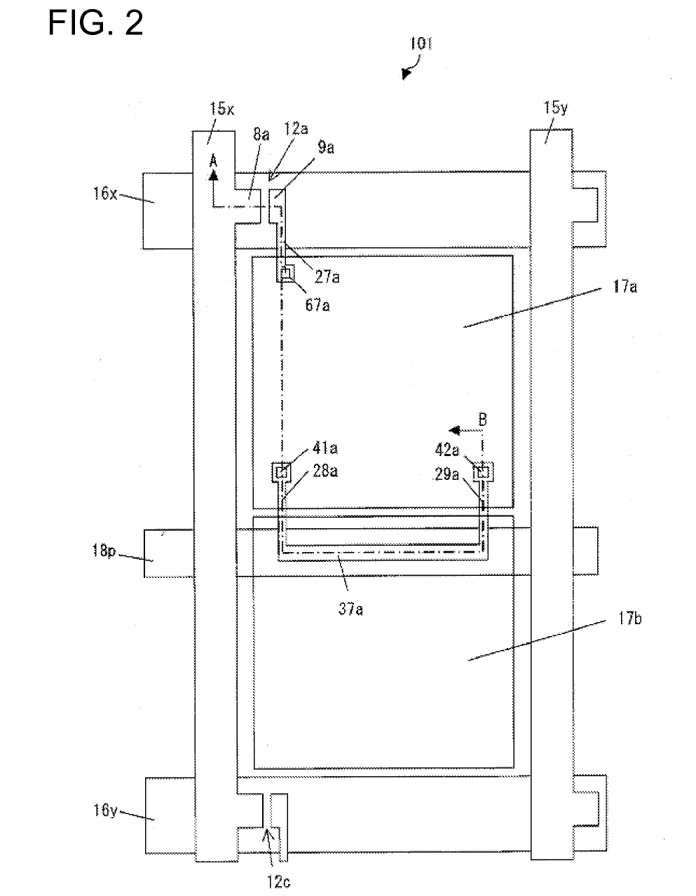

A specific example of pixel 101 of FIG. 1 is shown in FIG. 2. As shown in the figure, a transistor 12a is disposed in proximity of the intersection of the data signal line 15x and the scan signal line 16x. In the pixel region defined by the signal lines (15x and 16x), a rectangular-shaped pixel electrode 17a and a rectangular-shaped pixel electrode 17b are arranged in the column direction, and one of the four sides constituting the perimeter of the first pixel electrode and one of the four sides constituting the perimeter of the second pixel electrode are adjacent to each other. The storage capacitance wiring 18p extending in the row direction is disposed to overlap the pixel electrode 17b.

Also, the capacitance electrode 37a is disposed to overlap the storage capacitance wiring 18p and the pixel electrode 17b. More specifically, the capacitance electrode 37a extends in the same direction as the storage capacitance wiring 18p, and overlaps with the storage capacitance wiring 18p and the pixel electrode 17b.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through a contact hole 67a.

The capacitance electrode 37a overlaps with the pixel electrode 17b through an interlayer insulating film. The capacitance electrode 37a has two lead-out wirings 28a and 29a that extend from the respective extending directional end portions of the capacitance electrode 37a towards the pixel electrode 17a, and end portions of the lead-out wirings are connected to the pixel electrode 17a through contact holes 41a and 42a, respectively. This configuration forms a coupling capacitance Cab (see FIG. 1) between the pixel electrodes 17a and 17b where the capacitance electrode 37a and the pixel electrode 17b overlap with each other.

Further, the capacitance electrode 37a overlaps the storage capacitance wiring 18p through the gate insulating film, and a storage capacitance Cha (see FIG. 1) is formed at the location of the overlap. Also, the pixel electrode 17b and the storage capacitance wiring 18p overlap with each other through the interlayer insulating film and the gate insulating film, and a storage capacitance Chb (see FIG. 1) is formed at the location of the overlap.

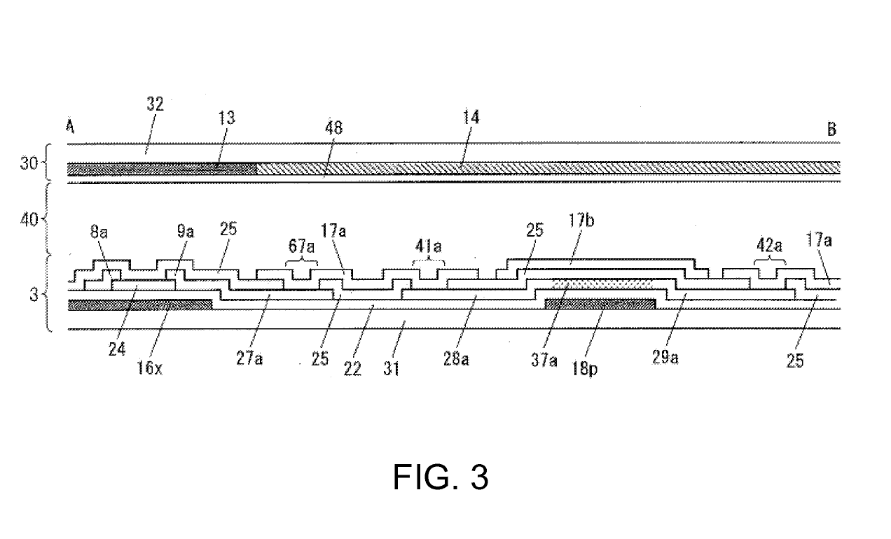

FIG. 3 is a cross-sectional arrow view taken along the line A-B of FIG. 2. As shown in the figure, the present liquid crystal panel includes an active matrix substrate 3, a color filter substrate 30 facing the active matrix substrate 3, and a liquid crystal layer 40 interposed between the substrates (3 and 30).

The active matrix substrate 3 includes a scan signal line 16x and a storage capacitance wiring 18p formed on the glass substrate 31, which are covered by an inorganic gate insulating film 22. Over the inorganic gate insulating film 22, a semiconductor layer 24 (i-layer and n+ layer), a source electrode 8a and a drain electrode 9a in contact with the n+ layer, a drain lead-out wiring 27a, a capacitance electrode 37a, and lead-out wirings 28a and 29a from the capacitance electrode 37a are formed, which are covered by an inorganic interlayer insulating film 25. On the inorganic interlayer insulating film 25, pixel electrodes 17a and 17b are formed, and further, an alignment film (not shown) is formed, covering the pixel electrodes 17a and 17b. Here, in the contact hole 67a, the inorganic interlayer insulating film 25 is removed, and therefore, the pixel electrode 17a and the drain lead-out wiring 27a are connected to each other. In the contact hole 41a, the inorganic interlayer insulating film 25 is removed, and therefore, the pixel electrode 17a (one of the pixel electrodes) and the capacitance electrode 37a are connected to each other through the lead-out wiring 28a. Similarly, in the contact hole 42a, the inorganic interlayer insulating film 25 are removed, and therefore the pixel electrode 17a (one of the pixel electrodes) and the capacitance electrode 37a are connected to each other through the lead-out wiring 29a. Also, the capacitance electrode 37a overlaps with the pixel electrode 17b (the other of the pixel electrodes) through the inorganic interlayer insulating film 25, and therefore the coupling capacitance Cab (see FIG. 1) is formed.

The capacitance electrode 37a overlaps with the storage capacitance wiring 18p through the inorganic gate insulating film 22, and therefore the storage capacitance Cha (see FIG. 1) is formed. Also, the pixel electrode 17b and the storage capacitance wiring 18p overlap with each other through the inorganic interlayer insulating film 25 and the inorganic gate insulating film 22, and therefore a storage capacitance Chb (see FIG. 1) is formed.

The color filter substrate 30, on the other hand, includes a colored layer 14 formed on a glass substrate 32. Over the colored layer 14, a common electrode (com) 48 is formed, which is covered by an alignment film (not shown).

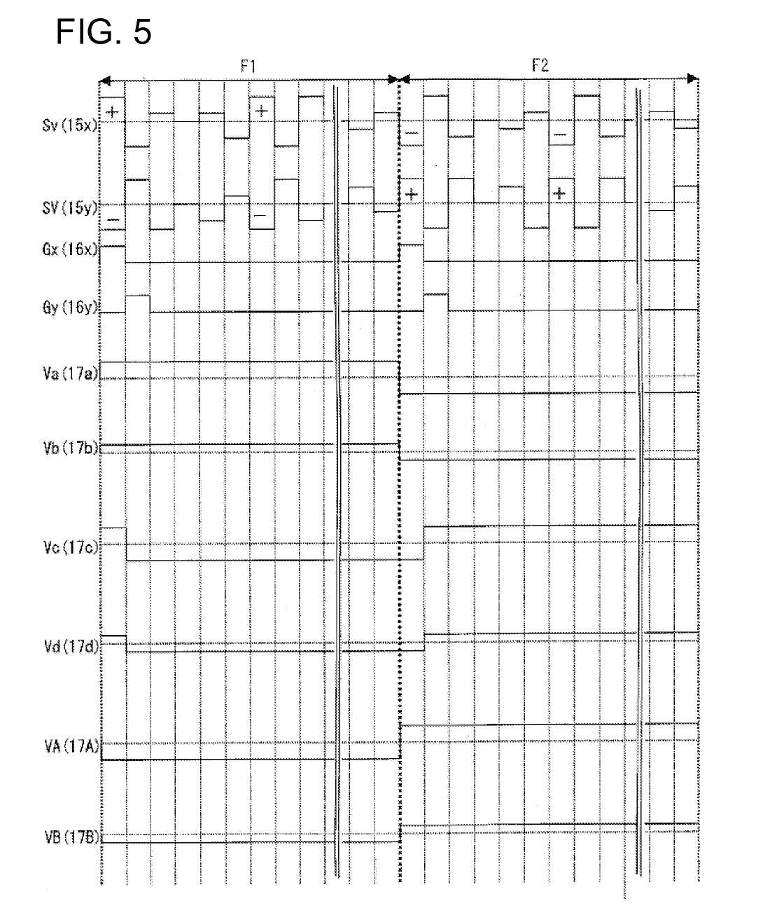

FIG. 5 is a timing chart showing the driving method of a present liquid crystal display device (liquid crystal display device operating in the normally black mode) equipped with the liquid crystal panel shown in FIG. 1 and FIG. 2. Here, “Sv” and “SV” respectively denote signal potentials supplied to two adjacent data signal lines (15x and 15y, for example), “Gx” and “Gy” respectively denote gate-on pulse signals supplied to the scan signal lines 16x and 16y, and “Va”, “Vb”, “VA”, “VB”, “Vc”, and “Vd” respectively denote potentials of the pixel electrodes 17a, 17b, 17A, 17B, 17c, and 17d.

In this driving method, as shown in FIG. 5, scan signal lines are selected sequentially, the polarity of the signal potential supplied to the data signal lines is reversed in every one horizontal scan period (1H), the polarity of the signal potential supplied during the same horizontal scan period in each frame is reversed for each frame, and during the same horizontal scan period, signal potentials of opposite polarities are supplied to two adjacent data signal lines.

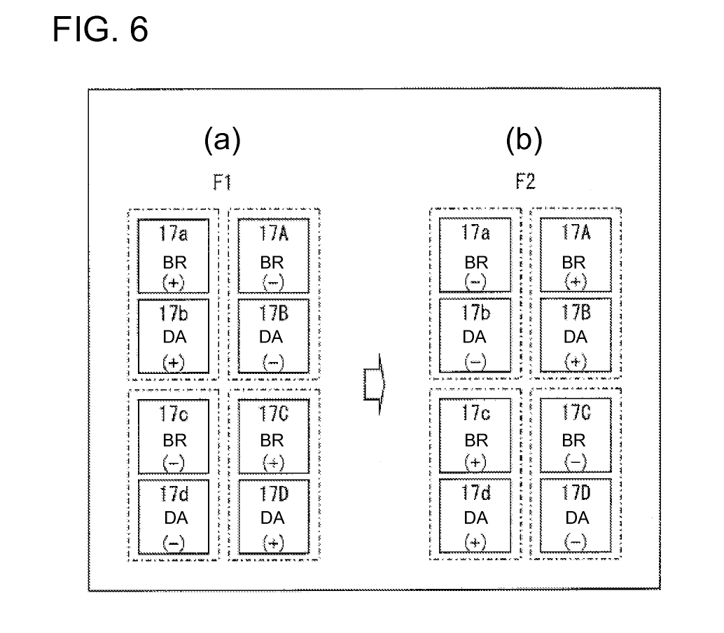

More specifically, in F1 of consecutive frames F1 and F2, scan signal lines are sequentially selected (scan signal lines 16x and 16y, for example, are selected in this order), and to one of the two neighboring data signal lines (data signal line 15x, for example), a signal potential of positive polarity is supplied during the first horizontal scan period (including the writing period of the pixel electrode 17a, for example), and a signal potential of negative polarity is supplied during the second horizontal scan period (including the writing period of the pixel electrode 17c, for example). To the other of the two neighboring data signal lines (data signal line 15y, for example), a signal potential of negative polarity is supplied during the first horizontal scan period (including the writing period of the pixel electrode 17A, for example), and a signal potential of positive polarity is supplied during the second horizontal scan period (including the writing period of the pixel electrode 17C, for example). As a result, as shown in FIG. 5, relations of |Va|≧|Vb|, |Vc|≧|Vd|, and |VA|≧|VB| are satisfied. The sub-pixel that includes the pixel electrode 17a (positive polarity) becomes a bright sub-pixel (hereinafter “BR”), the sub-pixel that includes the pixel electrode 17b (positive polarity) becomes a dark sub-pixel (hereinafter “DA”), the sub-pixel that includes the pixel electrode 17c (negative polarity) becomes “BR”, the sub-pixel that includes the pixel electrode 17d (negative polarity) becomes “DA”, the sub-pixel that includes the pixel electrode 17A (negative polarity) becomes “BR”, and the sub-pixel that includes the pixel electrode 17B (negative polarity) becomes “DA”. FIG. 6(a) shows the overall picture.

In F2, scan signal lines are sequentially selected (the scan signal line 16x and 16y, for example, are selected in this order), and to one of the two neighboring data signal lines (data signal line 15x, for example), a signal potential of negative polarity is supplied during the first horizontal scan period (including the writing period of the pixel electrode 17a, for example), and a signal potential of positive polarity is supplied during the second horizontal period (including the writing period of the pixel electrode 17c, for example). To the other of the two data signal lines (data signal line 15y, for example), a signal potential of positive polarity is supplied during the first horizontal scan period (including the writing period of the pixel electrode 17A, for example), and a signal potential of negative polarity is supplied during the second horizontal period (including the writing period of the pixel electrode 17C, for example). As a result, as shown in FIG. 5, relations of |Va|≧|Vb|, |Vc|≧|Vd|, and |VA|≧|VB| are satisfied. The sub-pixel that includes the pixel electrode 17a (negative polarity) becomes “BR”, the sub-pixel that includes the pixel electrode 17b (negative polarity) becomes “DA”, the sub-pixel that includes the pixel electrode 17c (positive polarity) becomes “BR”, the sub-pixel that includes the pixel electrode 17d (positive polarity) becomes “DA”, the sub-pixel that includes the pixel electrode 17A (positive polarity) becomes “BR”, and the sub-pixel that includes the pixel electrode 17B (positive polarity) becomes “DA”. FIG. 6(b) shows the overall picture.

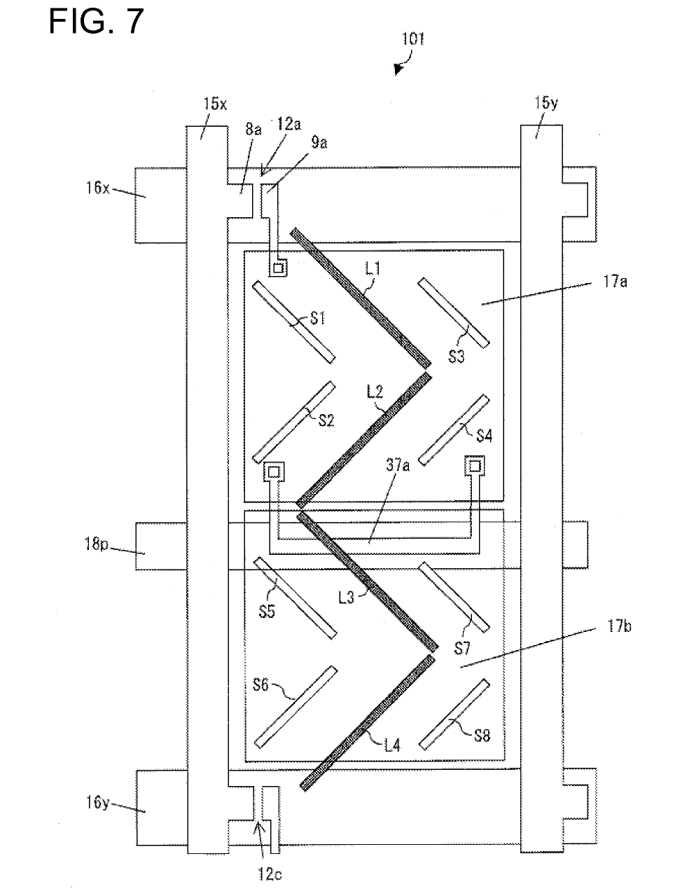

The alignment control structure is omitted in FIG. 2. However, for a liquid crystal panel of MVA (Multi-domain Vertical Alignment) system, for example, as shown in FIG. 7, for example, alignment control slits S1 to S4 are provided for the pixel electrode 17a, and alignment control ribs L1 and L2 are provided on the color filter substrate at locations corresponding to the pixel electrode 17a. Alignment control slits S5 to S8 are provided for pixel electrode 17b, and alignment control ribs L3 and L4 are provided on the color filter substrate at locations corresponding to the pixel electrode 17b. Here, instead of providing the aforementioned alignment control ribs, alignment control slits may be provided in the common electrode of the color filter substrate.

In the configuration of FIG. 2, the drain electrode 9a of the transistor 12a is connected to the pixel electrode 17a through a contact hole 67a, and the pixel electrode 17a and the capacitance electrode 37a are connected to each other through contact holes 41a and 42a. This way, the drain lead-out wiring that connects the drain electrode 9a and the capacitance electrode 37a together can be made shorter, which improves the aperture ratio. The pixel electrode 17a and the capacitance electrode 37a of the liquid crystal panel of FIG. 2 are connected together through two contact holes, and a capacitance coupling is formed between the pixel electrode 17a and the pixel electrode 17b. As a result, even if either one of the contact holes is not formed properly in the manufacturing process or the like (even if a sufficient connection between the capacitance electrode 37a and the pixel electrode 17a is not established in one of the contact holes), connection between the capacitance electrode 37a and the pixel electrode 17a can be obtained through the other of the contact holes, which makes it possible to maintain the capacitance coupling between the pixel electrodes 17a and 17b.

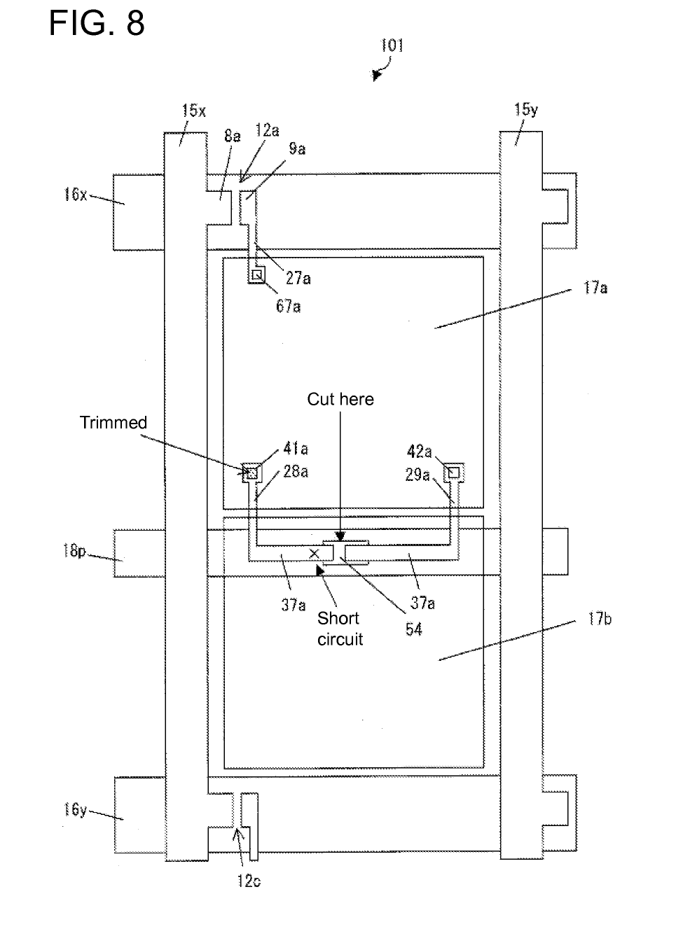

If a short circuit occurs between the capacitance electrode 37a and the storage capacitance wiring 18p or the pixel electrode 17b (in the manufacturing process or the like), as shown in FIG. 8, the capacitance coupling of the pixel electrodes 17a and 17b can be maintained by conducting a repair process in which the portion inside the contact hole 41a, which is proximal to the short circuit, is removed (trimmed) by laser or the like to electrically isolate the pixel electrode 17a and the capacitance electrode 37a from each other at the contact hole 41a, and the capacitance electrode 37a is cut by laser at a location between the contact hole 42a and the site of the short circuit.

For the repair process described above, an opening 54 is formed, as shown in FIG. 8, at the middle section of the overlapped area of the storage capacitance wiring 18p and the capacitance electrode 37a. If the repair process is conducted after the active matrix substrate is complete, the capacitance electrode 37a is irradiated with laser beam from the back side of the active matrix substrate (glass substrate side) through the opening 54 in the storage capacitance wiring 18p to cut the capacitance electrode 37a (see FIG. 8).

Instead of trimming the inside of the contact hole 41a, the lead-out wiring 28a can be irradiated with laser from the front side (the side opposite from the glass substrate side) of the active matrix substrate through the gap between the pixel electrodes 17a and 17b to cut the lead-out wiring 28a, and therefore, to electrically isolate the pixel electrode 17a from the capacitance electrode 37a.

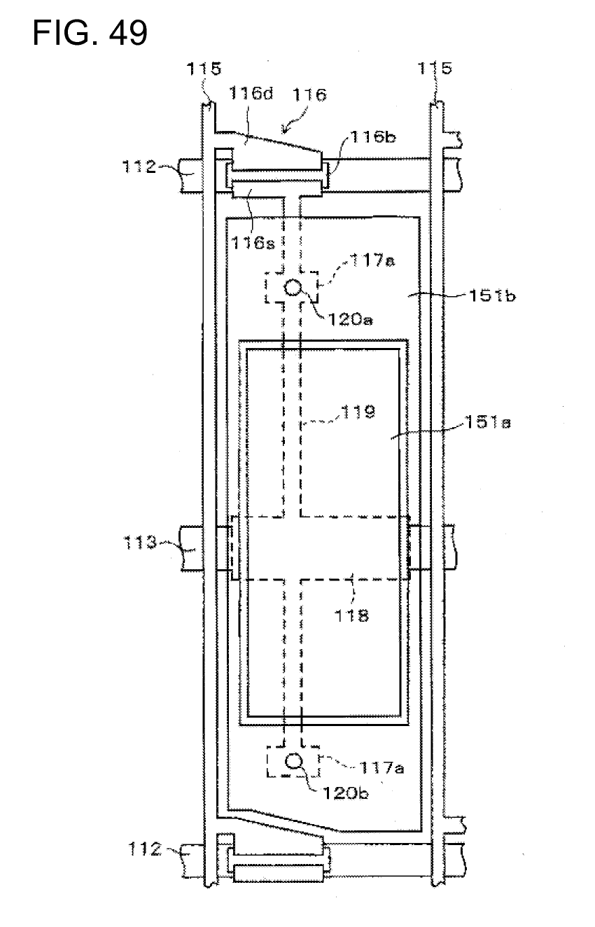

As described above, according to the present embodiment, production yield of liquid crystal panels and active matrix substrates for use in the liquid crystal panels can be increased. In the case of the conventional active matrix substrate shown in FIG. 49, if a short circuit occurs between the control electrode 118 and the capacitance wiring 113, a signal potential can be written on the pixel electrode 151b by cutting the lead-out wiring 119. As a result, however, the capacitive coupling between the pixel electrode 151a and the pixel electrode 151b becomes lost.

Regarding the liquid crystal panel of FIG. 2, the capacitance electrode 37a overlaps with the pixel electrode 17b and the storage capacitance wiring 18p. Thus, by utilizing the capacitance electrode 37a, which is provided to form a coupling capacitance, as an electrode for forming a storage capacitance, the aperture ratio can be improved.

Next, a method for manufacturing the present liquid crystal panel is described. The method for manufacturing the liquid crystal panel includes the steps of: manufacturing the active matrix substrate; manufacturing the color filter substrate; and assembling the substrates in which the substrates are bonded together and the liquid crystal is filled. Also, if any defective pixel (sub-pixel) is found in the inspection conducted at least during or after the manufacturing process or the assembly process of the active matrix substrate, a repair process to correct the defect is added to the entire process.

Below, the process of manufacturing an active matrix substrate is described.

First, over a substrate made of glass, plastic, or the like, a metal film of titanium, chrome, aluminum, molybdenum, tantalum, tungsten, copper, or the like, an alloy film of such metals, or a layered film (thickness: 1000 Å to 3000 Å) of such metals is deposited by sputtering. Then, patterning is conducted by a photolithographic technique (Photo Engraving Process; hereinafter referred to as the “PEP technique”) to form scan signal lines, gate electrodes of transistors (in some cases, a scan signal line also functions as a gate electrode), and storage capacitance wirings.

Next, over the entire substrate with the scan signal lines and the like formed thereon, an inorganic insulating film (thickness: approx. 3000 Å to 5000 Å) made of silicon nitride, silicon oxide, or the like is deposited by CVD (Chemical Vapor Deposition) to form a gate insulating film.

Subsequently, an intrinsic amorphous silicon film (thickness: 1000 Å to 3000 Å) and an n+ amorphous silicon film (thickness: 400 Å to 700 Å) doped with phosphorus are continuously deposited over the gate insulating film (over the entire substrate) by CVD. Then, the films are patterned by the PEP technique to form an island-shaped multi-layered body of silicon composed of the intrinsic amorphous silicon layer and the n+amorphous silicon layer on the gate electrode.

Next, over the entire substrate with the silicon multi-layered body formed thereon, a metal film of titanium, chrome, aluminum, molybdenum, tantalum, tungsten, copper, or the like, an alloy film of such metals, or a multi-layered film (thickness: 1000 Å to 3000 Å) of such metals is deposited by sputtering. Then, patterning is conducted by the PEP technique to form data signal lines, source electrodes and drain electrodes of transistors, drain lead-out wirings, capacitance electrodes, and lead-out wirings from capacitance electrodes.

Further, using the source electrode and the drain electrode as a mask, the n+amorphous silicon layer constituting the multi-layered body of silicon is etched away to form a transistor channel. Here, although the semiconductor layer may be formed of amorphous silicon film as described above, a polysilicon film may alternatively be deposited. Also, the amorphous silicon film or the polysilicon film may optionally be subjected to a laser annealing treatment for improved crystallinity. This treatment makes the electrons in the semiconductor layer move faster, and therefore improves the characteristics of the transistor (TFT).

Next, over the entire substrate with data signal lines or the like formed thereon, an inorganic insulating film of silicon nitride, silicon oxide, or the like (thickness: 2000 Å to 5000 Å) is deposited by CVD method.

Subsequently, using the PEP technique, the interlayer insulating film is etched away to form contact holes. Then, over the interlayer insulating film on the entire substrate with contact holes formed therein, a transparent conductive film made of ITO (Indium Tin Oxide), IZO (Indium Zinc Oxide), zinc oxide, tin oxide, or the like (thickness: 1000 Å to 2000 Å) is formed by sputtering. Then, patterning is conducted using the PEP technique to form pixel electrodes.

Lastly, a polyimide resin is printed to a thickness of 500 Å to 1000 Å over the entire substrate with the pixel electrodes formed thereon. Then, through baking and a unidirectional rubbing treatment using a rotating cloth, an alignment film is formed. The active matrix substrate is manufactured in this manner.

Below, the process of manufacturing the color filter substrate is described.

First, over a substrate made of glass, plastic, or the like (over the entire substrate), a chrome thin film or a resin containing a black pigment is deposited. Then, using the PEP technique, the film is patterned to form a black matrix. Next, in openings in the black matrix, a color filter layer (thickness: approx. 2 μm) of red, green, and blue is formed by patterning using a pigment dispersing method or the like.

Next, on the color filter layer over the entire substrate, a transparent conductive film (thickness: approx. 1000 Å) made of ITO, IZO, zinc oxide, tin oxide, or the like is deposited to form a common electrode (com).

Lastly, polyimide resin is printed to a thickness of 500 Å to 1000 Å over the entire substrate with the common electrode formed thereon. Then, through baking and a unidirectional rubbing treatment using a rotating cloth, an alignment film is formed. The color filter substrate can be manufactured in this manner.

Below, the assembly process is described.

First, a sealing material made of a thermosetting epoxy resin or the like is applied on either the active matrix substrate or the color filter substrate by screen printing in a frame-like pattern with an opening, which will be the inlet for the liquid crystal. On the other substrate, ball-shaped spacers made of plastic or silica and having a diameter equivalent to the thickness of the liquid crystal layer are dispersed.

Next, the active matrix substrate and the color filter substrate are bonded together, and the sealing material is cured.

Lastly, the liquid crystal material is introduced into the space surrounded by the active matrix substrate, the color filter substrate, and the sealing material by a decompression procedure. Then, a UV-curable resin is applied to the inlet for the liquid crystal and is subjected to UV radiation to seal in the liquid crystal material and thereby to form a liquid crystal layer. The liquid crystal panel is manufactured in this manner.

Below, the first inspection process is described, which is conducted during the active matrix substrate manufacturing process (after the pixel electrodes are formed and before the alignment film is formed, for example), or after the active matrix substrate manufacturing process. In the first inspection process, the active matrix substrate is subjected to an appearance inspection, electro-optical inspection, and the like to identify the location of any short circuit (short-circuit site). A short circuit can occur between the capacitance electrode and the storage capacitance wiring, or between the capacitance electrode and the pixel electrode, for example. The appearance inspection refers to an optical inspection of the wiring pattern using a CCD camera or the like, and the electro-optical inspection refers to an inspection in which, after a modulator (electro-optic element) is installed facing the active matrix substrate, a voltage is applied and light is passed between the active matrix substrate and the modulator. The change in the light luminance is detected by a CCD camera for the electro-optical examination of the wiring pattern.

If any short-circuit site is detected, a repair process is conducted in which a short-circuited capacitance electrode or a conductive portion connected to the short-circuited capacitance electrode (drain lead-out wiring, for example) is cut by laser. For the laser cutting, the fourth harmonic (wavelength: 266 nm) of YAG (Yttrium Aluminum Garnet) laser, for example, is used. High cutting precision can be obtained this way. Also, at a location where the capacitance electrode and the storage capacitance wiring overlap, an opening 54 is preferably formed in the storage capacitance wiring 18p at about the center of the region of the overlap, so that the capacitance electrode can be cut (see FIG. 8).

If any short-circuit site is detected, in some cases, a repair process is conducted in which the pixel electrode connected to the short-circuited capacitance electrode through the contact hole is removed (trimmed) by laser or the like at a location corresponding to the inside of the contact hole. Also, in the repair process conducted after the first inspection process, normally, laser light can be radiated from the front side (pixel electrode side) or the back side (substrate side) of the active matrix substrate.

The first inspection process and the repair process can be conducted after the pixel electrode is formed, after the capacitance electrode is formed, or after the transistor channel is formed. This way, problems can be corrected at an earlier stage of the manufacturing process, which can increase the production yield of the active matrix substrate.

Next, a second inspection process, which is conducted after the assembly process, is described. In the second inspection process, a short-circuit site is detected by performing a lighting test of the liquid crystal panel. A short circuit may occur between the capacitance electrode and the storage capacitance wiring, or between the capacitance electrode and the pixel electrode, for example. Specifically, for example, to respective scan signal lines, a gate inspection signal having a bias voltage of −10V, frequency of 16.7 msec, pulse width of 50 μsec, and pulse voltage of +15V is input to turn all TFTs on. Further, a source inspection signal that has a potential of ±2V and reverses the polarity every 16.7 msec is input to respective data signal lines to write the signal potential corresponding to ±2V to the pixel electrode through the source electrode and the drain electrode of respective TFTs. Simultaneously, a common electrode inspection signal, which is a direct current and having a potential of −1V is input to the common electrode (com) and the storage capacitance wiring. At this time, a voltage is applied to the liquid crystal capacitance formed between the pixel electrodes and the common electrode, and to the storage capacitance formed between the storage capacitance wiring and the capacitance electrodes, thereby lighting the sub-pixels formed of the pixel electrodes. Also, at the short-circuit site between the capacitance electrode and the storage capacitance wiring, for example, an electrical connection is established between the pixel electrode and the storage capacitance wiring, forming a black dot (normally black). This way, short circuits are detected.

If any short circuit is detected, a repair process is conducted in which the short-circuited capacitance electrode or any conductive body connected to the short-circuited capacitance electrode (drain lead-out wiring, for example) is cut off by laser. In the repair process conducted after the second inspection process, normally, laser is radiated from the back side of the active matrix substrate (the substrate side of the active matrix substrate).

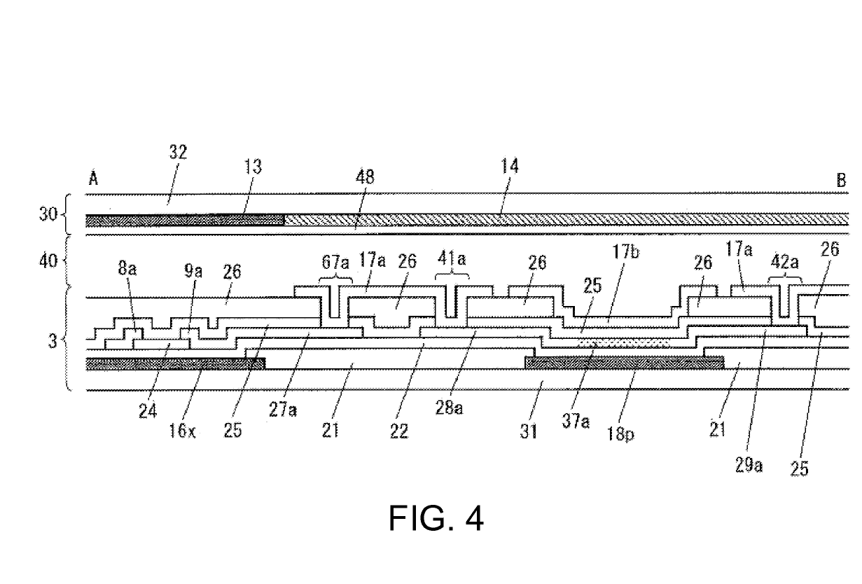

The cross-section taken along the line A-B of FIG. 2 can also be configured as shown in FIG. 4. That is, a thick organic gate insulating film 21 and a thin inorganic gate insulating film 22 are formed on the glass substrate 31, and a thin interlayer insulating film 25 and a thick organic interlayer insulating film 26 are formed under the pixel electrode. This configuration provides effects such as decrease in various parasitic capacitances, prevention of short-circuiting between wirings, and reduction of problems such as torn pixel electrode due to planarization. In this case, as shown in FIG. 4, the portion of the organic gate insulating film 21 located under the capacitance electrode 37a is preferably removed, and the portion of the organic interlayer insulating film 26 located over the capacitance electrode 37a is preferably removed. This way, the effects described above can be obtained while ensuring sufficient capacitance values for the coupling capacitance (Cab) and the storage capacitances (Cha and Chb).

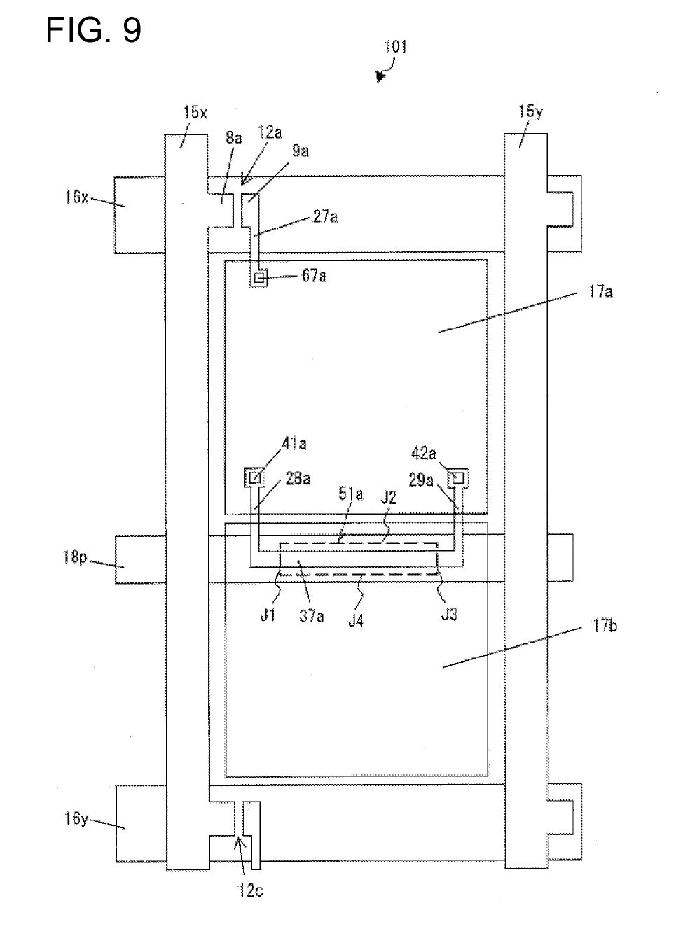

Also, preferably, the organic interlayer insulating film 26 is partially removed is the region indicated by the dashed line in FIG. 9 (thin film portion 51a). More specifically, as shown in FIG. 9, the thin film portion 51a is formed to a rectangular shape composed of four sides, which are first side (J1) to fourth side (J4). The capacitance electrode 37a is disposed along the direction in which the storage capacitance wiring 18p extends, crossing the first side (J1) and the third side (J3) of the thin film portion 51a, where the third side (J3) faces the first side (J1). This way, even if the capacitance electrode 37a is misaligned in the row direction, the overlapping area of the capacitance electrode 37a and the pixel electrode 17b in the thin film portion 51a is likely to be maintained constant, and the total of the two capacitances (coupling capacitance) tends to be unchanged. Needless to say, this configuration is applicable to liquid crystal panels described below in the discussion of the present embodiment.

Also, as shown in FIG. 4, because the thickness of the organic interlayer insulating film 26 is greater than the thickness of the inorganic interlayer insulating film 25, in a configuration in which the organic interlayer insulating film 26 is provided, a contact hole tends to be formed only insufficiently in the insulating film during the manufacturing process, resulting in a poorly functioning contact hole. In this case, the benefit of providing two contact holes 41a and 42a for the capacitance electrode 37a, as with the present invention, is even more significant. That is, even if a contact failure is provided through one of the contact holes, electrical connection can still be obtained through the other contact hole. Consequently, the pixel is unlikely to become defective, which improves the manufacturing yield.

The inorganic interlayer insulating film 25, organic interlayer insulating film 26, and the contact holes 67a, 41a, and 42a of FIG. 4 can be formed as described below, for example. That is, after the transistors (TFT) and the data signal lines are formed, an inorganic interlayer insulating film 25 (passivation film) made of SiNx and having a thickness of about 3000 Å is formed over the entire substrate by CVD using a mixed gas of SiH₄, NH₃, and N₂. Then, an organic interlayer insulating film 26 made of a positive photosensitive acrylic resin having a thickness of about 3 μm is formed by spin coating or die coating. Subsequently, a pattern is formed on the organic interlayer insulating film 26 by photolithography for the removal portions and various contacts. Further, using the patterned organic interlayer insulating film 26 as a mask, the inorganic interlayer insulating film 25 is dry-etched using a mixed gas of CF₄ and O₂. More specifically, for example, for the removal portion of the organic interlayer insulating film, the film is half-exposed in the photolithography process so that when the development is complete, a thin layer of the organic interlayer insulating film is preserved, and for the contact holes, the film is fully exposed in the photolithography process so that when the development is complete, no residue of the organic interlayer insulating film remains. Here, dry-etching is conducted using a mixed gas of CF₄ and O₂ to remove the preserved layer (of the organic interlayer insulating film) for the region in which the organic interlayer insulating film is supposed to be absent, and to remove portions of the inorganic interlayer insulating film that is under the organic interlayer insulating film, for the contact holes. The organic gate insulating film 21 and the organic interlayer insulating film 26 may be an insulating film made of SOG (spin-on-glass) material, for example. Also, the organic gate insulating film 21 and the organic interlayer insulating film 26 may contain at least any one of the acrylic resin, epoxy resin, polyimide resin, polyurethane resin, novolac resin, and siloxane resin.

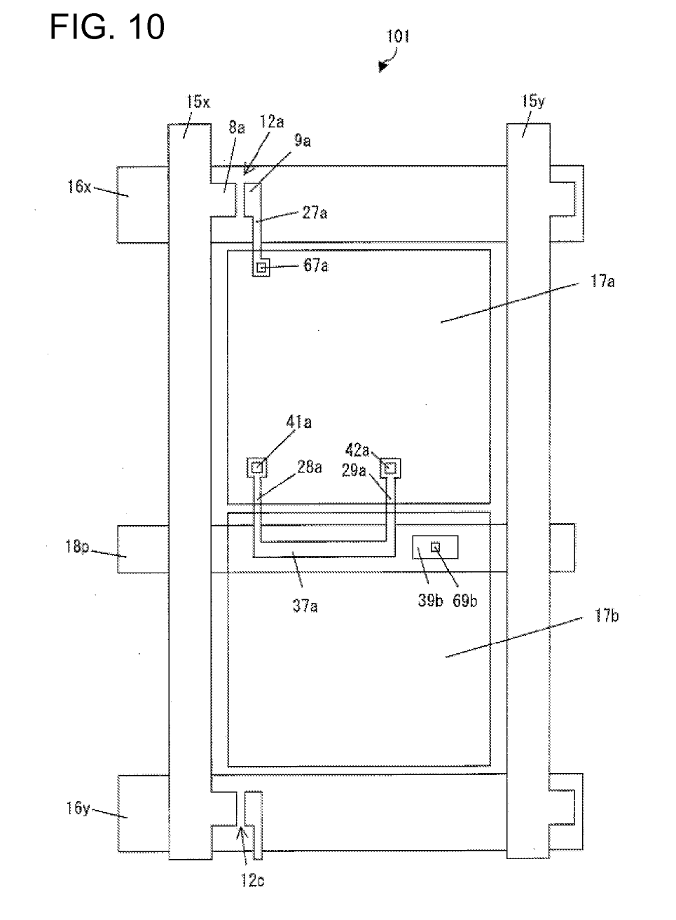

Here, the capacitance value of the storage capacitance Chb is preferably large for higher reliability. For this reason, the storage capacitance Chb can be formed according to the configuration shown in FIG. 10. That is, as shown in FIG. 10, a storage capacitance electrode 39b, which is formed in the same layer as the capacitance electrode 37a, is connected to the pixel electrode 17b through the contact hole 69b, and as a result, a storage capacitance Chb is formed between the storage capacitance electrode 39b and the storage capacitance wiring 18p. In this configuration, compared to the case where the storage capacitance Chb is formed between the pixel electrode 17b and the storage capacitance wiring 18p as shown in FIG. 2, the insulating film present between them can be made thin. The storage capacitance value can therefore be increased. Also, because the insulating film forming the storage capacitance Chb can be thin, the width of the storage capacitance wiring 18p can be made smaller without changing the storage capacitance value. This improves the aperture ratio without lowering the reliability.

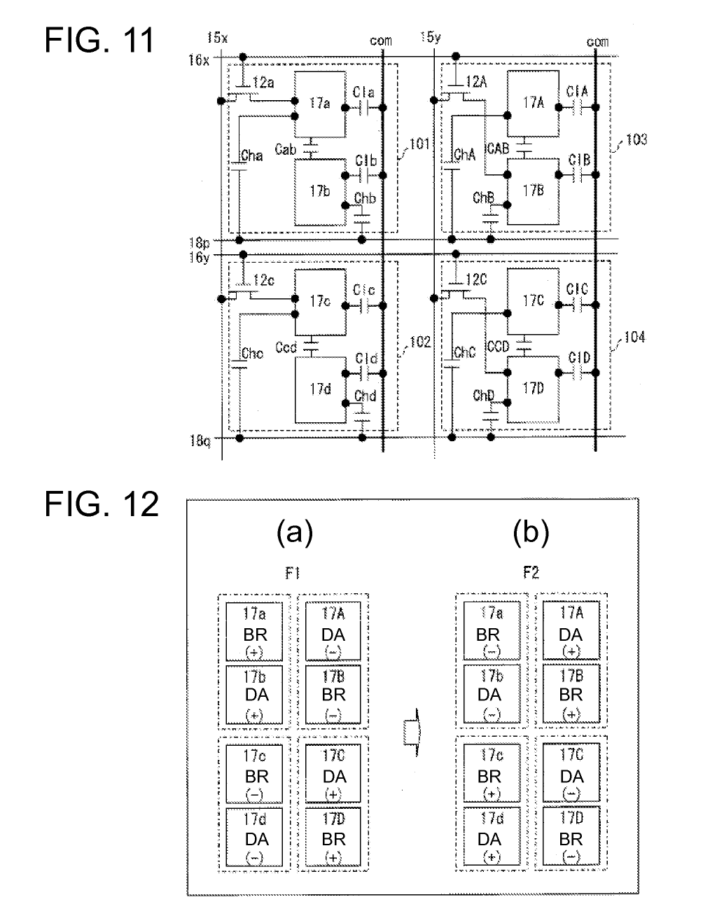

The liquid crystal panel of FIG. 1 may be configured as shown in FIG. 11. In FIG. 11, in one of the two adjacent pixels in the row direction, the pixel electrode proximal to the transistor is connected to the transistor, and in the other pixel, the pixel electrode distal to the transistor is connected to the transistor.

In the liquid crystal display device equipped with the liquid crystal panel of FIG. 11, when the data signal lines 15x and 15y are driven as shown in FIG. 5, in frame F1, the sub-pixel that includes the pixel electrode 17a (positive polarity) becomes “BR”, the sub-pixel that includes the pixel electrode 17b (positive polarity) becomes “DA”, the sub-pixel that includes the pixel electrode 17c (negative polarity) becomes “BR”, the sub-pixel that includes the pixel electrode 17d (negative polarity) becomes “DA”, the sub-pixel that includes the pixel electrode 17A (negative polarity) becomes “DA”, and the sub-pixel that includes the pixel electrode 17B (negative polarity) becomes “BR”. FIG. 12(a) shows the overall picture. In frame F2, the sub-pixel that includes the pixel electrode 17a (negative polarity) becomes “BR”, the sub-pixel that includes the pixel electrode 17b (negative polarity) becomes “DA”, the sub-pixel that includes the pixel electrode 17c (positive polarity) becomes “BR”, the sub-pixel that includes the pixel electrode 17d (positive polarity) becomes “DA”, and the sub-pixel that includes the pixel electrode 17A (positive polarity) becomes “DA”, and the sub-pixel that includes the pixel electrode 17B (positive polarity) becomes “BR”. FIG. 12(b) shows the overall picture.

In the liquid crystal panel of FIG. 11, because no two bright sub-pixels are arranged side by side in the row direction and no two dark sub-pixels are arranged side by side in the row direction, uneven streaks in the row direction can be suppressed.

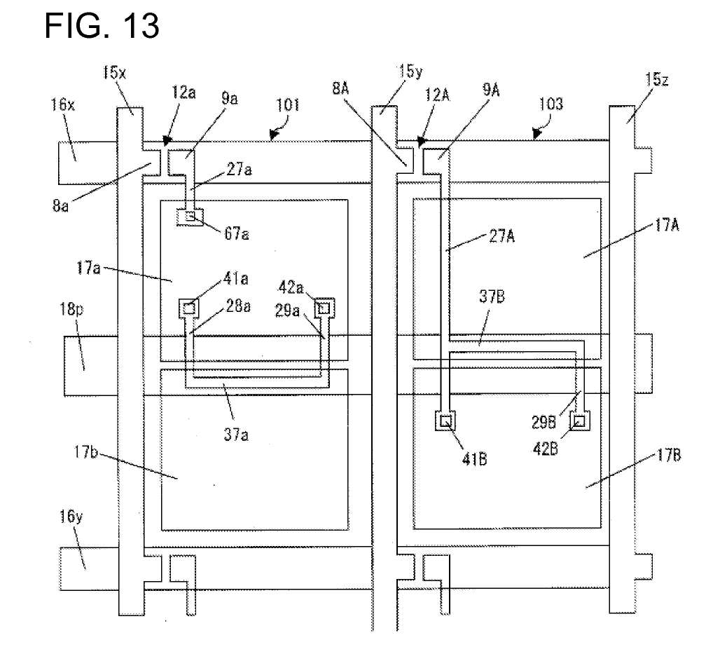

A specific example of pixels 101 and 103 of FIG. 11 is shown in FIG. 13. As shown in the figure, in pixel 101, a transistor 12a is disposed in the proximity of the intersection of the data signal line 15x and the scan signal line 16x. In the pixel region defined by the signal lines (15x and 16x), a rectangular-shaped pixel electrode 17a and a rectangular-shaped pixel electrode 17b are arranged in the column direction, and one of the four sides constituting the perimeter of the first pixel electrode and one of the four sides constituting the perimeter of the second pixel electrode are disposed adjacent to each other. The storage capacitance wiring 18p, which extends in the row direction, is disposed to overlap the entire gap between the adjacent two sides (the gap between the pixel electrodes 17a and 17b). Also, the capacitance electrode 37a is disposed to overlap with the storage capacitance wiring 18p and the pixel electrode 17b.

More specifically, the capacitance electrode 37a extends in the same direction as the storage capacitance wiring 18p, and overlaps with the storage capacitance wiring 18p and the pixel electrode 17b.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a.

The capacitance electrode 37a overlaps the pixel electrode 17b through an interlayer insulating film. The capacitance electrode 37a has two lead-out wirings 28a and 29a that extend from the respective extending directional end portions of the capacitance electrode 37a towards the pixel electrode 17a, and end portions of the lead-out wirings are connected to the pixel electrode 17a through contact holes 41a and 42a, respectively. With this configuration, the coupling capacitance Cab (see FIG. 11) between the pixel electrodes 17a and 17b is formed where the capacitance electrode 37a and the pixel electrode 17b overlap.

Further, the capacitance electrode 37a overlaps the storage capacitance wiring 18p through the gate insulating film, and most of the storage capacitance Cha (see FIG. 11) is formed at the location of the overlap. Also, the pixel electrode 17b and the storage capacitance wiring 18p overlap with each other through the interlayer insulating film and the gate insulating film, and the storage capacitance Chb (see FIG. 11) is formed at the location of the overlap.

On the other hand, in pixel 103, a transistor 12A is disposed in proximity of the intersection of the data signal line 15y and the scan signal line 16x; in the pixel region defined by the signal lines (15y and 16x), a rectangular-shaped pixel electrode 17A and a rectangular-shaped pixel electrode 17B are arranged in the column direction; and one of the four sides constituting the perimeter of the first pixel electrode and one of the four sides constituting the perimeter of the second pixel electrode are disposed adjacent to each other. Also, the storage capacitance wiring 18p that extends in the row direction is disposed to fully overlap the gap between the two sides (of the pixel electrodes 17A and 17B) adjacent to each other. Additionally, the capacitance electrode 37B is disposed to overlap with the storage capacitance wiring 18p and the pixel electrode 17A.

More specifically, the capacitance electrode 37B extends in the same direction as the storage capacitance wiring 18p, and overlaps with the storage capacitance wiring 18p and the pixel electrode 17A.

Over the scan signal line 16x, a source electrode 8A and a drain electrode 9A of the transistor 12A are formed, and the source electrode 8A is connected to the data signal line 15y. The drain electrode 9A is connected to the drain lead-out wiring 27A. The drain lead-out wiring 27A is connected to the capacitance electrode 37B formed in the same layer, and is also connected to the pixel electrode 17B through the contact hole 41B. Also, an end portion of the capacitance electrode 37B (the end portion away from the portion connected to the lead-out wiring 27A) has a lead-out wiring 29B extending towards the pixel electrode 17B, and the end portion of the lead-out wiring is connected to the pixel electrode 17B through a contact hole 42B. The capacitance electrode 37B overlaps with the pixel electrode 17A through an interlayer insulating film, and a coupling capacitance CAB (see FIG. 11) between the pixel electrodes 17A and 17B is formed at the location of the overlap.

Further, the capacitance electrode 37B overlaps with the storage capacitance wiring 18p through the gate insulating film, and most of the storage capacitance ChB (see FIG. 11) is formed at the location of the overlap. The pixel electrode 17A and the storage capacitance wiring 18p overlap with each other through the interlayer insulating film and the gate insulating film, and a storage capacitance ChA (see FIG. 11) is formed at the location of the overlap.

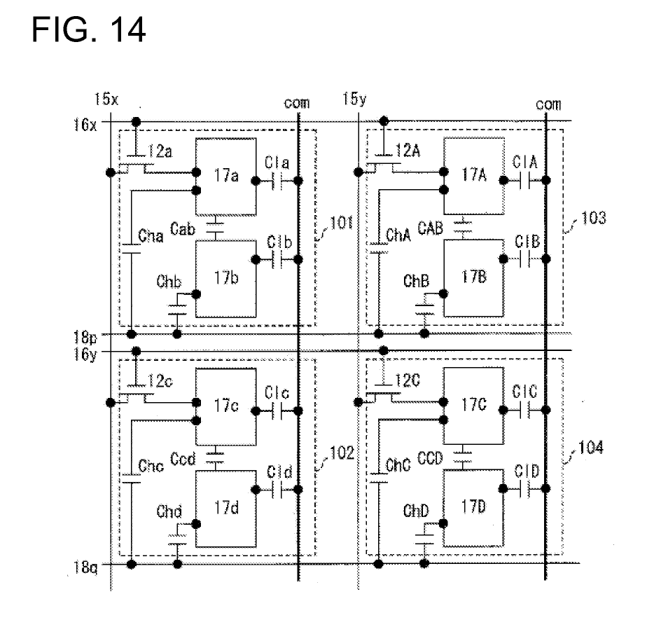

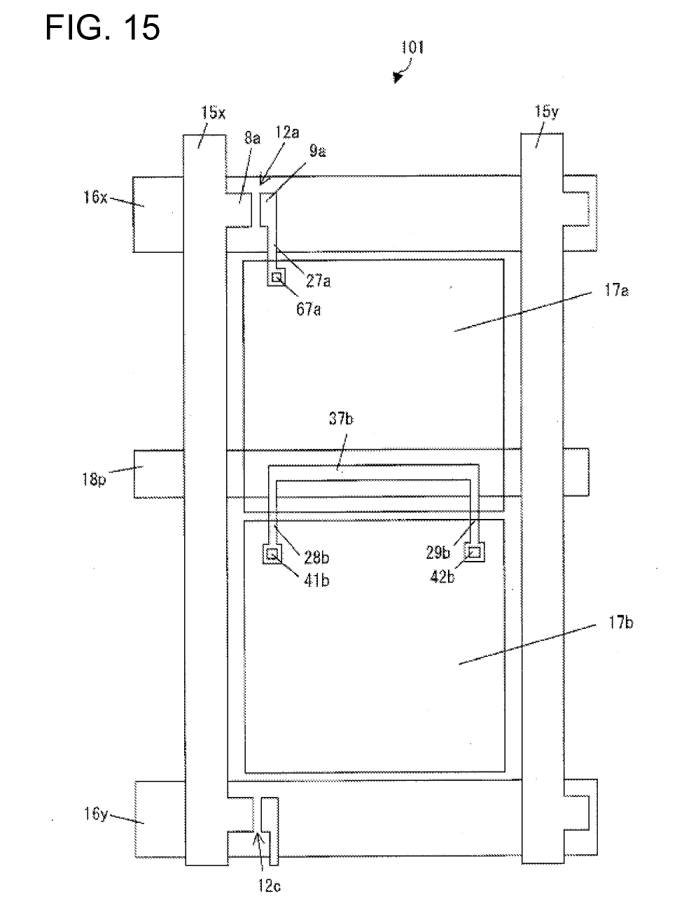

Here, although the liquid crystal panels described above have a structure in which the capacitance electrode is electrically connected to a pixel electrode corresponding to a sub-pixel that becomes a bright sub-pixel, the structure of the liquid crystal panel is not limited to such. As shown in FIG. 14, the present liquid crystal panel may have a configuration in which a capacitance electrode is electrically connected to a pixel electrode corresponding to a sub-pixel that becomes a dark sub-pixel. A specific example 101 of the pixel of FIG. 14 is shown in FIG. 15.

In the liquid crystal panel shown in FIG. 15, a transistor 12a is disposed in proximity of the intersection of the data signal line 15x and the scan signal line 16x. In the pixel region defined by the signal lines (15x and 16x), a rectangular-shaped pixel electrode 17a and a rectangular-shaped pixel electrode 17b are arranged in the column direction, and one of the four sides constituting the perimeter of the first pixel electrode and one of the four sides constituting the perimeter of the second pixel electrode are disposed adjacent to each other. The storage capacitance wiring 18p, which extends in the row direction, is disposed to overlap with the pixel electrode 17a.

Also, the capacitance electrode 37b is disposed to overlap with the storage capacitance wiring 18p and the pixel electrode 17a. More specifically, the capacitance electrode 37b extends in the same direction as the storage capacitance wiring 18p, and overlaps with the storage capacitance wiring 18p and the pixel electrode 17a.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a.

The capacitance electrode 37b overlaps with the pixel electrode 17a through the interlayer insulating film. The capacitance electrode 37b has two lead-out wirings 28b and 29b extending from the respective extending directional end portions of the capacitance electrode 37b towards the pixel electrode 17b, and end portions of the lead-out wirings are connected to the pixel electrode 17b through contact holes 41b and 42b, respectively. With this configuration, the coupling capacitance Cab (see FIG. 14) between the pixel electrodes 17a and 17b is formed where the capacitance electrode 37b and the pixel electrode 17a overlap with each other.

Further, the capacitance electrode 37b overlaps the storage capacitance wiring 18p through the gate insulating film, and the storage capacitance Chb (see FIG. 14) is formed at the location of the overlap. Also, the pixel electrode 17a and the storage capacitance wiring 18p overlap with each other through the interlayer insulating film and the gate insulating film, and a storage capacitance Cha (see FIG. 14) is formed at the location of the overlap.

Regarding the liquid crystal panel of FIG. 15, the sub-pixel that includes the pixel electrode 17a becomes “BR”, and the sub-pixel that includes the pixel electrode 17b becomes “DA”.

Regarding the liquid crystal panel of FIG. 15, the pixel electrode 17a and the capacitance electrode 37b are connected to each other through two contact holes, and a capacitance coupling is formed between the pixel electrode 17a and the pixel electrode 17b. Consequently, even if either one of the contact holes is not formed properly in the manufacturing process or the like (if a contact failure occurs between the capacitance electrode 37b and the pixel electrode 17b through either one of the contact holes), the connection between the capacitance electrode 37b and the pixel electrode 17b can be obtained through the other contact hole, and therefore, the capacitance coupling between the pixel electrodes 17a and 17b can be maintained.

If a short circuit occurs between the capacitance electrode 37b and the pixel electrode 17a, like the case shown in FIG. 8, the capacitance coupling of the pixel electrodes 17a and 17b can be maintained by conducting a repair process in which the inside of the contact hole proximal to the short circuit (contact hole 41b, for example) is removed (trimmed) by laser or the like to electrically isolate the pixel electrode 17a from the capacitance electrode 37b, and the capacitance electrode 37b is cut between the other contact hole (contact hole 42b, for example) and the short-circuit location by laser. In order to conduct the repair process described above, an opening is preferably formed in the storage capacitance wiring 18p around the center of the region where the capacitance electrode 37b overlaps with the storage capacitance wiring 18p.

Also, instead of trimming the contact hole 41b, the pixel electrode 17a and the capacitance electrode 37b may be electrically isolated from each other by cutting the lead-out wiring 28b by applying the laser from the front side of the active matrix substrate (the side away from the glass substrate) through the gap between the pixel electrodes 17a and 17b.

Needless to say, the structure shown in FIG. 14 in which the capacitance electrode is electrically connected to a pixel electrode corresponding to a sub-pixel that becomes a dark sub-pixel is applicable to liquid crystal panels described above.

### Embodiment 2

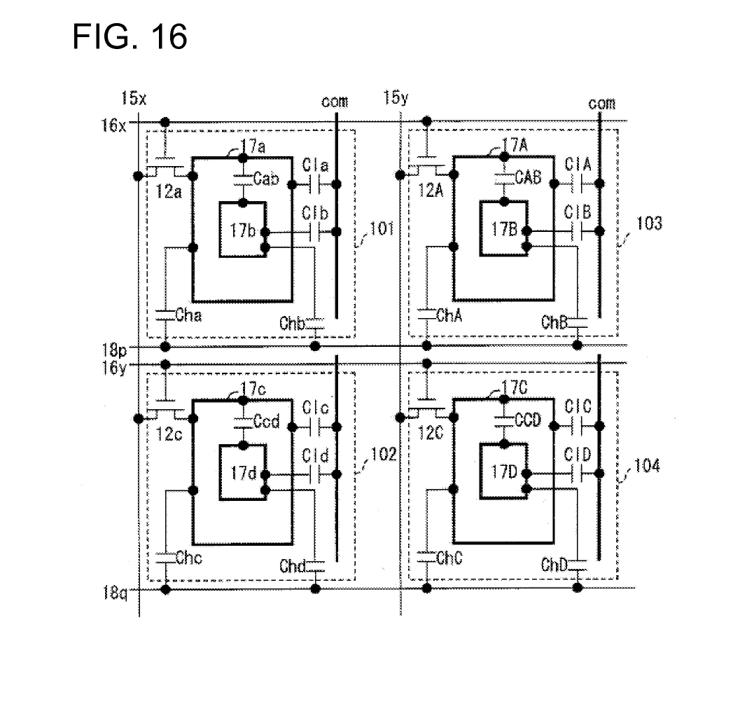

FIG. 16 is an equivalent circuit diagram showing a part of a liquid crystal panel according to Embodiment 2. As shown in FIG. 16, the present liquid crystal panel includes: data signal lines (15x and 15y) extending in a column direction (up and down directions in the figure); scan signal lines (16x and 16y) extending in a row direction (right and left directions in the figure); pixels arranged in the row and column directions (101 to 104); storage capacitance wirings (18p and 18q); and a common electrode (opposite electrode) com. All pixels have the same structure. The pixel column that includes pixels 101 and 102 and the pixel column that includes pixels 103 and 104 are adjacent to each other, and the pixel row that includes pixels 101 and 103 and the pixel row that includes pixels 102 and 104 are adjacent to each other.

For the present liquid crystal panel, one data signal line and one scan signal line are provided for each of the pixels. Also, in a single pixel, two pixel electrodes are provided such that one of them surrounds the other. In pixel 101, a pixel electrode 17b and a pixel electrode 17a surrounding the pixel electrode 17b are provided. In pixel 102, a pixel electrode 17d and a pixel electrode 17c surrounding the pixel electrode 17d are provided. In pixel 103, a pixel electrode 17B and a pixel electrode 17A surrounding the pixel electrode 17B are provided, and in pixel 104, a pixel electrode 17D and a pixel electrode 17C surrounding the pixel electrode 17D are provided.

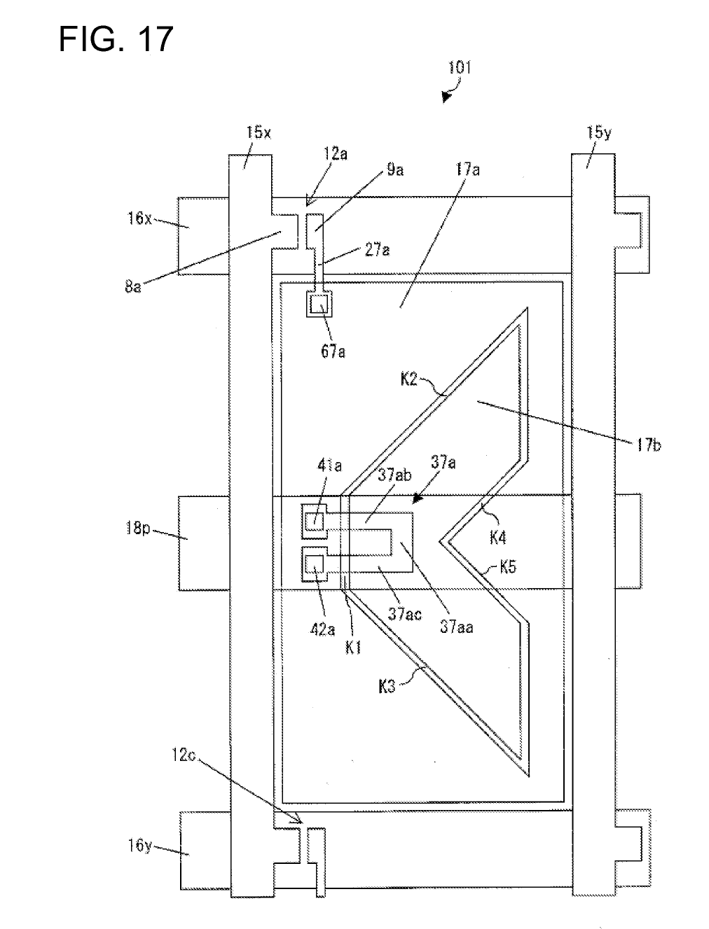

A specific example of pixel 101 of FIG. 16 is shown in FIG. 17. As shown in the figure, the transistor 12a is disposed in the proximity of the intersection of the data signal line 15x and the scan signal line 16x. In the pixel region defined by the signal lines (15x and 16x), the pixel electrode 17b, which is V-shaped when observed in the row direction, and the pixel electrode 17a, which surrounds the pixel electrode 17b, are disposed, and the storage capacitance wiring 18p extends in the row direction across the center of the pixel. More specifically, the pixel electrode 17b has the following: a first side, which is present over the storage capacitance wiring 18p and forms an angle of approx. 90° to the row direction; a second side, which extends from one end of the first side and forms an angle of approx. 45° to the row direction; a third side, which extends from the other end of the first side and forms an angle of approx. 315° to the row direction; a fourth side, which has its one end over the storage capacitance wiring 18p, and is parallel to and shorter than the second side; a fifth side, which is connected to one end of the fourth side, and is parallel to and shorter than the third side; a sixth side, which connects the second side and the fourth side; and a seventh side, which connects the third side and the fifth side. The inner perimeter of the pixel electrode 17a is composed of seven sides respectively facing the aforementioned first to seventh sides.

The gap between the first side of the pixel electrode 17b and a side of the inner perimeter of the pixel electrode 17a that faces the first side of the pixel electrode 17b is a first gap K1. The gap between the second side of the pixel electrode 17b and a side of the inner perimeter of the pixel electrode 17a that faces the second side of the pixel electrode 17b is a second gap K2. The gap between the third side of the pixel electrode 17b and a side of the inner perimeter of the pixel electrode 17a that faces the third side of the pixel electrode 17b is a gap K3. The gap between the fourth side of the pixel electrode 17b and a side of the inner perimeter of the pixel electrode 17a that faces the fourth side of the pixel electrode 17b is a fourth gap K4. The gap between the fifth side of the pixel electrode 17b and a side of the inner perimeter of the pixel electrode 17a that faces the fifth side of the pixel electrode 17b is a fifth gap K5.

Also, the capacitance electrode 37a is disposed to overlap with the first gap K1, the pixel electrode 17a, and the pixel electrode 17b. More specifically, the capacitance electrode 37a is composed of a first portion 37aa that forms an angle of approx. 90° to the row direction, and a second portion 37ab and a third portion 37ac that are connected to respective end portions of the first portion 37aa and are approximately parallel to the row direction. As a result, the capacitance electrode 37a is U-shaped where it overlaps with the storage capacitance wiring 18p.

Over the scan signal line 16x, a source electrode 8a and a drain electrode 9a of the transistor 12a are formed, and the source electrode 8a is connected to the data signal line 15x. The drain electrode 9a is connected to the drain lead-out wiring 27a, and the drain lead-out wiring 27a is connected to the pixel electrode 17a through the contact hole 67a.

The capacitance electrode 37a overlaps with the pixel electrode 17b through the interlayer insulating film. Also, the second portion 37ab and the third portion 37ac of the capacitance electrode 37a extend towards the pixel electrode 17a, and their end portions are connected to the pixel electrode 17a through the contact holes 41a and 42a. This way, a coupling capacitance Cab (see FIG. 16) between the pixel electrodes 17a and 17b is formed where the capacitance electrode 37a and the pixel electrode 17b overlap with each other.

Further, the capacitance electrode 37a overlaps with the storage capacitance wiring 18p through the gate insulating film, and most of a storage capacitance Cha (see FIG. 16) is formed at the location of the overlap. Also, the pixel electrode 17b and the storage capacitance wiring 18p overlap with each other through the interlayer insulating film and the gate insulating film, and a storage capacitance Chb (see FIG. 16) is formed at the location of the overlap.

For the liquid crystal panel of FIG. 17, the drain electrode 9a of the transistor 12a is connected to the pixel electrode 17a through the contact hole 67a, and the pixel electrode 17a and the capacitance electrode 37a are connected to each other through the contact holes 41a and 42a. This way, the drain lead-out wiring that connects the drain electrode 9a and the capacitance electrode 37a together can be made shorter, which improves the aperture ratio. For the liquid crystal panel of FIG. 17, the pixel electrode 17a and the capacitance electrode 37a are connected together through two contact holes to form a capacitance coupling between the pixel electrode 17a and the pixel electrode 17b. As a result, even if either one of the contact holes is not formed properly in the manufacturing process or the like (if a contact failure between the capacitance electrode 37a and the pixel electrode 17a occurs in either one of the contact holes), the connection between the capacitance electrode 37a and the pixel electrode 17a can be obtained through the other contact hole, and therefore the capacitance coupling between the pixel electrodes 17a and 17b can be maintained.

If a short circuit occurs between the capacitance electrode 37a and the storage capacitance wiring 18p or the pixel electrode 17b, the capacitance coupling between the pixel electrodes 17a and 17b can still be maintained by conducting a repair process in which the inside of the contact hole proximal to the short-circuit site (contact hole 41a, for example) is removed (trimmed) with laser or the like, and the capacitance electrode 37a is cut between the other contact hole (contact hole 42a, for example) and the short-circuit location with laser. In order to conduct the repair process described above, an opening is preferably formed in the storage capacitance wiring 18p around the center of the region where the storage capacitance wiring 18p overlaps with the capacitance electrode 37a (where the storage capacitance wiring 18p overlaps with the first portion 37aa of the capacitance electrode 37a, for example).

As described above, according to the present embodiment, the production yield of the liquid crystal panels and the active matrix substrates for use in the liquid crystal panels can be increased without lowering the aperture ratio of the pixel region.

Also, for the liquid crystal panel of FIG. 17, the capacitance electrode 37a overlaps with the pixel electrode 17b and the storage capacitance wiring 18p. As described above, by utilizing the capacitance electrode 37 provided to form a coupling capacitance as an electrode for forming a storage capacitance, the aperture ratio can further be increased.

Also, for the liquid crystal panel of FIG. 17, the pixel electrode 17b, which is electrically floating, is surrounded by the pixel electrode 17a. As a result, the pixel electrode 17a functions as a shield electrode to suppress jumping of electrical charge or the like into the pixel electrode 17b. Consequently, burning of the sub-pixel that includes the pixel electrode 17b (dark sub-pixel) can be suppressed.

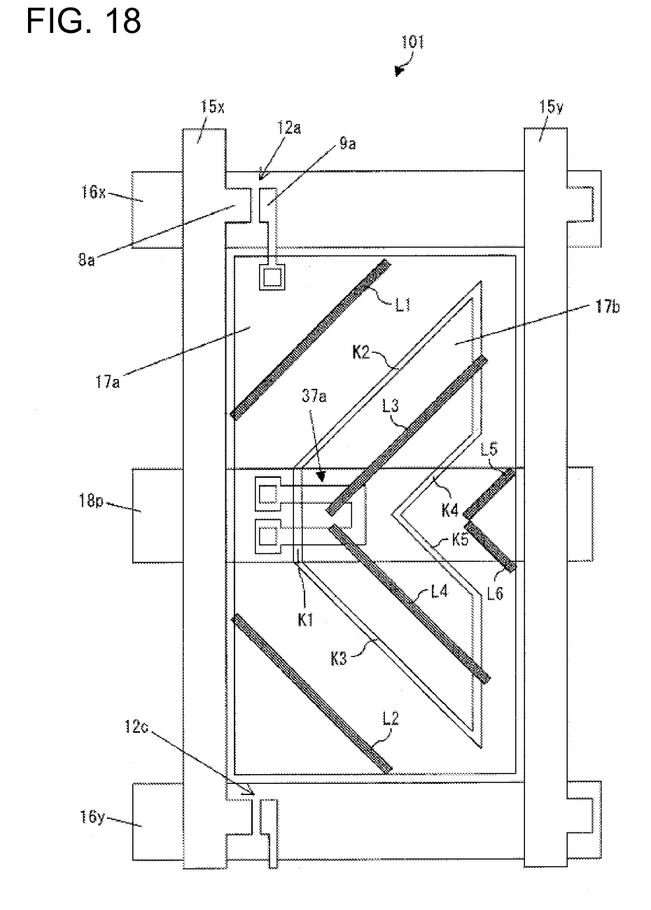

Although the alignment control structures are omitted in FIG. 17, for an MVA (multi-domain vertical alignment) system liquid crystal panel as shown in FIG. 18, for example, gaps K2 to K5 of pixel electrodes 17a and 17b function as alignment control structures. On the color filter substrate, at the location corresponding to the pixel electrode 17b, a rib L3 that is parallel to the gaps K2 and K4, and a rib L4 that is parallel to gaps K3 and K5 are disposed. On the color filter substrate, at the location corresponding to the pixel electrode 17a, ribs L1 and L5, which are parallel to gaps K2 and K4, and ribs L2 and L6, which are parallel to gaps K3 and K5, are disposed. Here, instead of providing the aforementioned alignment control ribs, alignment control slits may be provided in the common electrode of the color filter substrate.

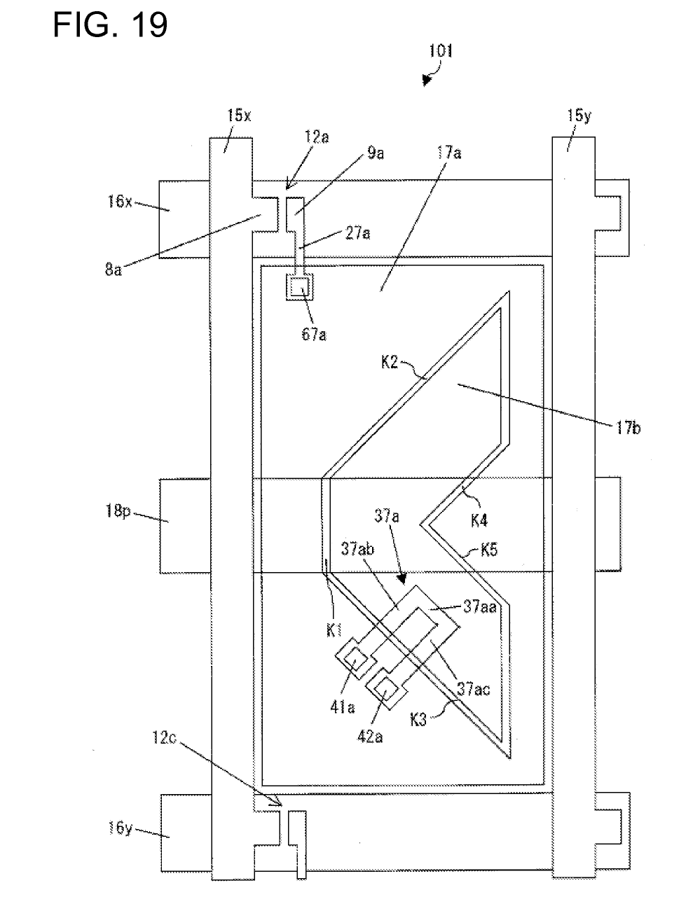

Pixel 101 of FIG. 17 may be modified as shown in FIG. 19. In the configuration shown in FIG. 19, the capacitance electrode 37a extends to cross the third gap K3 and to form an angle of 225° to the row direction. The capacitance electrode 37a does not overlap with the storage capacitance wiring 18p. The shape of the capacitance electrode 37a is about the same as that of the capacitance electrode 37a shown in FIG. 17.

The drain electrode 9a of the transistor 12a is connected to the drain lead-out wiring 27a, and the drain lead-out wiring 27a is connected to the pixel electrode 17a through the contact hole 67a.

The capacitance electrode 37a, which is composed of the first portion 37aa, the second portion 37ab, and the third portion 37ac, overlaps with the pixel electrode 17b through the interlayer insulating film. Also, a second portion 37ab and a third portion 37ac of the capacitance electrode 37a extend towards the pixel electrode 17a, and their end portions are connected to the pixel electrode 17a through the contact holes 41a and 42a. As a result, a coupling capacitance Cab (see FIG. 16) between the pixel electrodes 17a and 17b is formed where the capacitance electrode 37a and the pixel electrode 17b overlap.

A portion of the pixel electrode 17a overlaps the storage capacitance wiring 18p through the gate insulating film and the interlayer insulating film, and a storage capacitance Cha (see FIG. 16) is formed at the location of the overlap. Also, a portion of the pixel electrode 17b overlaps the storage capacitance wiring 18p through the gate insulating film and the interlayer insulating film, and a storage capacitance Chb (see FIG. 16) is formed at the location of the overlap.

For the liquid crystal panel of FIG. 19, if a short circuit occurs between the capacitance electrode 37a and the pixel electrode 17b, the capacitance coupling between the pixel electrodes 17a and 17b can be maintained by conducting a repair process in which the inside of the contact hole proximal to the short-circuit location (contact hole 41a, for example) is removed (trimmed) by laser or the like, and the capacitance electrode 37a is cut between the other contact hole (contact hole 42a, for example) and the short-circuit location.

Alternatively, instead of trimming the inside of the contact hole, the capacitance electrode 37a can be cut by radiating the laser from the front side of the active matrix substrate (the side away from the glass substrate) through the third gap K3 to electrically isolate the pixel electrode 17a and the capacitance electrode 37a from each other.

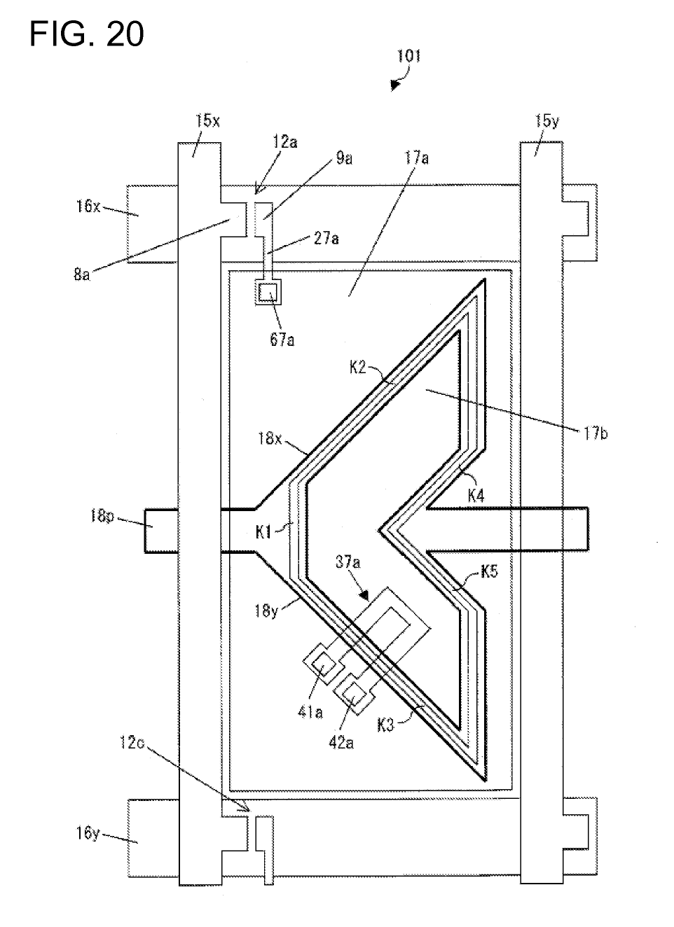

Pixel 101 of FIG. 19 may be modified as shown in FIG. 20. In the configuration of FIG. 20, a storage capacitance wiring extended portion 18x is provided, which extends from the storage capacitance wiring 18p to overlap the first side, second side, sixth side and fourth side of the pixel electrode 17b and merges into the storage capacitance wiring 18p again; and a storage capacitance wiring extended portion 18y is provided, which extends from the storage capacitance wiring 18p to overlap the first side, third side, seventh side, and fifth side of the pixel electrode 17b and merges into the storage capacitance wiring 18p again.

For the liquid crystal panel of FIG. 20, the storage capacitance wiring extended portions 18x and 18y surround the pixel electrode 17b, which is electrically floating. Because the storage capacitance wiring extended portions 18x and 18y function as the shield electrode for the pixel electrode 17b, problems such as jumping of electric charge to the pixel electrode 17b can be more effectively suppressed. Consequently, burning of the sub-pixel that includes the pixel electrode 17b (dark sub-pixel) can be suppressed.

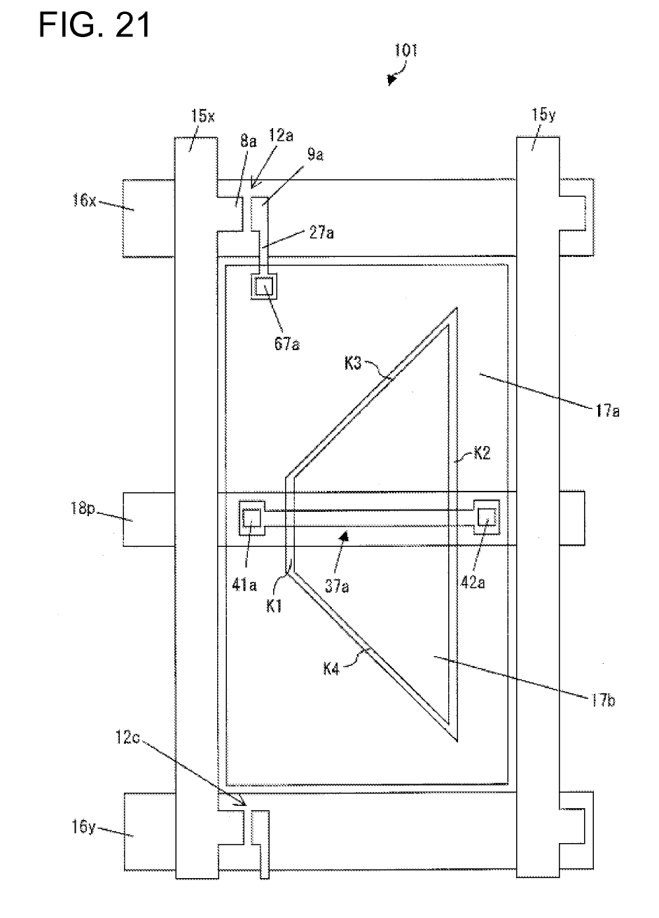

Another specific example of pixel 101 of FIG. 16 is shown in FIG. 21. As shown in the figure, a transistor 12a is disposed in proximity of the intersection of the data signal line 15x and the scan signal line 16x. In the pixel region defined by the signal lines (15x and 16x), a pixel electrode 17b having a trapezoidal shape when observed in the row direction and the pixel electrode 17a that surrounds the pixel electrode 17b are disposed, and the storage capacitance wiring 18p extends in the row direction across the center of the pixel. More specifically, pixel electrode 17b intersects with the storage capacitance wiring 18p, and has a first side that forms an angle of approx. 90° to the row direction, a second side that is parallel to the first side and intersects with the storage capacitance wiring 18p, a third side that extends from one end of the first side to form an angle of approx. 45° to the row direction, and a fourth side that extends from the other end of the first side to form an angle of approx. 315° to the row direction. The inner perimeter of the pixel electrode 17a is composed of four sides that respectively face the first to fourth sides, and the outer perimeter of the pixel electrode 17a is rectangular-shaped.

The gap between the first side of the pixel electrode 17b and a side of the inner perimeter of the pixel electrode 17a that faces the first side of the pixel electrode 17b is a first gap K1, and the gap between the second side of the pixel electrode 17b and a side of the inner perimeter of the pixel electrode 17a that faces the second side of the pixel electrode 17b is a second gap K2. The capacitance electrode 37a is disposed to overlap the pixel electrode 17a, the first gap K1, pixel electrode 17b, and the second gap K2.

More specifically, the capacitance electrode 37a is shaped such that it extends in the row direction to intersect with the first gap K1 and the second gap K2, and is disposed in the row direction to overlap with the storage capacitance wiring 18p. That is, the capacitance electrode 37a is disposed to overlap with the storage capacitance wiring 18p, and to extend in the row direction across the pixel electrode 17b.

Over the scan signal line 16x, a source electrode 8a and a drain electrode 9a of the transistor 12a are formed, and the source electrode 8a is connected to the data signal line 15x. The drain electrode 9a is connected to the drain lead-out wiring 27a, and the drain lead-out wiring 27a is connected to the pixel electrode 17a through the contact hole 67a.

The capacitance electrode 37a overlaps with the pixel electrode 17b through the interlayer insulating film. The both end portions (end portions in the row direction) of the capacitance electrode 37a extend to the pixel electrode 17a, and end portions of the extended portions are connected to the pixel electrode 17a through the contact holes 41a and 42a. As a result, a coupling capacitance Cab (see FIG. 16) between the pixel electrode 17a and 17b is formed where the capacitance electrode 37a and the pixel electrode 17b overlap with each other.

Further, the capacitance electrode 37a overlaps with the storage capacitance wiring 18p through the gate insulating film, and most of a storage capacitance Cha (see FIG. 16) is formed at the location of the overlap. Also, the pixel electrode 17b and the storage capacitance wiring 18p overlap through the interlayer insulating film and the gate insulating film, and a storage capacitance Chb (see FIG. 16) is formed at the location of the overlap.

For the liquid crystal panel of FIG. 21, the drain electrode 9a of the transistor 12a is connected to the pixel electrode 17a through the contact hole 67a, and the pixel electrode 17a and the capacitance electrode 37a are connected to each other through the contact holes 41a and 42a. As a result, the drain lead-out wiring connecting the drain electrode 9a and the capacitance electrode 37a together can be made short, which improves the aperture ratio. For the liquid crystal panel of FIG. 21, the pixel electrode 17a and the capacitance electrode 37a are connected to each other through two contact holes to form a capacitance coupling between the pixel electrode 17a and the pixel electrode 17b. For this reason, even if one of the contact holes is not formed properly in the manufacturing process or the like (if a contact failure occurs between the capacitance electrode 37a and pixel electrode 17a via either one of the contact holes), the connection between the capacitance electrode 37a and the pixel electrode 17a can be obtained via the other contact hole. The capacitance coupling between the pixel electrodes 17a and 17b can therefore be maintained.

If a short circuit occurs between the capacitance electrode 37a and the storage capacitance wiring 18p or the pixel electrode 17b, the capacitance coupling between the pixel electrodes 17a and 17b can be maintained by conducting a repair process in which the inside of the contact hole proximal to the short-circuit location (contact hole 41a, for example) is removed (trimmed) by laser or the like, and the capacitance electrode 37a is cut between the other contact hole (contact hole 42a, for example) and the short-circuit location by laser. In order to conduct the repair process described above, an opening is preferably formed about at the center of the area where the storage capacitance wiring 18p overlaps with the capacitance electrode 37a.

As described above, according to the present embodiment, the production yield of liquid crystal panels and active matrix substrates for the use in the active matrix substrates can be increased.

Also, for the liquid crystal panel of FIG. 21, the capacitance electrode 37a is disposed in the direction in which the storage capacitance wiring 18p extends (the row direction) so that the capacitance electrode 37a overlaps with the storage capacitance wiring 18p. The capacitance electrode 37a extends to the pixel electrode 17a, across the first gap K1 and the second gap K2. As a result, even if the pixel electrodes 17a and 17b are misaligned in the row direction against the capacitance electrode 37a, the area where the capacitance electrode 37a and the pixel electrode 17b overlap with each other can be maintained constant. The total value of the coupling capacitance Cab, therefore, is likely to remain unchanged, which is a beneficial effect.

Also, for the liquid crystal panel of FIG. 21, the capacitance electrode 37a overlaps with the pixel electrode 17b and the storage capacitance wiring 18p. Thus, by utilizing the capacitance electrode 37a, which is provided to form a coupling capacitance, as an electrode for forming a storage capacitance, the aperture ratio can be improved.

Further, the capacitance electrode 37a extends in the row direction, and capacitance electrodes are arranged in the row direction to overlap the storage capacitance wiring 18p. The line width of the storage capacitance wiring 18p can therefore be made smaller. This configuration can further increase the aperture ratio.

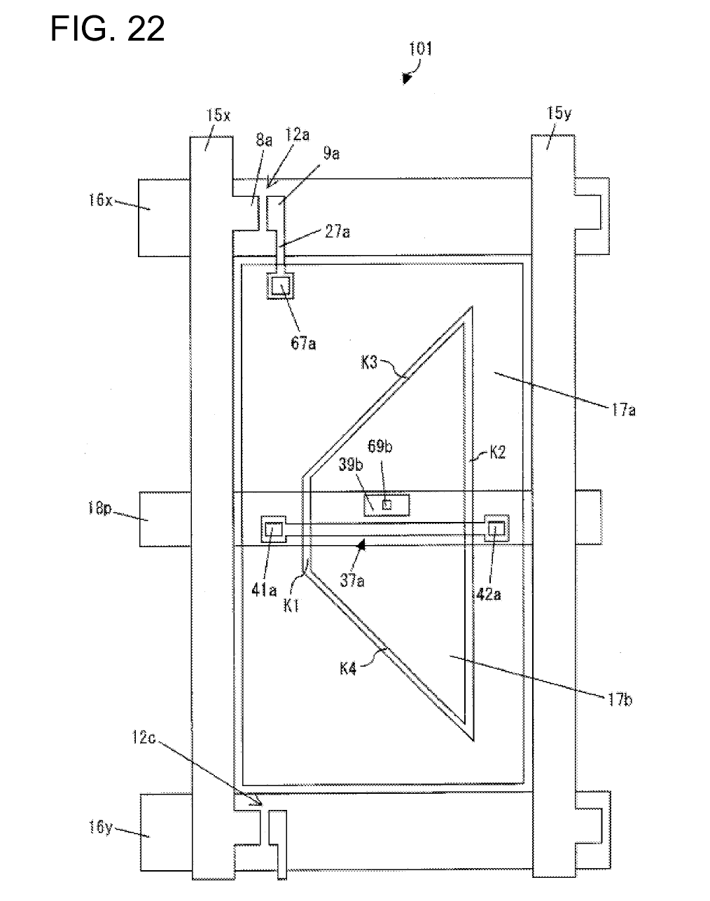

The capacitance value of the storage capacitance Chb is preferably large from the perspective of the reliability. The storage capacitance Chb, therefore, may be formed according to the configuration shown in FIG. 22. That is, as shown in FIG. 22, a storage capacitance electrode 39b formed in the same layer as the capacitance electrode 37a is connected to the pixel electrode 17b through the contact hole 69b. As a result, a storage capacitance Chb is formed between the storage capacitance electrode 39b and the storage capacitance wiring 18p. In this configuration, as shown in FIG. 21, compared to the case in which the storage capacitance Chb is formed between the pixel electrode 17b and the storage capacitance wiring 18p, the insulating film interposed between them can be made small (thin). Consequently, the storage capacitance value can be increased. Also, because the insulating film that forms the storage capacitance Chb can be made thinner, the width of the storage capacitance wiring 18p can be made smaller without changing the storage capacitance value. As a result, the aperture ratio can be improved without sacrificing the reliability.

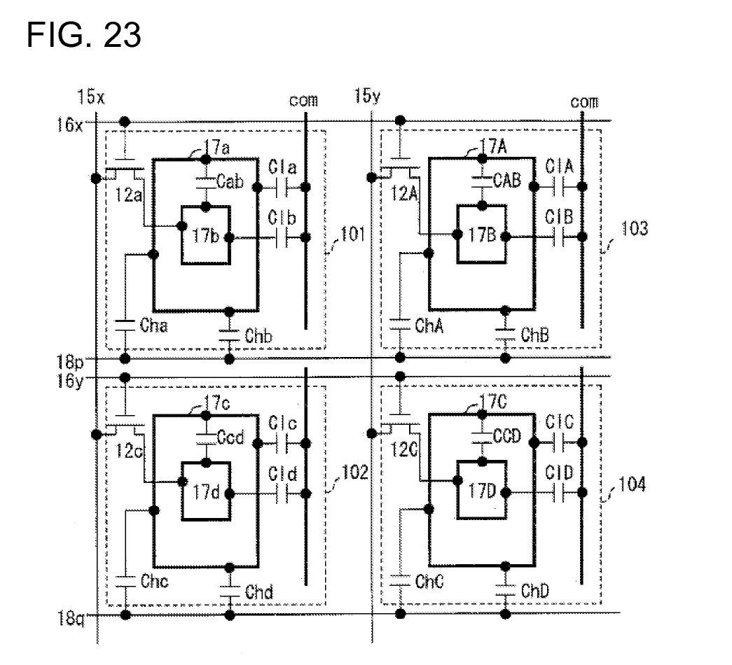

Here, in FIG. 16, one of the two pixel electrodes provided in a single pixel surrounds the other pixel, and the surrounding pixel electrode is connected to the transistor. However, the configuration is not limited to such. As shown in FIG. 23, when one of the two pixel electrodes provided in a single pixel surrounds the other pixel, the surrounded pixel may be connected to the transistor.

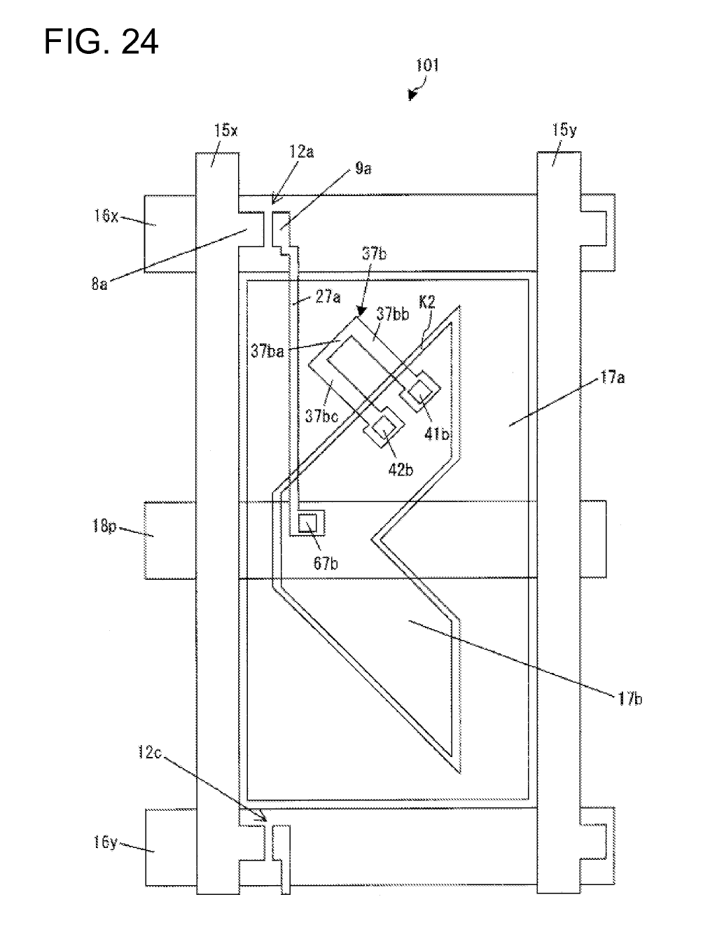

A specific example of pixel 101 of FIG. 23 is shown in FIG. 24. As shown in the figure, the shapes and arrangements of the pixel electrodes 17a and 17b and the storage capacitance wiring 18p are the same as those of FIG. 17. In the embodiment shown in FIG. 23 and FIG. 24, the pixel electrode 17b corresponds to the first pixel electrode, and the pixel electrode 17a corresponds to the second pixel electrode.

The capacitance electrode 37b is disposed such that it overlaps the second gap K2, the pixel electrode 17a, and the pixel electrode 17b. That is, in the configuration of FIG. 24, the capacitance electrode 37b is disposed to intersect with the second gap K2, and extends to form an angle of approx. 135° to the row direction. The capacitance electrode 37b does not overlap the storage capacitance wiring 18p. The shape of the capacitance electrode 37b is about the same as that of the capacitance electrode 37a shown in FIG. 17.

Over the scan signal line 16x, a source electrode 8a and a drain electrode 9a of the transistor 12a are formed, and the source electrode 8a is connected to the data signal line 15x. The drain electrode 9a is connected to the pixel electrode 17b through the drain lead-out wiring 27a and the contact hole 67b.

The capacitance electrode 37b, which is composed of a first portion 37ba, a second portion 37bb, and a third portion 37bc, overlaps with the pixel electrode 17a through an interlayer insulating film. Also, the capacitance electrode 37b has a second portion 37bb and a third portion 37bc extending to the pixel electrode 17b, and their end portions are connected to the pixel electrode 17b through the contact holes 41b and 42b, respectively. Consequently, a coupling capacitance Cab (see FIG. 23) between the pixel electrodes 17a and 17b is formed where the capacitance electrode 37b and the pixel electrode 17a overlap with each other.

Also, a portion of the pixel electrode 17a overlaps the storage capacitance wiring 18p through the gate insulating film and the interlayer insulating film, and a storage capacitance Cha (see FIG. 23) is formed at the location of the overlap. Also, the portion of the pixel electrode 17b overlaps the storage capacitance wiring 18p through the gate insulating film and the interlayer insulating film, and a storage capacitance Chb (see FIG. 23) is formed at the location of the overlap.

For the liquid crystal panel of FIG. 24, the sub-pixel that includes the pixel electrode 17a becomes “DA”, and the sub-pixel that includes the pixel electrode 17b becomes “BR”.

For the liquid crystal panel of FIG. 24, the pixel electrode 17b and the capacitance electrode 37b are connected to each other through two contact holes, and a capacitance coupling between the pixel electrode 17a and the pixel electrode 17b is formed. Consequently, even if either one of the contact holes is not formed properly in the manufacturing process or the like (if a contact failure occurs between the capacitance electrode 37b and the pixel electrode 17b through either one of the contact holes), the connection between the capacitance electrode 37b and the pixel electrode 17b can be obtained through the other contact hole, and therefore, the capacitance coupling between the pixel electrodes 17a and 17b can be maintained.

Thus, according to the embodiment described above, the production yield of liquid crystal panels and the active matrix substrate for use in the liquid crystal panels can be increased. However, from the perspective of suppressing the aperture ratio reduction, a configuration in which the pixel electrode 17a that is disposed closer to the transistor 12a is connected to the drain electrode 9a (the structure shown in FIG. 19, for example) is preferable than the structure shown in FIG. 24.

Because the liquid crystal panel of FIG. 24 has a structure in which the pixel electrode 17a corresponding to a dark sub-pixel surrounds the pixel electrode 17b corresponding to a bright sub-pixel, images with a high spatial frequency can be displayed clearly.

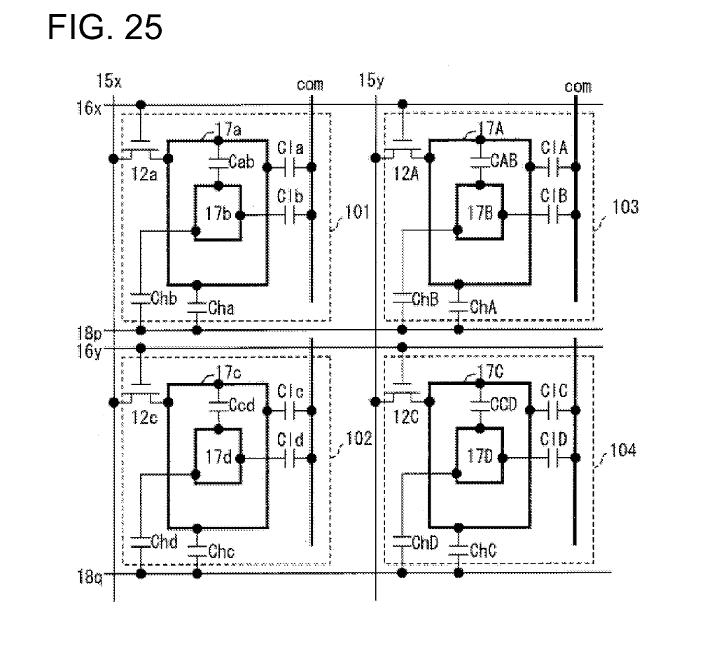

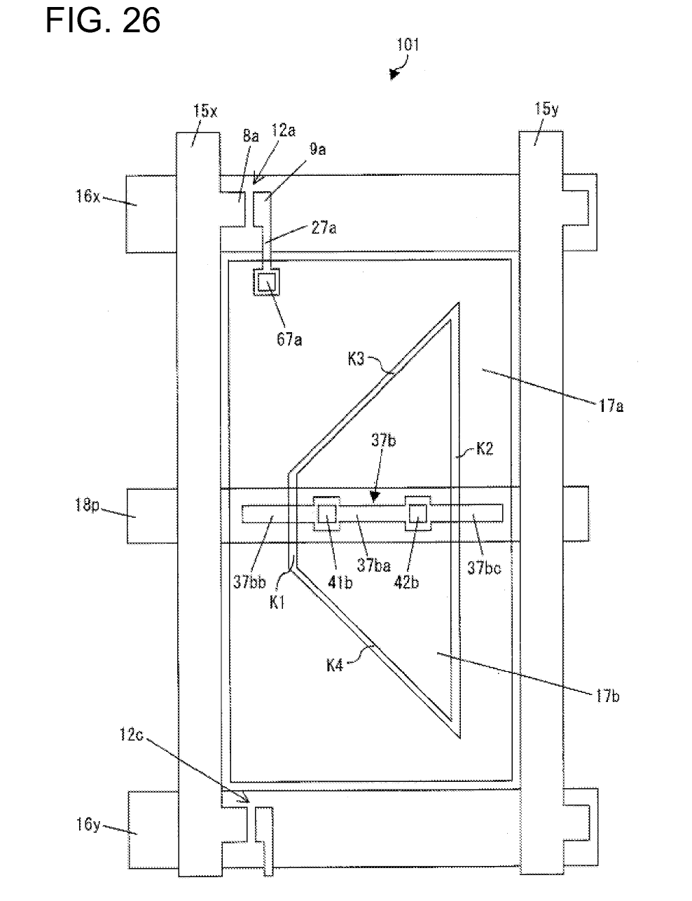

Here, the liquid crystal panel described above has a structure in which the capacitance electrode is electrically connected to a pixel electrode corresponding to a bright sub-pixel, but the configuration is not limited to such. The present liquid crystal panel may have a configuration, as shown in FIG. 25, in which the capacitance electrode is electrically connected to a pixel electrode corresponding to a sub-pixel that becomes a dark sub-pixel. A specific example 101 of the pixel of FIG. 25 is shown in FIG. 26.

For the liquid crystal panel of FIG. 26, like in the case of the liquid crystal panel of FIG. 21, a transistor 12a is disposed in proximity of the intersection of the data signal line 15x and the scan signal line 16x. In the pixel region defined by the signal lines (15x and 16x), a pixel electrode 17b having a trapezoidal shape when observed in the row direction and a pixel electrode 17a that surrounds the pixel electrode 17b are disposed, and the storage capacitance wiring 18p extends in the row direction, passing through the center of the pixel.

More specifically, the capacitance electrode 37b extends in the row direction such that it intersects with the first gap K1 and the second gap K2, and overlaps with the storage capacitance wiring 18p. That is, the capacitance electrode 37b is disposed to overlap with the storage capacitance wiring 18p, and to extend in the row direction across the pixel electrode 17b.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a.

The capacitance electrode 37b overlaps with the pixel electrode 17b through the interlayer insulating film. The row directional end portions of the capacitance electrode 37b extend to the pixel electrode 17a, and overlap with the pixel electrode 17a through the interlayer insulating film. The capacitance electrode 37b is connected to the pixel electrode 17b through two contact holes 41b and 42b. For convenience, the capacitance electrode 37b is divided into a center portion 37ba, a left end portion 37bb, and a right end portion 37bc. A contact hole 41b is present between the center portion 37ba and the left end portion 37bb, and a contact hole 42b is present between the center portion 37ba and the right end portion 37bc.

The left end portion 37bb extends to the pixel electrode 17a across the first gap K1, and the right end portion 37bc extends to the pixel electrode 17a across the second gap K2. As a result, a coupling capacitance Cab (see FIG. 25) between the pixel electrodes 17a and 17b is formed where the capacitance electrode 37b and the pixel electrode 17a overlap with each other.

Further, the capacitance electrode 37b overlaps with the storage capacitance wiring 18p through the gate insulating film, and most of the storage capacitance Chb (see FIG. 25) is formed at the location of the overlap. Also, the pixel electrode 17a and the storage capacitance wiring 18p overlap through the interlayer insulating film and the gate insulating film, and a storage capacitance Cha (see FIG. 25) is formed at the location of the overlap.

Consequently, the sub-pixel that includes the pixel electrode 17a becomes “BR”, and the sub-pixel that includes the pixel electrode 17b becomes “DA”.

For the liquid crystal panel of FIG. 26, the pixel electrode 17b and the capacitance electrode 37b are connected together through two contact holes, forming a capacitance coupling between the pixel electrode 17a and the pixel electrode 17b. Consequently, even if either one of the contact holes is not formed properly in the manufacturing process or the like (if a contact failure occurs between the capacitance electrode 37b and the pixel electrode 17b through either one of the contact holes), the connection between the capacitance electrode 37b and the pixel electrode 17b can be obtained through the other of the contact holes, and therefore, the capacitance coupling between the pixel electrodes 17a and 17b can be maintained.

Needless to say, the configuration shown in FIG. 26 in which a capacitance electrode is electrically connected to a pixel electrode corresponding to a sub-pixel that becomes a dark sub-pixel is applicable to liquid crystal panels described above.

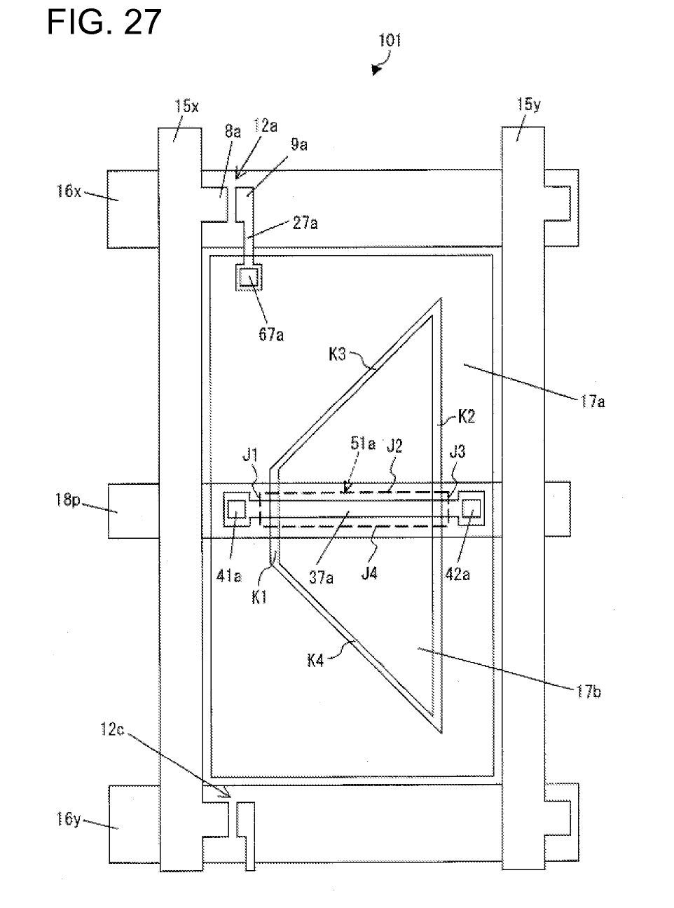

Also for the liquid crystal panel according to Embodiment 2, like the case with the liquid crystal panel according to Embodiment 1 (see FIG. 4), a thick organic gate insulating film 21 and a thin inorganic gate insulating film 22 may be formed over the glass substrate 31, and a thin inorganic interlayer insulating film 25 and a thick organic interlayer insulating film 26 may be formed under the pixel electrode. This configuration provides effects such as reduction in various parasitic capacitances, prevention of short-circuiting between wirings, and reduction of problems such as torn pixel electrode due to planarization. Also in this case, in the region indicated by dashed line in FIG. 27, for example, the portion of the organic gate insulating film 21 located under the capacitance electrode 37a is preferably removed, and the portion of the organic interlayer insulating film 26 located over the capacitance electrode 37a is preferably removed, as shown in FIG. 4. This way, the effects described above can be obtained while ensuring sufficient capacitance values of the coupling capacitance (Cab) and the storage capacitances (Cha and Chb).

Also, the removed portion of the organic interlayer insulating film 26 (thin film portion 51a) shown in FIG. 27 is formed into a rectangular shape composed of first (J1) to fourth sides (J4), and the capacitance electrode 37a extends to cross the first side (J1) and the third side (J3) facing the first side (J1). As a result, even if the capacitance electrode 37a is misaligned in the row direction, the overlapped area of the capacitance electrode 37a and the pixel electrode 17b stays about the same, and the total value of the coupling capacitance is likely to remain unchanged, which is a beneficial effect.

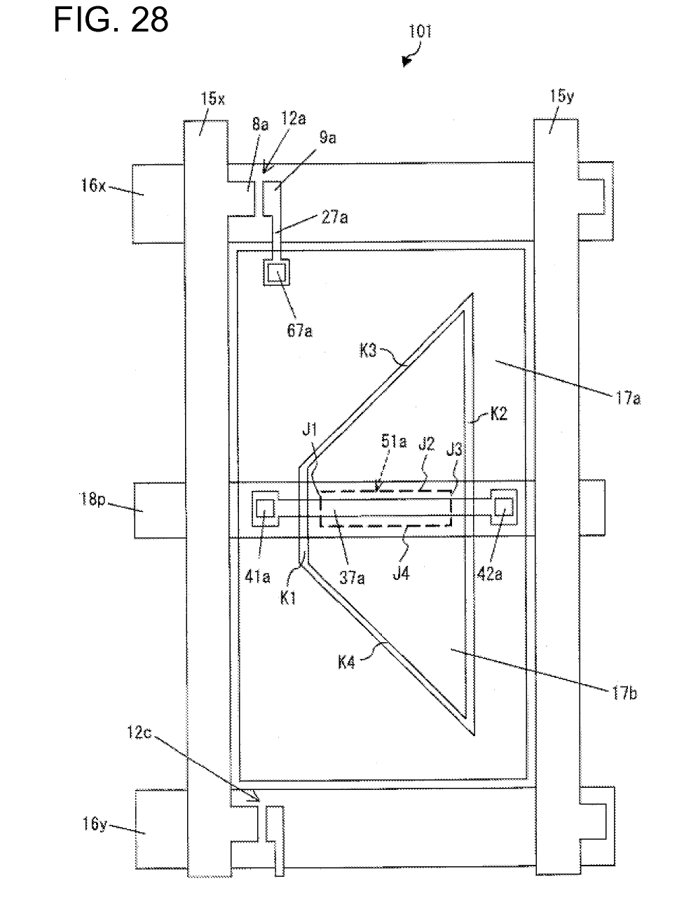

The thin film portion 51a shown in FIG. 27 may be formed within the region of the pixel electrode 17b as shown in FIG. 28 such that it overlaps only with the pixel electrode 17b. In that case, the first (J1) to fourth sides (J4) constituting the rectangular-shaped thin film portion 51a are disposed inside the pixel electrode 17b region. Consequently, because the overlapped area of the capacitance electrode 37a and the pixel electrode 17b in the thin film portion 51a is reduced, in addition to the effect obtained from the configuration shown in FIG. 27 (the total value of the coupling capacitance is likely to remain unchanged), another effect is obtained, which is a lower probability of the short circuit occurrence between the capacitance electrode 37a and the pixel electrode 17b.

### Embodiment 3

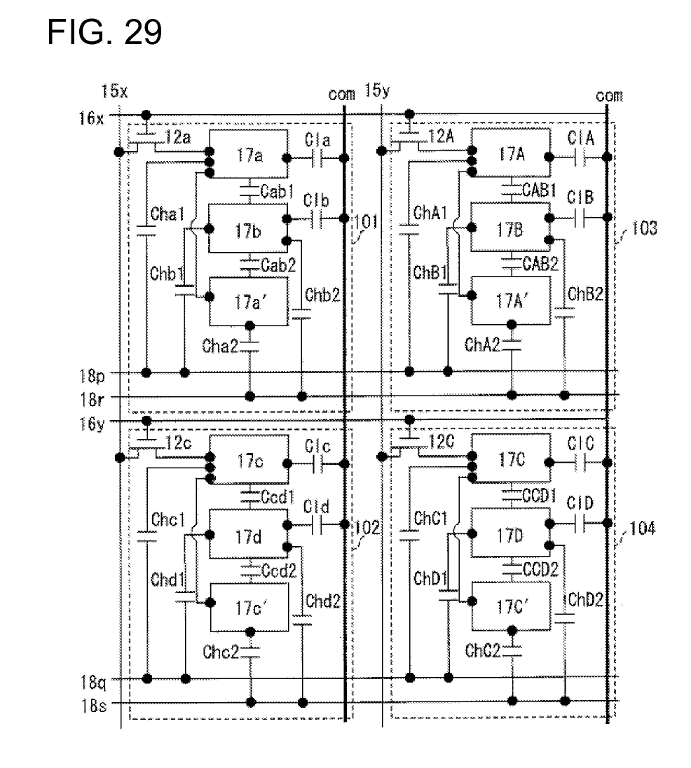

FIG. 29 is an equivalent circuit diagram showing a part of the liquid crystal panel according to Embodiment 3. As shown in FIG. 29, the present liquid crystal panel includes: data signal lines (15x and 15y) extending in a column direction (up and down directions in the figure); scan signal lines (16x and 16y) extending in a row direction (right and left directions in the figure); pixels (101 to 104) arranged in the row and column directions; storage capacitance wirings (18p to 18s); and a common electrode (opposite electrode) com. All pixels have the same structure. The pixel column that includes pixels 101 and 102 and the pixel column that includes pixels 103 and 104 are adjacent to each other, and the pixel row that includes pixels 101 and 103 and the pixel row that includes pixels 102 and 104 are adjacent to each other.

The present liquid crystal panel has one data signal line, one scan signal line, and two storage capacitance wirings for one pixel. Also, three pixel electrodes are provided in a single pixel. That is, in pixel 101, pixel electrodes 17a, 17b, and 17a′ are provided; in pixel 102, pixel electrodes 17c, 17d, and 17c′ are provided; in pixel 103, pixel electrodes 17A, 17B, and 17A′ are provided; and in pixel 104, pixel electrodes 17C, 17D, and 17C′ are provided.

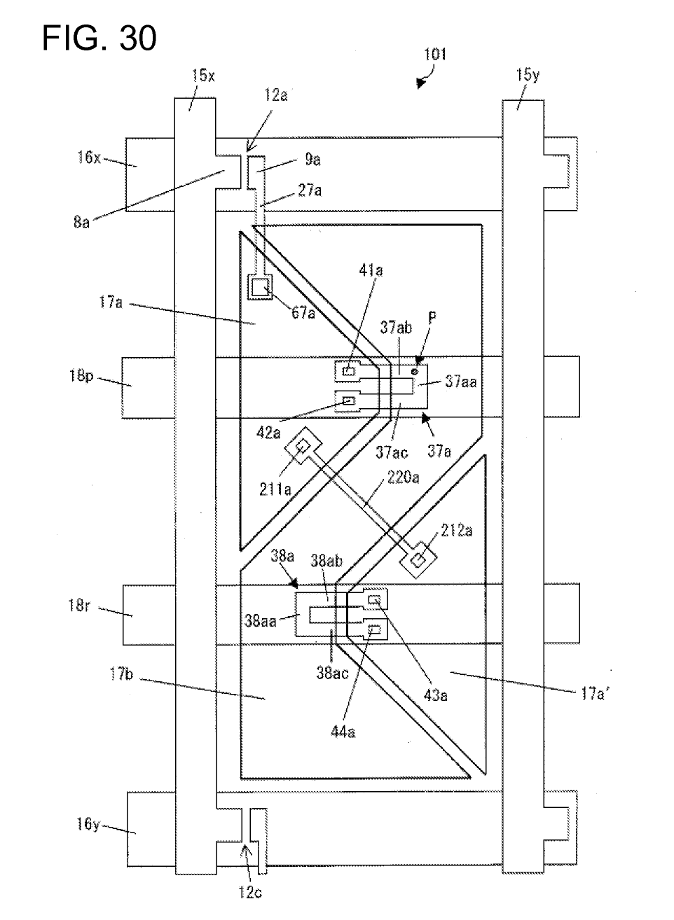

A specific example of pixel 101 of FIG. 29 is shown in FIG. 30. As shown in the figure, a transistor 12a is disposed in proximity of the intersection of the data signal line 15x and the scan signal line 16x. The pixel region defined by the signal lines (15x and 16x) includes: a pixel electrode 17a that has a trapezoidal shape; a pixel electrode 17a′ that is located at approximately 315° to the row direction of the storage capacitance wiring 18p, and has a trapezoidal shape that approximates the shape of the pixel electrode 17a that has been rotated by 180°; and a pixel electrode 17b disposed in the region not occupied by the pixel electrode 17a or 17a′, such that it corresponds to (fits against) the shapes of the pixel electrodes 17a and 17a′. The storage capacitance wirings 18p and 18r are disposed in parallel with each other, the storage capacitance wiring 18p extends in the row direction across the pixel electrodes 17a and 17b, and the storage capacitance wiring 18r extends in the row direction across the pixel electrodes 17b and 17a′.

With this configuration, the pixel electrodes 17a, 17b, and 17a′ are arranged such that a portion of the pixel electrode 17a is in proximity of the scan signal line 16x, a portion of the pixel electrode 17a′ is in proximity of the scan signal line 16y, and one end portion of the pixel electrode 17b is in proximity of the scan signal line 16x and the other end portion is in proximity of the scan signal line 16y. In other words, at least a portion of the pixel electrode 17a and a portion of the pixel electrode 17a′ are disposed in proximity of the scan signal lines 16x and 16y, respectively, and the pixel electrode 17b extends as if to bridge the scan signal lines 16x and 16y together. The capacitance electrode 37a is disposed to overlap with the storage capacitance wiring 18p and the pixel electrodes 17a and 17b, and the capacitance electrode 38a is disposed to overlap with the storage capacitance wiring 18r and the pixel electrodes 17b and 17a′.

More specifically, the capacitance electrode 37a is composed of a first portion 37aa that forms an angle of approx. 90° to the row direction, and a second portion 37ab and a third portion 37ac that are connected to respective end portions of the first portion 37aa and are approximately parallel to the row direction. As a result, the capacitance electrode 37a is U-shaped where it overlaps with the storage capacitance wiring 18p.

The capacitance electrode 38a is composed of a first portion 38aa that forms an angle of approx. 90° to the row direction, and a second portion 38ab and a third portion 38ac connected to respective end portions of the first portion and are about parallel to the row direction. As a result, the capacitance electrode 38a is U-shaped where it overlaps with the storage capacitance wiring 18r. The shape of the capacitance electrode 38a approximates the shape of the capacitance electrode 37a that has been rotated by 180°.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a. To the pixel electrode 17a, a relay wiring 220a is connected through a contact hole 211a, and the relay wiring 220a is connected to the pixel electrode 17a′ through a contact hole 212a.

The capacitance electrode 37a overlaps the pixel electrode 17b through the interlayer insulating film. Also, a second portion 37ab and a third portion 37ac of the capacitance electrode 37a extend towards the pixel electrode 17a, and their end portions are connected to the pixel electrode 17a through the contact holes 41a and 42a. Consequently, a coupling capacitance Cab1 (see FIG. 29) between the pixel electrodes 17a and 17b is formed where the capacitance electrode 37a and the pixel electrode 17b overlap with each other.

The capacitance electrode 38a overlaps with the pixel electrode 17b through the interlayer insulating film. The capacitance electrode 38a has a second portion 38ab and a third portion 38ac, which extend to the pixel electrode 17a′, and their end portions are connected to the pixel electrode 17a′ through contact holes 43a and 44a, respectively. As a result, a coupling capacitance Cab2 (see FIG. 29) between the pixel electrodes 17a′ and 17b is formed where the capacitance electrode 38a and the pixel electrode 17b overlap with each other.

Also, the capacitance electrode 37a overlaps with the storage capacitance wiring 18p through the gate insulating film, and most of the storage capacitance Cha1 (see FIG. 29) is formed at the location of the overlap. The capacitance electrode 38a overlaps with the storage capacitance wiring 18r through the gate insulating film, and most of the storage capacitance Cha2 (see FIG. 29) is formed at the location of the overlap. Also, the pixel electrode 17b and the storage capacitance wiring 18p overlap with each other through the interlayer insulating film and the gate insulating film, and a storage capacitance Chb1 (see FIG. 29) is formed at the location of the overlap. The pixel electrode 17b and the storage capacitance wiring 18r overlap with each other through the interlayer insulating film and the gate insulating film, and a storage capacitance Chb2 (see FIG. 29) is formed at the location of the overlap.

For the liquid crystal panel of FIG. 30, the sub-pixel that includes the pixel electrodes 17a and 17a′ becomes “BR”, and the sub-pixel that includes the pixel electrode 17b becomes “DA”.

For the liquid crystal panel of FIG. 30, the pixel electrodes 17a and 17a′ and the pixel electrode 17b are connected together via two coupling capacitances (Cab1 and Cab2), i.e., by capacitance coupling. As a result, if a short circuit occurs between the capacitance electrode 37a and the pixel electrode 17b at P in FIG. 30, for example (in the manufacturing process or the like), capacitance coupling of pixel electrodes 17a, 17b, and 17a′ can be maintained by conducting a repair process in which the capacitance electrode 37a is cut by laser between the contact hole 41a and the short-circuit location, and between the contact hole 42a and the short-circuit location. If a short circuit occurs between the capacitance electrode 38a and the pixel electrode 17b, the capacitance electrode 38a can be cut by laser between the short-circuit location and the contact hole 43a and between the contact hole 44a and the short-circuit location.

If a short circuit occurs between the capacitance electrode 37a and the storage capacitance wiring 18p or the pixel electrode 17b, the capacitance coupling among the pixel electrodes 17a, 17b, and 17a′ can be maintained also by removing (trimming) the pixel electrode 17a inside the contact holes 41a and 42a by laser or the like to electrically isolate the pixel electrode 17a from the capacitance electrode 37a.

For the liquid crystal panel of FIG. 30, the pixel electrode 17a and the capacitance electrode 37a are connected to each other through two contact holes, and a capacitance coupling is formed between the pixel electrode 17a and the pixel electrode 17b. For this reason, even if one of the contact holes is not formed properly in the manufacturing process or the like (if a contact failure occurs between the capacitance electrode 37a and pixel electrode 17a via either one of the contact holes), the connection between the capacitance electrode 37a and the pixel electrode 17a can be obtained via the other contact hole. The capacitance coupling between the pixel electrodes 17a and 17b can therefore be maintained. Similarly, the pixel electrode 17a′ and the capacitance electrode 38a are also connected via two contact holes. Consequently, even if either one of the contact holes is not formed properly in the manufacturing process or the like, the connection between the capacitance electrode 38a and the pixel electrode 17a′ can be obtained through the other of the contact holes, and therefore a capacitance coupling between the pixel electrodes 17a′ and 17b can be maintained.

As described above, according to the present embodiment, the production yield of the liquid crystal panels and active matrix substrates for use in such liquid crystal panels can be increased.

Also, referring to the liquid crystal panel of FIG. 30, the capacitance electrode 37a extends in the same direction as the storage capacitance wiring 18p, and overlaps with the storage capacitance wiring 18p and the pixel electrodes 17a and 17b. The capacitance electrode 38a has a shape that approximates the shape of capacitance electrode 37a that has been rotated by 180°, extends in the same direction as the storage capacitance wiring 18r, and overlaps with the storage capacitance wiring 18r and the pixel electrodes 17b and 17a′. Consequently, even if the pixel electrodes 17a, 17b, and 17a′ are misaligned against the capacitance electrodes 37a and 38a in the row direction, the overlapped area of the capacitance electrode 37a and the pixel electrode 17b and the overlapped area of the capacitance electrode 38a and the pixel electrode 17b compensate with one another, making the sum of the two coupling capacitances (Cab1 and Cab2) likely to remain unchanged. This is a beneficial effect.

Also, for the liquid crystal panel of FIG. 30, the capacitance electrode 37a overlaps with the pixel electrode 17b and the storage capacitance wiring 18p, and the capacitance electrode 38a overlaps with the pixel electrode 17b and the storage capacitance wiring 18r. Thus, by utilizing the capacitance electrodes 37a and 38a, which are provided for forming a coupling capacitance, also as electrodes for forming a storage capacitance, the aperture ratio can be improved.

Further, because the capacitance electrodes 37a and 38a are disposed to extend in the row direction and to overlap with the storage capacitance wirings 18p and 18r, the line width of the storage capacitance wirings 18p and 18r can be made smaller. As a result, the aperture ratio can further be increased.

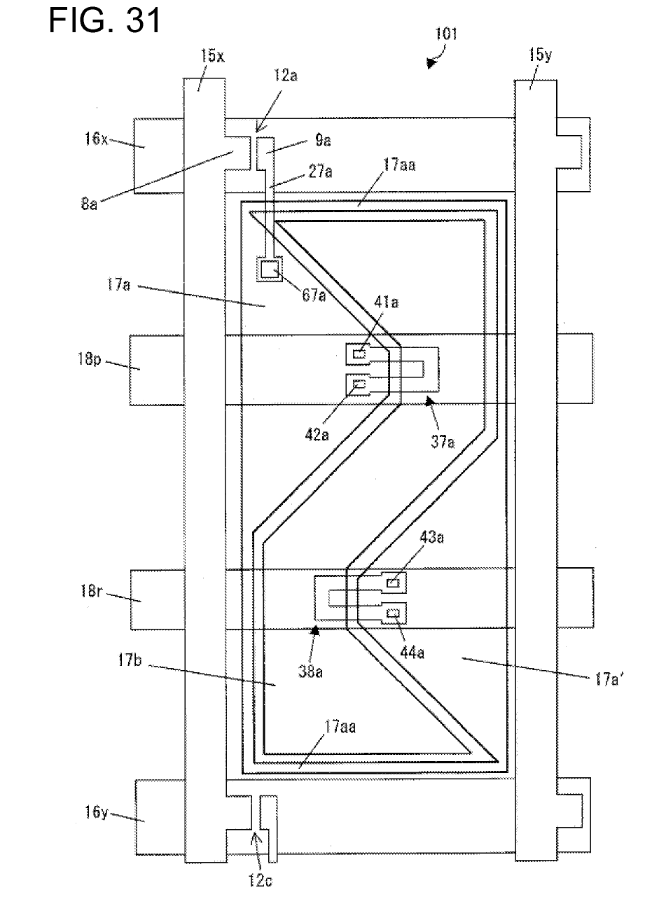

Pixel 101 of FIG. 30 may be modified as shown in FIG. 31. In the configuration of FIG. 31, the pixel electrodes 17a and 17a′ of FIG. 30 are connected to each other in the region outside the pixel electrode 17b via a connecting portion 17aa made of ITO or the like. That is, a pixel electrode unifiedly formed of the pixel electrodes 17a and 17a′ is disposed to surround the pixel electrode 17b. As a result, contact holes 211a and 212a and the relay wiring 210a shown in FIG. 30, which are for connecting the pixel electrodes 17a and 17a′ together, are no longer needed, and therefore the aperture ratio can be increased accordingly.

Also, because the pixel electrodes 17a and 17a′ surround the electrically floating pixel electrode 17b, the pixel electrodes 17a and 17a′ function as shield electrodes and suppress problems such as the jumping of electric charge into the pixel electrode 17b. With this configuration, burning of the sub-pixel that includes the pixel electrode 17b (dark sub-pixel) can be suppressed.

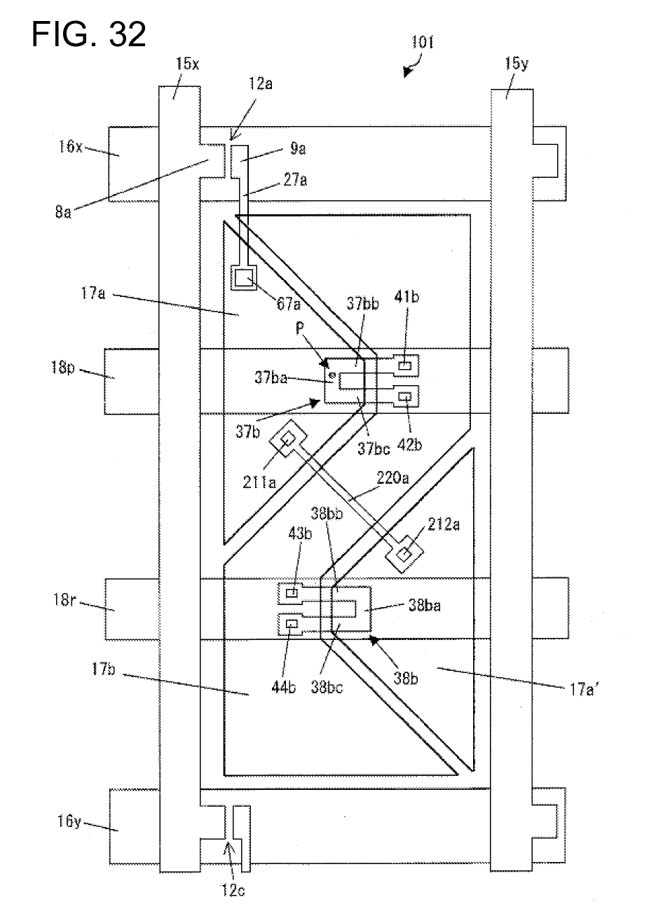

Here, although the liquid crystal panel described above has a configuration in which the capacitance electrode is electrically connected to a pixel electrode corresponding to a sub-pixel that becomes a bright sub-pixel, the configuration is not limited to such. The present liquid crystal panel may have a configuration in which the capacitance electrode is electrically connected to a pixel electrode corresponding to a sub-pixel that becomes a dark sub-pixel. FIG. 32 shows a specific example 101 of the pixel having this configuration.

Referring to the liquid crystal panel of FIG. 32, a transistor 12a is disposed in proximity of the intersection of the data signal line 15x and the scan signal line 16x. The pixel region defined by the signal lines (15x and 16x) includes: a pixel electrode 17a having a trapezoidal shape; a pixel electrode 17a′ located at about 315° to the row direction of the storage capacitance wiring 18p, and having a trapezoidal shape that approximates the shape of the pixel electrode 17a that has been rotated by 180°; and the pixel electrode 17b disposed in the region not occupied by the pixel electrode 17a or 17a′ such that it corresponds to (fits against) the shapes of the pixel electrodes 17a and 17a′. Also, the storage capacitance wirings 18p and 18r are arranged in parallel to each other, the storage capacitance wiring 18p extends in the row direction across the pixel electrodes 17a and 17b, and the storage capacitance wiring 18r extends in the row direction across the pixel electrodes 17b and 17a′.

With this configuration, the pixel electrodes 17a, 17b, and 17a′ are arranged such that a portion of the pixel electrode 17a is in proximity of the scan signal line 16x, a portion of the pixel electrode 17a′ is in proximity of the scan signal line 16y, and one end portion of the pixel electrode 17b is in proximity of the scan signal line 16x and the other end portion is in proximity of the scan signal line 16y. In other words, at least a portion of the pixel electrode 17a and a portion of the pixel electrode 17a′ are disposed in proximity of the scan signal lines 16x and 16y, respectively, and the pixel electrode 17b extends as if to bridge the scan signal lines 16x and 16y together. The capacitance electrode 37b is disposed to overlap with the storage capacitance wiring 18p and the pixel electrodes 17a and 17b, and the capacitance electrode 38b is disposed to overlap with the storage capacitance wiring 18r and the pixel electrodes 17b and 17a′.

More specifically, the capacitance electrode 37b is composed of a first portion 37ba that forms an angle of approximately 90° to the row direction, and a second portion 37bb and a third portion 37bc that are connected to respective end portions of the first portion and are approximately parallel to the row direction. As a result, the capacitance electrode 37b is U-shaped where it overlaps with the storage capacitance wiring 18p.

Also, the capacitance electrode 38b is composed of a first portion 38ba that forms an angle of 90° to the row direction, and a second portion 38bb and a third portion 38bc that are connected to respective end portions of the first portion and are approximately parallel to the row direction. As a result, the capacitance electrode 38b is U-shaped where it overlaps with the storage capacitance wiring 18r. The shape of the capacitance electrode 38b approximates the shape of the capacitance electrode 37b that has been rotated by 180°.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a. To the pixel electrode 17a, a relay wiring 220a is connected through a contact hole 211a, and the relay wiring 220a is connected to the pixel electrode 17a′ through a contact hole 212a.

The capacitance electrode 37b overlaps with the pixel electrode 17a through an interlayer insulating film. Also, the capacitance electrode 37b has a second portion 37bb and a third portion 37bc extending to the pixel electrode 17b, and their end portions are connected to the pixel electrode 17b through the contact holes 41b and 42b, respectively. Consequently, a coupling capacitance Cab1 (see FIG. 29) between the pixel electrodes 17a and 17b is formed where the capacitance electrode 37b and the pixel electrode 17a overlap with each other.

The capacitance electrode 38b overlaps with the pixel electrode 17a′ through the interlayer insulating film. Also, the capacitance electrode 38b has the second portion 38bb and the third portion 38bc extending to the pixel electrode 17b, and their end portions are connected to the pixel electrode 17b through contact holes 43b and 44b, respectively. Consequently, a coupling capacitance Cab2 (see FIG. 29) between the pixel electrodes 17a′ and 17b is formed where the capacitance electrode 38b and the pixel electrode 17a′ overlap with each other.

Also, the capacitance electrode 37b overlaps with the storage capacitance wiring 18p through the gate insulating film, and most of the storage capacitance Chb1 (see FIG. 29) is formed at the location of the overlap. The capacitance electrode 38b overlaps with the storage capacitance wiring 18r through the gate insulating film, and most of a storage capacitance Chb2 (see FIG. 29) is formed at the location of the overlap. The pixel electrode 17a and the storage capacitance wiring 18p overlap with each other through the interlayer insulating film and gate insulating film, and a storage capacitance Cha1 (see FIG. 29) is formed at the location of the overlap. The pixel electrode 17a′ and the storage capacitance wiring 18r overlap with each other through the interlayer insulating film and the gate insulating film, and a storage capacitance Cha2 (see FIG. 29) is formed at the location of the overlap.

For the liquid crystal panel of FIG. 32, the sub-pixel that includes the pixel electrodes 17a and 17a′ becomes “BR”, and the sub-pixel that includes the pixel electrode 17b becomes “DA”.

Referring to the liquid crystal panel of FIG. 32, the pixel electrode 17a and the pixel electrode 17b are connected (capacitively coupled) to each other via two coupling capacitances (Cab1 and Cab2). Consequently, if a short circuit occurs between the capacitance electrode 37b and the pixel electrode 17a (in the manufacturing process or the like) at P as shown in FIG. 32, for example, the capacitance coupling among the pixel electrodes 17a, 17b, and 17a′ can be maintained by conducting a repair process in which the capacitance electrode 37b is cut by laser between the short-circuit location and the contact hole 41b and between the short-circuit location and the contact hole 42b. If a short circuit occurs between the capacitance electrode 38b and the pixel electrode 17a′, the capacitance electrode 38b can be cut by laser between the short-circuit location and the contact hole 43b and between the short-circuit location and the contact hole 44b.

Needless to say, the configuration shown in FIG. 32 in which a capacitance electrode is electrically connected to a pixel electrode corresponding to a sub-pixel that becomes a dark sub-pixel is applicable to the liquid crystal panels described above.

### Embodiment 4

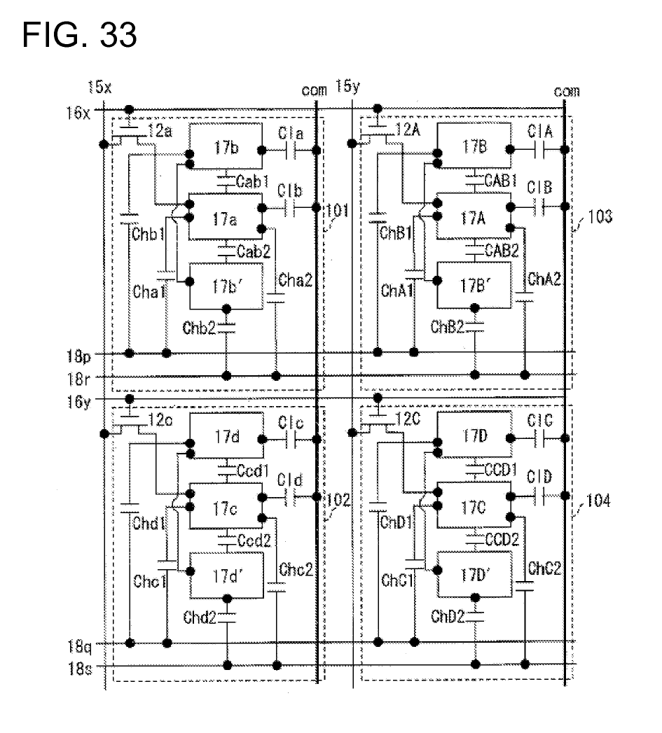

FIG. 33 is an equivalent circuit diagram showing a part of the liquid crystal panel according to Embodiment 4. As shown in FIG. 33, the present liquid crystal panel includes: data signal lines (15x and 15y) extending in a column direction (up and down directions in the figure); scan signal lines (16x and 16y) extending in a row direction (right and left directions in the figure); pixels arranged in the row and column directions (101 to 104); storage capacitance wirings (18p to 18s); and a common electrode (opposite electrode) com. All pixels have the same structure. The pixel column that includes pixels 101 and 102 and the pixel column that includes pixels 103 and 104 are adjacent to each other, and the pixel row that includes pixels 101 and 103 and the pixel row that includes pixels 102 and 104 are adjacent to each other.

For the present liquid crystal panel, one data signal line, one scan signal line, and two storage capacitance wirings are provided for one pixel. Also, three pixel electrodes are provided for one pixel. Pixel electrodes 17b, 17a, and 17b′ are provided for pixel 101, pixel electrodes 17d, 17c, and 17d′ are provided for pixel 102, pixel electrodes 17B, 17A, and 17B′ are provided for pixel 103, and pixel electrodes 17D, 17C, and 17D′ are provided for pixel 104.

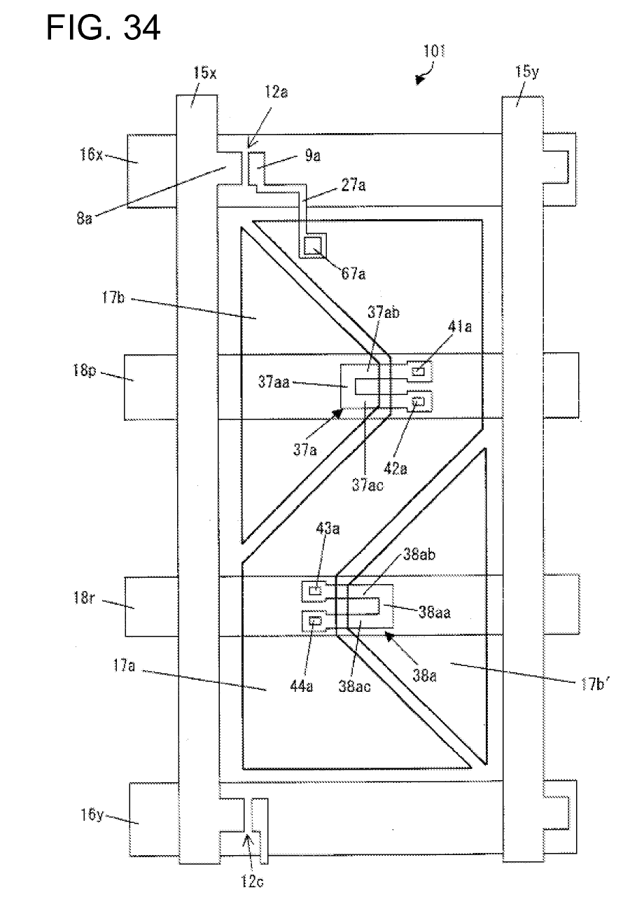

A specific example of pixel 101 of FIG. 33 is shown in FIG. 34. As shown in the figure, a transistor 12a is disposed in proximity of the intersection of the data signal line 15x and the scan signal line 16x. The pixel region defined by the signal lines (15x and 16x) includes: a pixel electrode 17b having a trapezoidal shape; a pixel electrode 17b′ located at approximately 315° to the row direction of the storage capacitance wiring 18p and having a trapezoidal shape that approximates the shape of the pixel electrode 17b that has been rotated by 180°; and a pixel electrode 17a disposed in the region not occupied by the pixel electrodes 17b or 17b′ such that it corresponds to (fits against) the shapes of the pixel electrodes 17b and 17b′. Also, the storage capacitance wirings 18p and 18r are parallel to each other, the storage capacitance wiring 18p extends in the row direction across the pixel electrodes 17a and 17b, and the storage capacitance wiring 18r extends in the row direction across the pixel electrodes 17a and 17b′.

With this configuration, the pixel electrodes 17b, 17a, and 17b′ are disposed such that a portion of the pixel electrode 17b is in proximity of the scan signal line 16x, a portion of the pixel electrode 17b′ is in proximity of the scan signal line 16y, one of end portions of the pixel electrode 17a is in proximity of the scan signal line 16x, and the other of the end portions is in proximity of the scan signal line 16y. In other words, at least a portion of the pixel electrode 17b and a portion of the pixel electrode 17b′ are disposed close to the scan signal lines 16x and 16y, respectively, and the pixel electrode 17a is disposed to extend in the column direction as if to bridge the scan signal lines 16x and 16y together. The capacitance electrode 37a is disposed to overlap with the storage capacitance wiring 18p and the pixel electrodes 17a and 17b, and the capacitance electrode 38a is disposed to overlap with the storage capacitance wiring 18r and the pixel electrodes 17a and 17b′.

More specifically, the capacitance electrode 37a is composed of a first portion 37aa that forms an angle of approx. 90° to the row direction, and a second portion 37ab and a third portion 37ac that are connected to respective end portions of the first portion 37aa and are approximately parallel to the row direction. As a result, the capacitance electrode 37a is U-shaped where it overlaps with the storage capacitance wiring 18p.

The capacitance electrode 38a is composed of a first portion 38aa that forms an angle of approx. 90° to the row direction, and a second portion 38ab and a third portion 38ac that are connected to respective end portions of the first portion and are approximately parallel to the row direction. As a result, the capacitance electrode 38a is U-shaped where it overlaps with the storage capacitance wiring 18r. The shape of the capacitance electrode 38a approximates the shape of the capacitance electrode 37a that has been rotated by 180°.

Also, the overlapped area of the capacitance electrode 37a and the pixel electrode 17b and the overlapped area of the capacitance electrode 38a and the pixel electrode 17b′ are preferably the same. With this configuration, the coupling capacitance values become about the same, which makes the luminance values of the pixel electrodes 17b and 17b′ consistent.

The overlapped area of the capacitance electrode 37a and the pixel electrode 17b, and the overlapped area of the capacitance electrode 38a and the pixel electrode 17b′ can be made different in order to provide three different luminance values for half-tone display and to improve the view angle characteristics.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a.

The capacitance electrode 37a overlaps with the pixel electrode 17b through the interlayer insulating film. Also, the capacitance electrode 37a has a second portion 37ab and a third portion 37ac, which extend to the pixel electrode 17a, and their end portions are connected to the pixel electrode 17a through contact holes 41a and 42a, respectively. Consequently, a coupling capacitance Cab1 (see FIG. 33) between the pixel electrodes 17a and 17b is formed where the capacitance electrode 37a and the pixel electrode 17b overlap with each other.

The capacitance electrode 38a overlaps with the pixel electrode 17b′ through the interlayer insulating film. Also, the capacitance electrode 38a has a second portion 38ab and a third portion 38ac, which extend to the pixel electrode 17a, and their end portions are connected to the pixel electrode 17a through contact holes 43a and 44a, respectively. As a result, a coupling capacitance Cab2 (see FIG. 33) between the pixel electrodes 17a and 17b′ is formed where the capacitance electrode 38a and the pixel electrode 17b′ overlap with each other.

Also, the capacitance electrode 37a overlaps with the storage capacitance wiring 18p through the gate insulating film, and most of a storage capacitance Cha1 (see FIG. 29) is formed at the location of the overlap. The capacitance electrode 38a overlaps with the storage capacitance wiring 18r through the gate insulating film, and most of a storage capacitance Cha2 (see FIG. 29) is formed at the location of the overlap. Also, the pixel electrode 17b and the storage capacitance wiring 18p overlap with each other through the interlayer insulating film and the gate insulating film, and a storage capacitance Chb1 (see FIG. 29) is formed at the location of the overlap. The pixel electrode 17b′ and the storage capacitance wiring 18r overlap with each other through the interlayer insulating film and the gate insulating film, and a storage capacitance Chb2 (see FIG. 29) is formed at the location of the overlap.

Referring to the liquid crystal panel of FIG. 34, the sub-pixel that includes the pixel electrode 17a becomes “BR”, and the sub-pixel that includes the pixel electrodes 17b and 17b′ becomes “DA”.

Referring to the liquid crystal panel of FIG. 34, the pixel electrode 17a and the capacitance electrode 37a are connected together through two contact holes to form a capacitance coupling between the pixel electrode 17a and the pixel electrode 17b. For this reason, even if one of the contact holes is not formed properly in the manufacturing process or the like (if a contact failure occurs between the capacitance electrode 37a and pixel electrode 17a via either one of the contact holes), the connection between the capacitance electrode 37a and the pixel electrode 17a can be obtained via the other contact hole. The capacitance coupling between the pixel electrodes 17a and 17b can therefore be maintained. Similarly, because the pixel electrode 17a and the capacitance electrode 38a are also connected together through two contact holes, even if either one of the contact holes become improperly formed in the manufacturing process or the like, the connection between the capacitance electrode 38a and the pixel electrode 17a can be obtained through the other of the contact holes, and therefore the capacitance coupling of the pixel electrodes 17a and 17b′ can be maintained.

As described above, according to the present embodiment, the production yield of the liquid crystal panels and active matrix substrates for use in such liquid crystal panels can be increased.

Referring to the liquid crystal panel of FIG. 34, the capacitance electrode 37a extends in the same direction as the storage capacitance wiring 18p and overlaps with the storage capacitance wiring 18p and the pixel electrodes 17a and 17b. The capacitance electrode 38a has a shape that approximates the shape of the capacitance electrode 37a that has been rotated by 180°, extends in the same direction as the storage capacitance wiring 18r, and overlaps with the storage capacitance wiring 18r and the pixel electrodes 17a and 17b′.

Also, referring to the liquid crystal panel of FIG. 34, the capacitance electrode 37a overlaps with the pixel electrode 17b and the storage capacitance wiring 18p, and the capacitance electrode 38a overlaps with the pixel electrode 17b′ and the storage capacitance wiring 18r. Thus, by utilizing the capacitance electrodes 37a and 38a, which are provided to form a coupling capacitance, as an electrode for forming a storage capacitance, the aperture ratio can be increased.

Further, because the capacitance electrodes 37a and 38a are disposed to extend in the row direction and to overlap with the storage capacitance wirings 18p and 18r, the line width of the storage capacitance wirings 18p and 18r can be made smaller. As a result, the aperture ratio can further be increased.

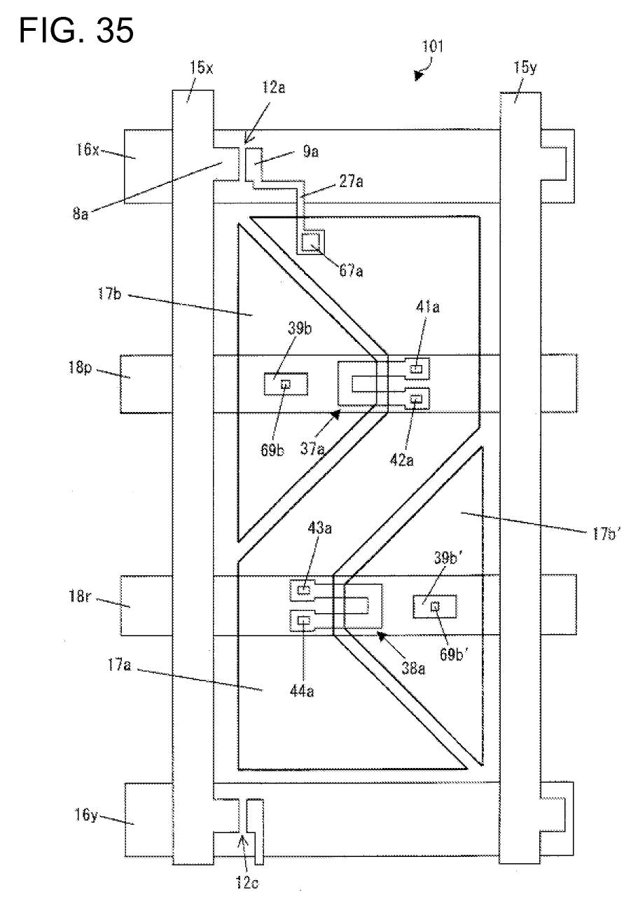

From the perspective of the reliability, the capacitance values of the storage capacitances Chb1 and Chb2 are preferably large. The storage capacitances Chb1 and Chb2, therefore, may be formed according to the configuration shown in FIG. 35. That is, as shown in FIG. 35, a capacitance electrode 39b formed in the same layer with the storage capacitance electrode 37a is connected to the pixel electrode 17b through the contact hole 69b to form a storage capacitance Chb1 between the storage capacitance electrode 39b and the storage capacitance wiring 18p. A storage capacitance electrode 39b′ formed in the same layer as the capacitance electrode 38a is connected to the pixel electrode 17b′ through the contact hole 69b′ to form a storage capacitance Chb2 between the storage capacitance electrode 39b′ and the storage capacitance wiring 18r.

In the case of this configuration, compared to the case shown in FIG. 34 where storage capacitances Chb1 and Chb2 are formed respectively between the pixel electrode 17b and the storage capacitance wiring 18p and between the pixel electrode 17b′ and the storage capacitance wiring 18r, the insulating film interposed between them can be made smaller (thinner), and therefore the storage capacitance value can be increased. Also, because the insulating film that forms the storage capacitances Chb1 and Chb2 can be made thinner, the width of the storage capacitance wirings 18p and 18r can be made narrower without changing the storage capacitance value. As a result, the aperture ratio can be improved without lowering the reliability, which is a beneficial effect.

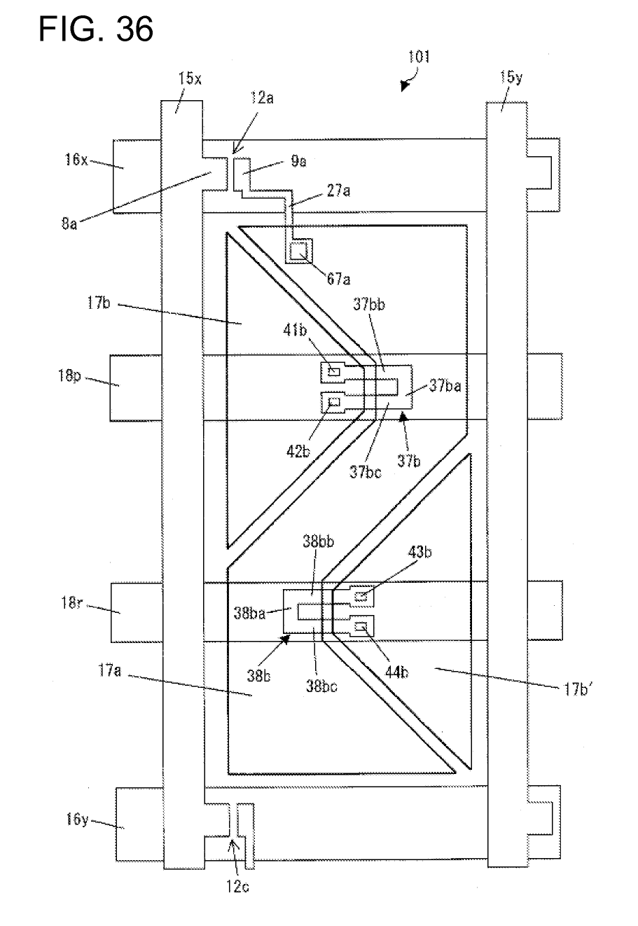

Here, although the liquid crystal panel described above has a configuration in which the capacitance electrode is electrically connected to a pixel electrode corresponding to a sub-pixel that becomes a bright sub-pixel, the configuration is not limited to such. The present liquid crystal panel may have a configuration in which the capacitance electrode is electrically connected to a pixel electrode corresponding to a sub-pixel that becomes a dark sub-pixel. FIG. 36 shows a specific example 101 of the pixel having this configuration.

Referring to the liquid crystal panel of FIG. 36, a transistor 12a is formed at the intersection of the data signal line 15x and the scan signal line 16x. The pixel region defined by the signal lines (15x and 16x) includes: a pixel electrode 17b that has a trapezoidal shape; a pixel electrode 17b′ that is located at approximately 315° to the row direction of the storage capacitance wiring 18p, and has a trapezoidal shape that approximates the shape of the pixel electrode 17b that has been rotated by 180°; and a pixel electrode 17a disposed in the region not occupied by the pixel electrode 17b or 17b′, such that it corresponds to (fits against) the shapes of the pixel electrodes 17b and 17b′. Also, the storage capacitance wirings 18p and 18r are parallel to each other, the storage capacitance wiring 18p extends in the row direction across the pixel electrodes 17a and 17b, and the storage capacitance wiring 18r extends in the row direction across the pixel electrodes 17a and 17b′.

With this configuration, pixel electrodes 17b, 17a, and 17b′ are disposed such that a portion of the pixel electrode 17b is in proximity of the scan signal line 16x, a portion of the pixel electrode 17b′ is in proximity of the scan signal line 16y, one of end portions of the pixel electrode 17a is in proximity of the scan signal line 16x, and the other of the end portions is in proximity of the scan signal line scan signal line 16y. In other words, at least a portion of the pixel electrode 17b and a portion of the pixel electrode 17b′ are disposed close to the scan signal lines 16x and 16y, respectively, and the pixel electrode 17a is disposed to extend in the column direction as if to bridge the scan signal lines 16x and 16y. The capacitance electrode 37b is disposed to overlap with the storage capacitance wiring 18p and the pixel electrodes 17a and 17b, and the capacitance electrode 38b is disposed to overlap with the storage capacitance wiring 18r and the pixel electrodes 17a and 17b′.

More specifically, the capacitance electrode 37b is composed of a first portion 37ba that forms an angle of approximately 90° to the row direction, and a second portion 37bb and a third portion 37bc that are connected to respective end portions of the first portion and are approximately parallel to the row direction. As a result, the capacitance electrode 37b is U-shaped where it overlaps with the storage capacitance wiring 18p.

Also, the capacitance electrode 38b is composed of a first portion 38ba that forms an angle of 90° to the row direction, and a second portion 38bb and a third portion 38bc that are connected to respective end portions of the first portion and are approximately parallel to the row direction. As a result, the capacitance electrode 38b is U-shaped where it overlaps with the storage capacitance wiring 18r. The shape of the capacitance electrode 38b approximates the shape of the capacitance electrode 37b that has been rotated by 180°.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a.

The capacitance electrode 37b overlaps with the pixel electrode 17a through the interlayer insulating film. Also, the capacitance electrode 37b has the second portion 37bb and the third portion 37bc extending to the pixel electrode 17b, and their end portions are connected to the pixel electrode 17b through the contact holes 41b and 42b, respectively. As a result, a coupling capacitance Cab1 (see FIG. 33) between the pixel electrodes 17a and 17b is formed where the capacitance electrode 37b and the pixel electrode 17a overlap with each other.

The capacitance electrode 38b overlaps with the pixel electrode 17a through the interlayer insulating film. Also, the capacitance electrode 38b has the second portion 38bb and the third portion 38bc extending to the pixel electrode 17b′, and their end portions are connected to the pixel electrode 17b′ through contact holes 43b and 44b, respectively. Consequently, a coupling capacitance Cab2 (see FIG. 33) between the pixel electrodes 17a and 17b′ is formed where the capacitance electrode 38b and the pixel electrode 17a overlap with each other.

Also, the capacitance electrode 37b overlaps with the storage capacitance wiring 18p through the gate insulating film, and most of a storage capacitance Chb1 (see FIG. 33) is formed at the location of the overlap. The capacitance electrode 38b overlaps with the storage capacitance wiring 18r through the gate insulating film, and most of a storage capacitance Chb2 (see FIG. 33) is formed at the location of the overlap. Also, the pixel electrode 17a and the storage capacitance wiring 18p overlap with each other through the interlayer insulating film and the gate insulating film, and a storage capacitance Cha1 (see FIG. 33) is formed at the location of the overlap. The pixel electrode 17a and the storage capacitance wiring 18r overlap with each other through the interlayer insulating film and the gate insulating film, and a storage capacitance Cha2 (see FIG. 33) is formed at the location of the overlap.

For the liquid crystal panel of FIG. 36, the sub-pixel that includes the pixel electrode 17a becomes “BR”, and the sub-pixel that includes the pixel electrodes 17b and 17b′ becomes “DA”.

Needless to say, the configuration shown in FIG. 36 in which a capacitance electrode is electrically connected to a pixel electrode corresponding to a sub-pixel that becomes a dark sub-pixel is applicable to the liquid crystal panels described above.

### Embodiment 5

For the liquid crystal panels of Embodiments 1 to 4 described above, the capacitance electrode is formed in a drain layer, i.e., the layer interposed between the gate insulating film and the interlayer insulating film, but the configuration is not limited to such. That is, the present liquid crystal panel may have a configuration in which the capacitance electrode is formed in the same layer as the scan signal line, and is covered with the gate insulating film. In Embodiment 5, a liquid crystal panel having this configuration is described. Although the present embodiment is applicable to the liquid crystal panels described above (in particular, liquid crystal panels having a configuration in which the capacitance electrode does not overlap with the storage capacitance wiring), here, a case that the embodiment is applied to the liquid crystal panel shown in FIG. 2 is described as an example.

The equivalent circuit diagram showing a part of the liquid crystal panel according to Embodiment 5 is similar to FIG. 1, and therefore the explanation of the equivalent circuit diagram is omitted.

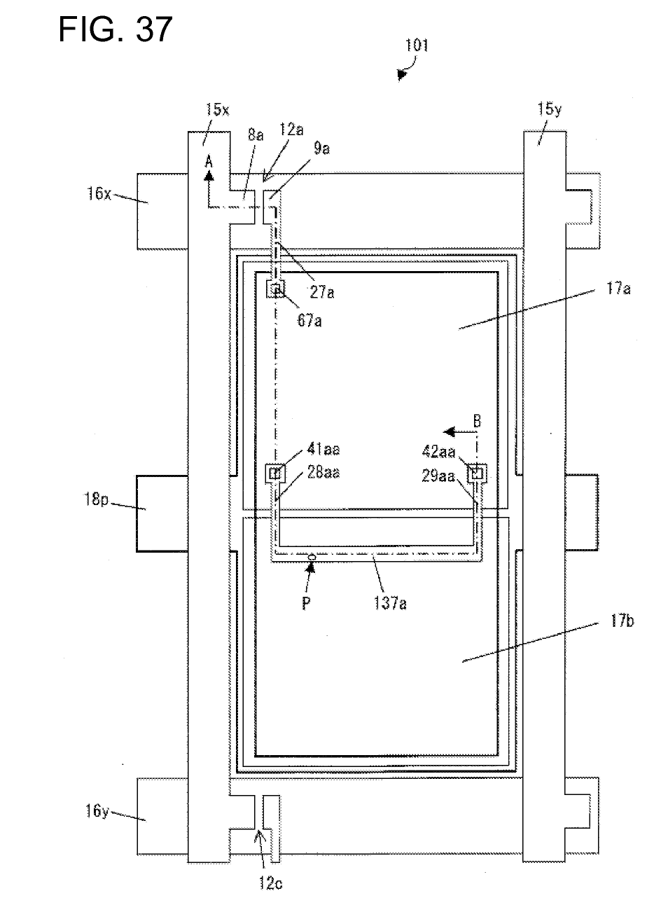

FIG. 37 shows a specific example of the pixel 101 of the present liquid crystal panel. As shown in the figure, a transistor 12a is disposed in proximity of the intersection of the data signal line 15x and the scan signal line 16x. In the pixel region defined by the signal lines (15x and 16x), a rectangular-shaped pixel electrode 17a and a rectangular-shaped pixel electrode 17b are arranged in the column direction, and one of the four sides constituting the perimeter of the first pixel electrode and one of the four sides constituting the perimeter of the second pixel electrode are adjacent to each other. The capacitance electrode 137a is disposed such that it extends in the column direction across the gap between the neighboring two sides (the gap between the pixel electrodes 17a and 17b), and overlaps with the pixel electrodes 17a and 17b. The storage capacitance wiring 18p has a storage capacitance wiring extended portions, which branch off from the storage capacitance wiring 18p and are disposed such that they extend to overlap with portions of the edges of the pixel electrodes 17a and 17b when observed in a plan view.

More specifically, the capacitance electrode 137a is formed in the same layer as the scan signal line 16x, and extends in the same direction as the data signal line 15x such that it overlaps with the pixel electrodes 17a and 17b when observed in a plan view. Also, the storage capacitance wiring extended portion of the storage capacitance wiring 18p extends around the pixel region, along the data signal lines 15x and 15y, and along the scan signal lines 16x and 16y. Further, the storage capacitance wiring extended portion is disposed to overlap the three sides of the pixel electrode 17a and of the pixel electrode 17b, which sides are not the sides that form the gap between the pixel electrodes 17a and 17b. Because of the shape of the storage capacitance wiring 18p, jumping of electric charge from the data signal lines 15x and 15y and the scan signal lines 16x and 16y can be suppressed, which provides an effect against the burning of the floating pixel. Also, because of the branching structure, redundancy is provided to the storage capacitance wiring 18p, which helps improve the production yield. Such structure of the storage capacitance wiring 18p is applicable to embodiments of the liquid crystal panels described below, and similar effects can be obtained from the application.

Over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a. The capacitance electrode 137a has two lead-out wirings 28aa and 29aa extending from its extending directional end portions to the pixel electrode 17a, and their end portions are connected to the pixel electrode 17a through the contact holes 41aa and 42aa, respectively. With this configuration, a coupling capacitance Cab (see FIG. 1) between the pixel electrodes 17a and 17b is formed where the capacitance electrode 137a and pixel electrode 17b overlap with each other.

Also, the pixel electrode 17a and the storage capacitance wiring 18p overlap with each other through the interlayer insulating film and the gate insulating film, and a storage capacitance Cha (see FIG. 1) is formed at the location of the overlap. The pixel electrode 17b and the storage capacitance wiring 18p overlap with each other through the interlayer insulating film and the gate insulating film, and a storage capacitance Chb (see FIG. 1) is formed at the location of the overlap. Configuration (the shapes and locations of the respective members, and the relation of connection among them) of other pixels is the same as that of the pixel 101.

According to this configuration, the sub-pixel that includes the pixel electrode 17a becomes “BR”, and the sub-pixel that includes the pixel electrode 17b becomes “DA”.

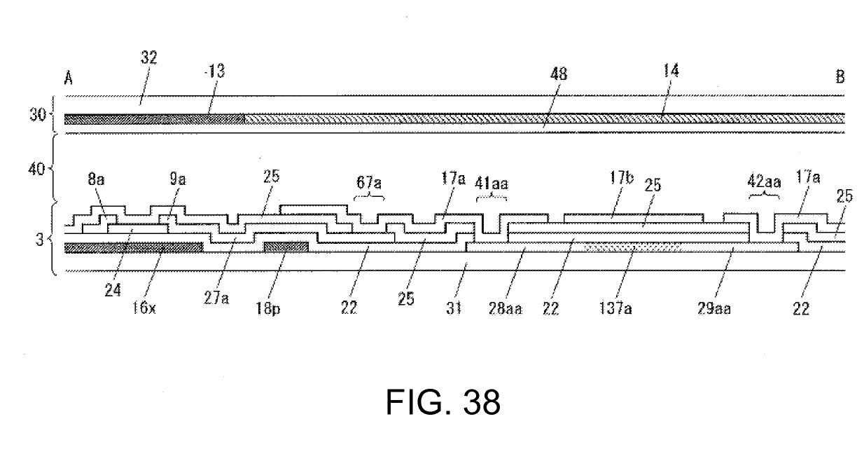

FIG. 38 is a cross-sectional arrow view taken along the line A-B of FIG. 37. As shown in the figure, the present liquid crystal panel includes an active matrix substrate 3, a color filter substrate 30 facing the active matrix substrate, and a liquid crystal layer 40 interposed between the substrates (3 and 30).

The active matrix substrate 3 has a glass substrate 31 with a scan signal line 16x, a storage capacitance wiring 18p, and a capacitance electrode 137a formed thereon, which are covered by an inorganic gate insulating film 22. Over the inorganic gate insulating film 22, a semiconductor layer 24 (an i-layer and an n+ layer), a source electrode 8a and a drain electrode 9a in contact with the n+ layer, and a drain lead-out wiring 27a are formed, which are covered by an inorganic interlayer insulating film 25. On the inorganic interlayer insulating film 25, pixel electrodes 17a and 17b are formed, and further, an alignment film (not shown) is formed to cover the pixel electrodes 17a and 17b.

Here, in the contact hole 67a, the inorganic interlayer insulating film 25 is removed, and therefore, the pixel electrode 17a and the drain lead-out wiring 27a are connected to each other. Also, inside the contact holes 41aa and 42aa, the inorganic interlayer insulating film 25 and the inorganic gate insulating film 22 are removed. As a result, the pixel electrode 17a and the capacitance electrode 137a are connected to each other. Additionally, the capacitance electrode 137a and the pixel electrode 17b overlap through the inorganic gate insulating film 22 and the inorganic interlayer insulating film 25. As a result, a coupling capacitance Cab (see FIG. 1) is formed.

On the other hand, referring to the color filter substrate 30, a colored layer 14 is formed on the glass substrate 32. Over the colored layer 14, a common electrode (com) 28 is formed, and further, an alignment film (not shown) is formed, covering the common electrode (com) 28.

In the configuration of FIG. 37, the drain electrode 9a of the transistor 12a is connected to the pixel electrode 17a through the contact hole 67a, and the pixel electrode 17a and the capacitance electrode 137a are connected to each other through the contact holes 41aa and 42aa. This way, the drain lead-out wiring that connects the drain electrode 9a and the capacitance electrode 137a can be made shorter, and the aperture ratio can be increased accordingly. Also, referring to the liquid crystal panel of FIG. 37, pixel electrode 17a and the capacitance electrode 137a are connected to each other through two contact holes to form a capacitance coupling between the pixel electrode 17a and the pixel electrode 17b. For this reason, even if one of the contact holes is not formed properly in the manufacturing process or the like (if a contact failure occurs between the capacitance electrode 137a and pixel electrode 17a via either one of the contact holes), the connection between the capacitance electrode 137a and the pixel electrode 17a can be obtained via the other contact hole. The capacitance coupling between the pixel electrodes 17a and 17b can therefore be maintained.

If a short circuit occurs between the capacitance electrode 137a and the pixel electrode 17b during the manufacturing process or the like, for example at P in FIG. 37, the capacitance coupling between the pixel electrodes 17a and 17b can be maintained by conducting a repair process in which the inside of the contact hole 41aa, which is proximal to the short-circuit location P, is removed (trimmed) by laser or the like to electrically isolate the pixel electrode 17a from the capacitance electrode 137a in the contact hole 41aa, and the capacitance electrode 137a is cut by laser between the other contact hole 42aa and the short-circuit location P. The capacitance electrode 137a can be cut by irradiating the capacitance electrode 137a from its back side (substrate side) with laser.

Also, in the present liquid crystal panel, because the capacitance electrode 137a is formed in the same layer as the scan signal line 16x, the thickness of the insulating film interposed between the capacitance electrode 137a and the pixel electrode 17b can be made greater than that of the liquid crystal panel of FIG. 2. Consequently, the chance that a short circuit occurs between the capacitance electrode 137a and the pixel electrode 17b can be reduced.

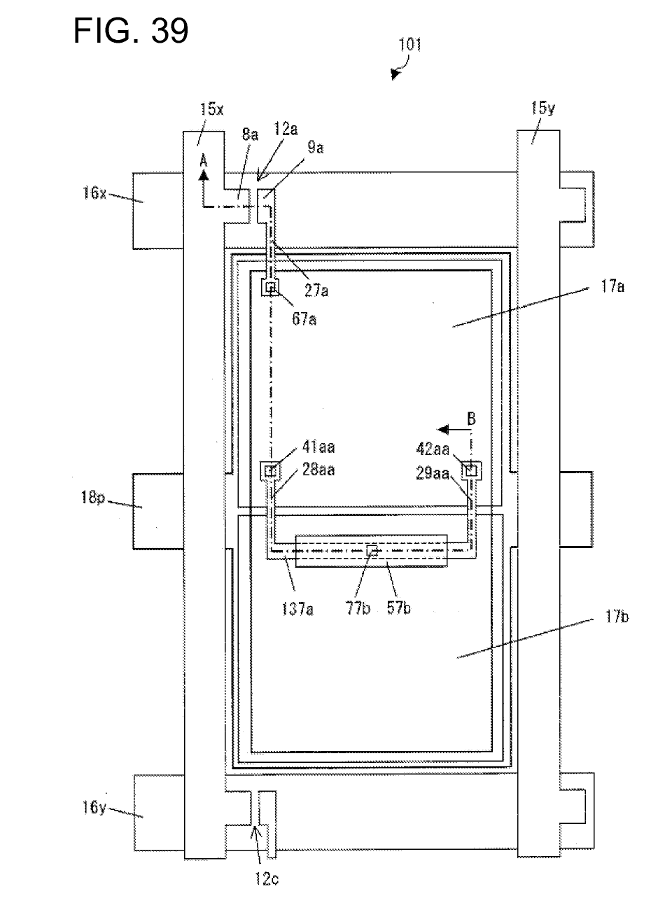

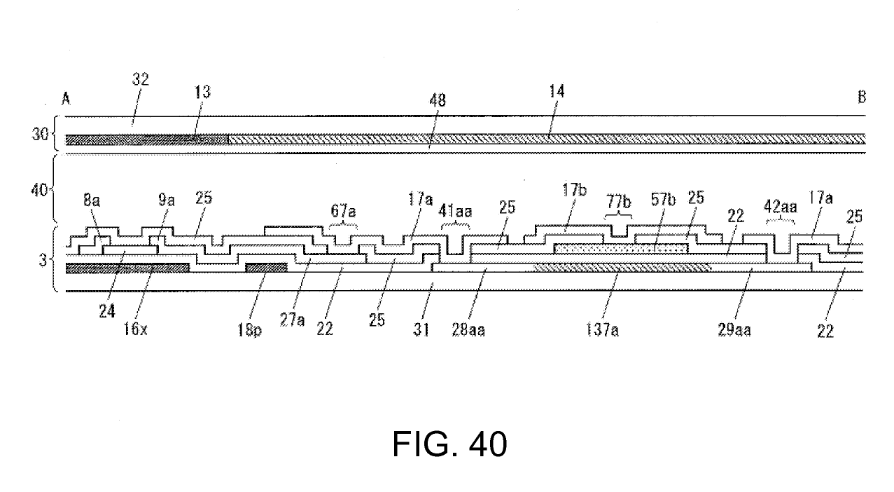

Pixel 101 of FIG. 37 can be modified as shown in FIG. 39. FIG. 40 is a cross-sectional arrow view taken along the line A-B of FIG. 39. For the present liquid crystal panel, a capacitance upper electrode 57b (third capacitance electrode) connected to the pixel electrode 17b is provided over the capacitance electrode 137a.

More specifically, over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a. The capacitance electrode 137a has two lead-out wirings 28aa and 29aa extending from its extending directional end portions to the pixel electrode 17a, and their end portions are connected to the pixel electrode 17a through the contact holes 41aa and 42aa, respectively. The capacitance upper electrode 57b is connected to the pixel electrode 17b through a contact hole 77b, overlaps with the pixel electrode 17b through an interlayer insulating film 25, and overlaps with the capacitance electrode 137a through the gate insulating film 22. A coupling capacitance Cab (see FIG. 1) between the pixel electrodes 17a and 17b is formed at the location of the overlap.

In the liquid crystal panel of FIG. 39, the pixel electrode 17a and the capacitance electrode 137a are connected together through two contact holes to form a capacitance coupling between the pixel electrode 17a and the pixel electrode 17b. As a result, even if one of the contact holes is not formed properly in the manufacturing process or the like (if a contact failure occurs between the capacitance electrode 137a and pixel electrode 17a via either one of the contact holes), the connection between the capacitance electrode 137a and the pixel electrode 17a can be obtained via the other contact hole. The capacitance coupling between the pixel electrodes 17a and 17b can therefore be maintained.

If a short circuit occurs between the capacitance electrode 137a and the pixel electrode 17b or the capacitance electrode 57b (in the manufacturing process or the like), like the case of the liquid crystal panel shown in FIG. 37, the capacitance coupling of pixel electrodes 17a and 17b can be maintained by conducting a repair process in which the inside the contact hole proximal to the short-circuit location (41aa, for example) is removed (trimmed) by laser or the like to electrically isolate the pixel electrode 17a from the capacitance electrode 137a in the contact hole, and the capacitance electrode 137a is cut by laser between the other of the contact holes (42aa, for example) and the short-circuit location. The capacitance electrode 137a can be cut by irradiating the capacitance electrode 137a from its back side (substrate side) with laser, for example.

Also, if a short circuit occurs between the capacitance electrode 137a and the pixel electrode 17b or the capacitance electrode 57b (in the production process or the like), the contact hole 77b can be trimmed. Thus, with the capacitance formed where the capacitance electrode 57b and the pixel electrode 17b overlap with each other, a coupling capacitance Cab (see FIG. 1) between pixel electrodes 17a and 17b can be formed.

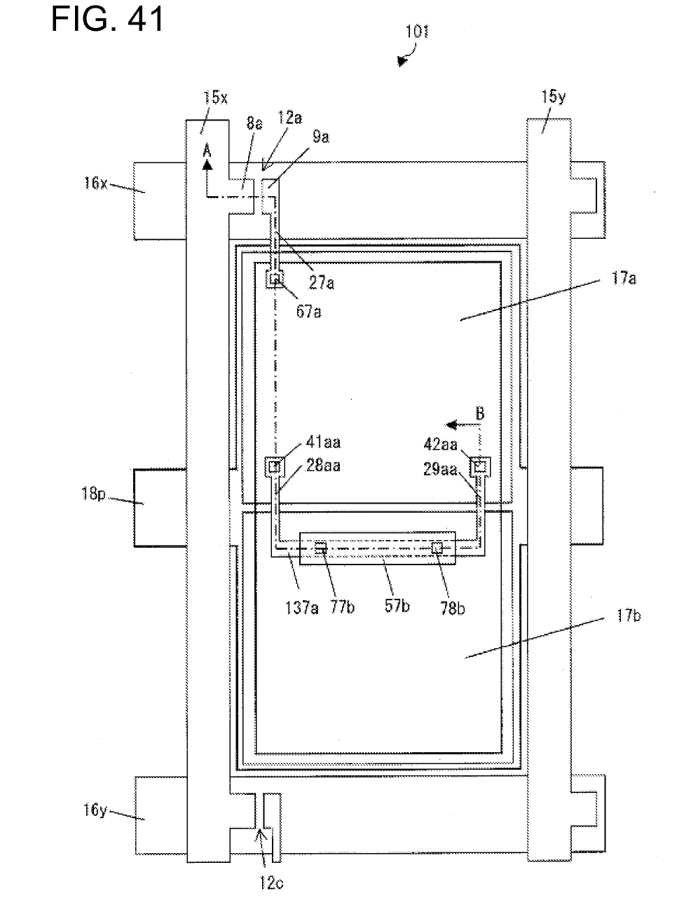

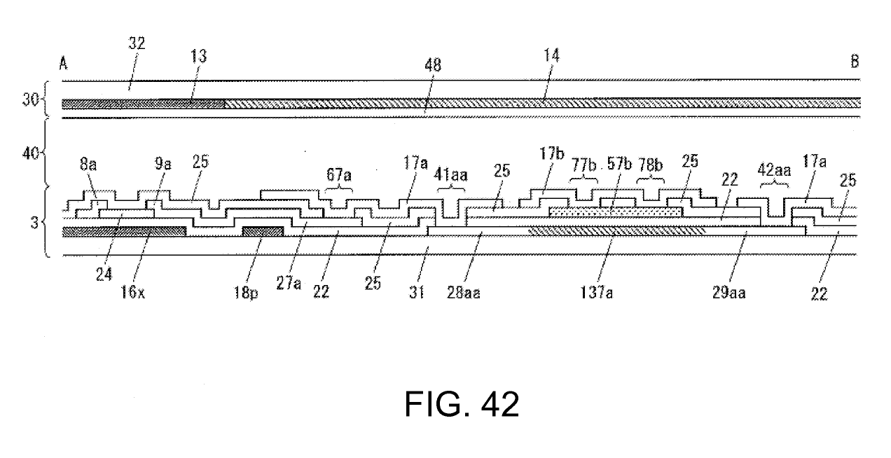

Further, the pixel 101 of FIG. 39 may be modified as shown in FIG. 41. FIG. 42 is a cross-sectional arrow view taken along the line A-B of FIG. 41. In this liquid crystal panel, a capacitance upper electrode 57b (third capacitance electrode), which is provided over the capacitance electrode 137a, is connected to the pixel electrode 17b through two contact holes 77b and 78b.

More specifically, over the scan signal line 16x, a source electrode 8a and a drain electrode 9a of the transistor 12a are formed, and the source electrode 8a is connected to the data signal line 15x. The drain electrode 9a is connected to a drain lead-out wiring 27a, and the drain lead-out wiring 27a is connected to the pixel electrode 17a through the contact hole 67a. The capacitance electrode 137a has two lead-out wirings 28aa and 29aa extending from its extending directional end portions to the pixel electrode 17a, and their end portions are connected to the pixel electrode 17a through the contact holes 41aa and 42aa, respectively. The capacitance upper electrode 57b is connected to the pixel electrode 17b through two contact holes 77b and 78b, overlaps with the pixel electrode 17b through the interlayer insulating film 25, and overlaps with the capacitance electrode 137a through the gate insulating film 22. A coupling capacitance Cab (see FIG. 1) between the pixel electrodes 17a and 17b is formed at the location of the overlap.

According to this configuration, because the pixel electrode 17b and the capacitance upper electrode 57b are connected together through two contact holes, even if either one of the contact holes is not formed properly in the manufacturing process or the like, the connection between the pixel electrode 17b and the capacitance upper electrode 57b can be maintained through the other of the contact holes. This is an additional effect, besides the effect that can be obtained from the configuration shown in FIG. 39.

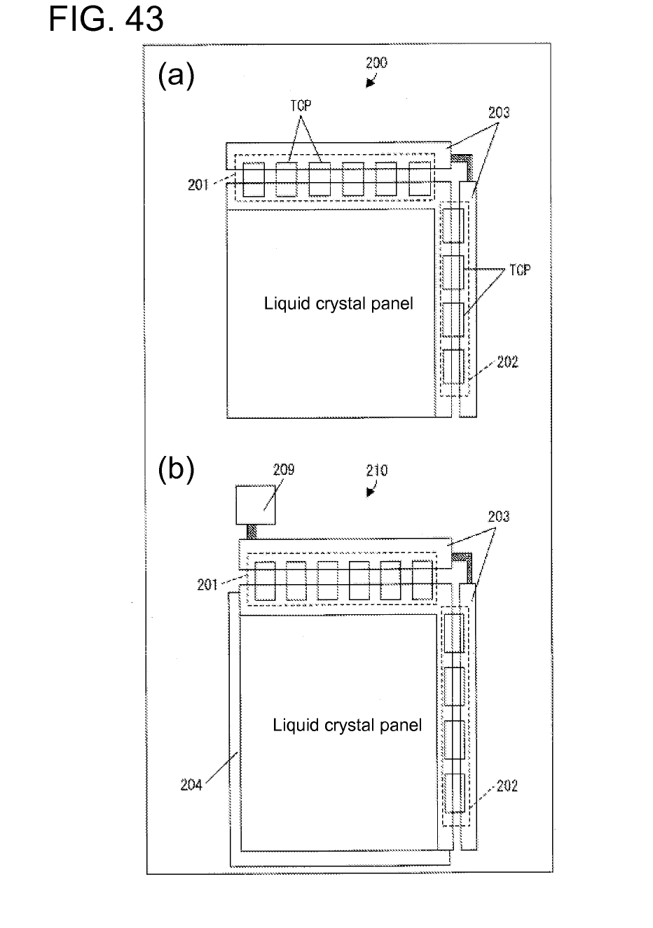

Lastly, configuration examples of a liquid crystal display unit and a liquid crystal display device of the present invention are described. In the embodiments discussed above, the present liquid crystal display unit and liquid crystal display device are configured as follows. That is, two polarizing plates A and B are attached on respective sides of the liquid crystal panel so that the polarizing axis of the polarizing plate A and the polarizing axis of the polarizing plate B cross each other at a right angle. For the polarizing plates, an optical compensation sheet or the like may be layered as necessary. Next, as shown in FIG. 43(a), drivers (gate driver 202 and source driver 201) are connected. Here, the configuration in which drivers are connected by TCP (Tape Career Package) system is described as an example.

First, ACF (Anisotropic Conductive Film) is temporarily pressure-bonded to the terminal section of the liquid crystal panel. Next, TCP with drivers mounted thereon is punched out from the carrier tape, aligned to the panel terminal electrode, and heated for permanent pressure-bonding. Then, a circuit substrate 203 (PWB: Printed Wiring Board), which is for coupling the driver TCPs, and TCP input terminals are connected together with ACF. The liquid crystal display unit 200 is thus complete. Subsequently, as shown in FIG. 43(b), a display control circuit 209 is connected to drivers (201 and 202) of the liquid crystal display unit through the circuit substrate 203 for unification with an illumination device (backlight unit) 204, to complete a liquid crystal display device 210.

The “polarity of the potential” herein refers to either the reference potential (positive) or higher, or the reference potential (negative) or lower. Here, the reference potential may be Vcom (common potential), which is the potential of the common electrode (opposite electrode), or any other potential.

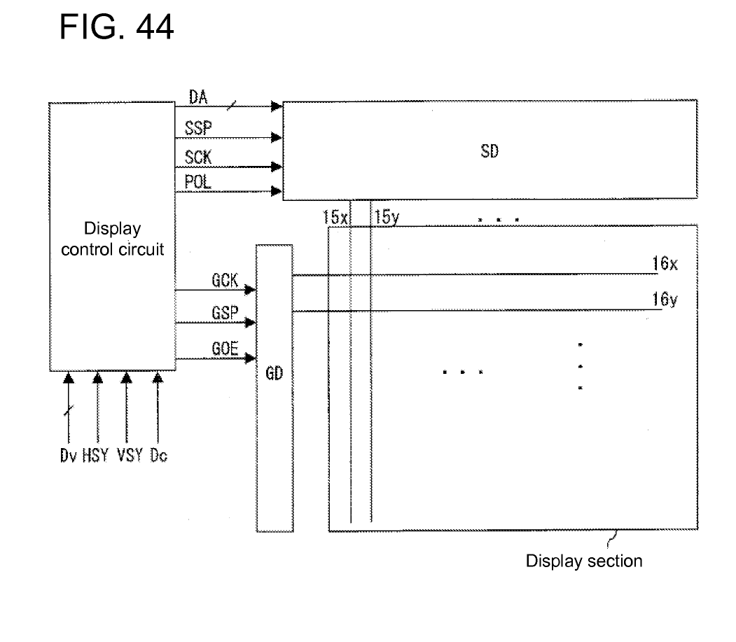

FIG. 44 is a block diagram showing the configuration of the present liquid crystal display device. As shown in the figure, the liquid crystal display device includes a display section (liquid crystal panel), a source driver (SD), a gate driver (GD), and a display control circuit. The source driver drives the data signal lines, the gate driver drives the scan signal lines, and the display control circuit controls the source driver and the gate driver.

The display control circuit receives from an external signal source (a tuner, for example) a digital video signal Dv representing images to be displayed, a horizontal synchronization signal HSY and a vertical synchronization signal VSY for the digital video signal Dv, and a control signal Dc for controlling the display action. Based on the received signals Dv, HSY, VSY, and Dc, the display control circuit generates: a data start pulse signal SSP; a data clock signal SCK; a charge share signal sh; a digital image signal DA (the signal corresponding to the video signal Dv) representing the image to be displayed; a gate start pulse signal GSP; a gate clock signal GCK; and a gate driver output control signal (scan signal output control signal) GOE, as signals for displaying images represented by the digital video signal Dv on the display section and outputs them.

In more detail, the video signal Dv is subjected to the timing adjustment and the like in the internal memory as necessary, and then is output from the display control circuit as a digital image signal DA. The display control circuit generates a data clock signal SCK, which is composed of pulses corresponding to the respective pixels of the images represented by the digital image signal DA; generates, based on the horizontal synchronization signal HSY, a data start pulse signal SSP, which shifts to a high level (H level) for a predetermined period of time for every horizontal scan period; generates, based on the vertical synchronization signal VSY, a gate start pulse signal GSP, which shifts to H level for a predetermined period of time for every frame period (one vertical scan period); generates a gate clock signal GCK based on the horizontal synchronization signal HSY; and generates the charge share signal sh and the gate driver output control signal GOE based on the horizontal synchronization signal HSY and the control signal Dc.

Among the signals generated by the display control circuit as described above, the digital image signal DA, the charge share signal sh, the signal POL for controlling the polarity of signal potentials (data signal potentials), the data start pulse signal SSP, and the data clock signal SCK are input to the source driver, and the gate start pulse signal GSP, the gate clock signal GCK, and the gate driver output control signal GOE are input to the gate driver.

The source driver sequentially generates analog potentials (signal potentials) corresponding to the pixel values of images represented by the digital image signal DA at respective scan signal lines for every horizontal scan period, based on the digital image signal DA, data clock signal SCK, charge share signal sh, data start pulse signal SSP, and polarity inversion signal POL, and outputs these data signals to the data signal lines (15x and 15x, for example).

The gate driver generates the gate-on pulse signals based on the gate start pulse signal GSP, the gate clock signal GCK, and the gate driver output control signal GOE, and outputs the signals to the scan signal lines to selectively drive the scan signal lines.

The data signal lines and the scan signal lines in the display section (liquid crystal panel) are driven by the source driver and the gate driver in the manner described above, and signal potentials are written from the data signal lines to the pixel electrodes through transistors (TFT) connected to the selected scan signal lines. Consequently, voltages are applied to the liquid crystal layer for respective sub-pixels, by which the amount of the light from the backlight that is transmitted is controlled, and images represented by the digital video signal Dv are displayed on respective sub-pixels.

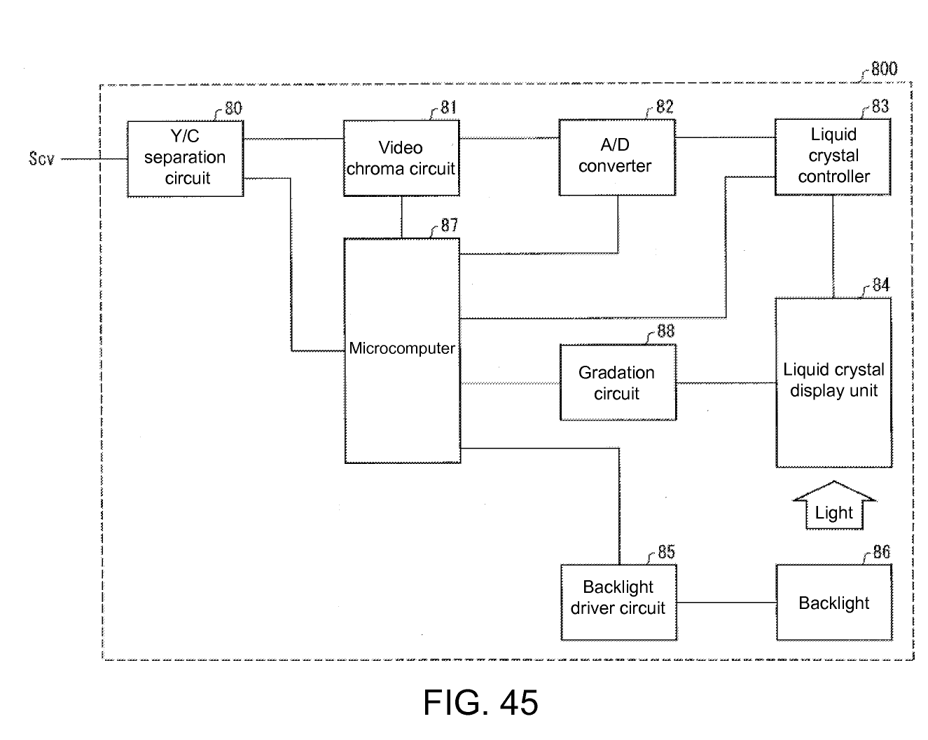

Next, a configuration example of the present liquid crystal display device as applied to a television receiver is described. FIG. 45 is a block diagram showing the configuration of a liquid crystal display device 800 for television receiver. The liquid crystal display device 800 includes a liquid crystal display unit 84, a Y/C separation circuit 80, a video chroma circuit 81, an A/D converter 82, a liquid crystal controller 83, a backlight driver circuit 85, a backlight 86, a microcomputer 87, and a gradation circuit 88. The liquid crystal display unit 84 is composed of a liquid crystal panel and a source driver and a gate driver for driving the liquid crystal panel.

In the liquid crystal display device 800 having a configuration described above, first, a composite color image signal Scv, which is a television signal, is input from outside to the Y/C separation circuit 80. There, the signal is separated into a luminance signal and a color signal. The luminance signal and the color signal are converted to an analog RGB signal corresponding to three primary colors of light by the video chroma circuit 81. Further, this analog RGB signal is converted to a digital RGB signal by the A/D converter 82. The digital RGB signal is input to the liquid crystal controller 83. In the Y/C separation circuit 80, horizontal and vertical synchronization signals are also obtained from the composite color image signal Scv, which is input from outside. These synchronization signals are also input to the liquid crystal controller 83 through the microcomputer 87.

To the liquid crystal display unit 84, the digital RGB signal is input from the liquid crystal controller 83, together with the timing signal based on the aforementioned synchronization signals at a predetermined timing. Also, in the gradation circuit 88, gradation potentials of respective three primary colors R, G, and B for color display are generated, and the gradation potentials are also supplied to the liquid crystal display unit 84. In the liquid crystal display unit 84, signals for driving (data signals=signal potentials, scan signals, and the like) are generated by the internal source driver, the gate driver, and the like based on the RGB signals, the timing signals, and gradation potentials. Based on the signals for driving, color images are displayed on the internal liquid crystal panel. In order for the images to be displayed by the liquid crystal display unit 84, the light needs to be radiated from behind the liquid crystal panel in the liquid crystal display unit. In the liquid crystal display device 800, the backlight driver circuit 85 drives the backlight 86 under the control of the microcomputer 87, and irradiates the back side of the liquid crystal panel with the light. Overall system control, including the processes described above, is conducted by the microcomputer 87. Not only image signals based on television broadcasting, but signals of images captured by cameras and of other images supplied via internet connection can also be used as image signals input from outside (composite color image signals). Thus, in the liquid crystal display device 800, image display based on various image signals is possible.

When the liquid crystal display device 800 is used to display images of television broadcasting, as shown in FIG. 46, a tuner unit 90 is connected to the liquid crystal display device 800 to constitute a television receiver 601. The tuner unit 90 extracts signals of the channel to be received from the waves (high frequency signals) received through an antenna (not shown), and converts the extracted signals to an intermediate frequency signal. The tuner unit 90 then detects the intermediate frequency signal to retrieve composite color image signal Scv as a television signal. The composite color image signal Scv is input to the liquid crystal display device 800 as described above. Images based on the composite color image signal Scv are displayed by the liquid crystal display device 800.

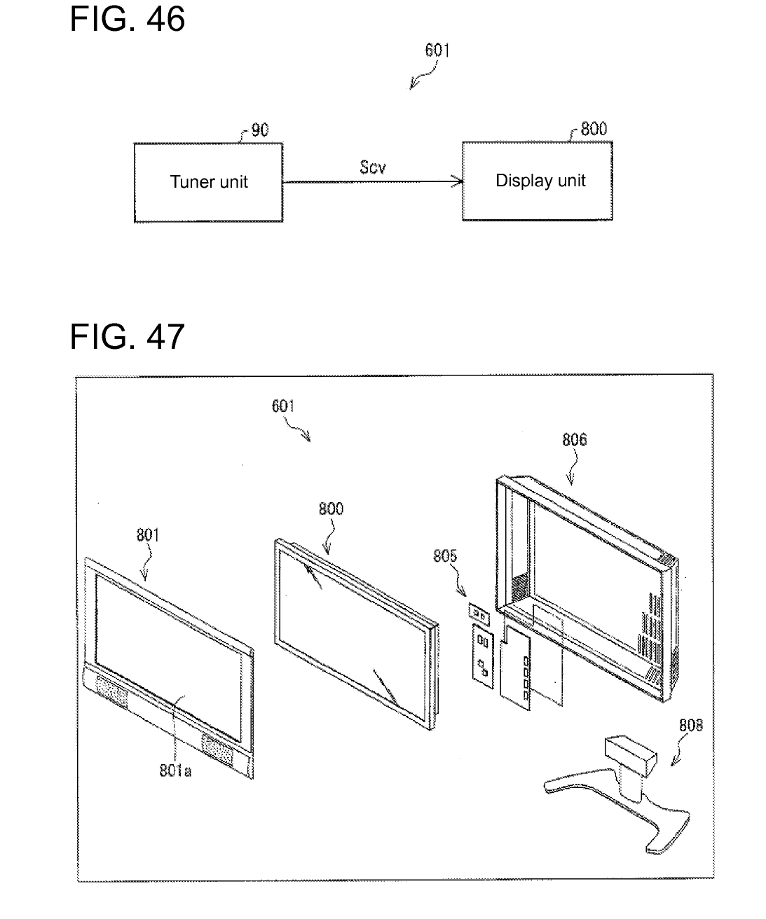

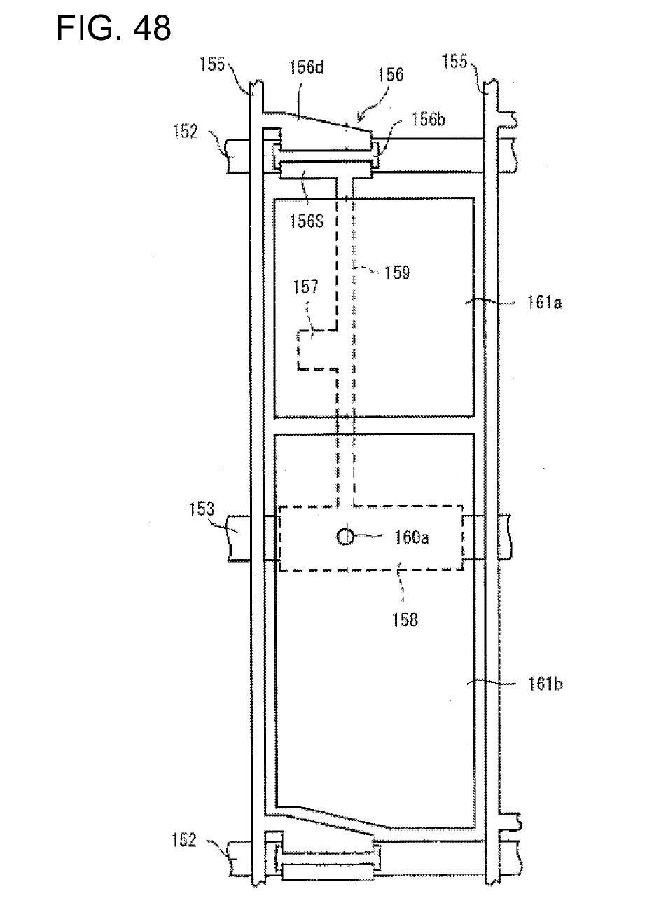

FIG. 47 is an exploded perspective view showing a configuration example of the present television receiver. As shown in the figure, the television receiver 601 includes a first case 801 and a second case 806, in addition to the liquid crystal display device 800, as its constituting elements, and the liquid crystal display device 800 is held in the first case 801 and the second case 806. In the first case 801, there is an opening portion 801a that transmits the image to be displayed on the liquid crystal display device 800. The second case 806 covers the back side of the liquid crystal display device 800. An operation circuit 805 for operating the display device 800 is provided in the second case 806, and a supporting member 808 is attached at the bottom of the second case 806.

The present invention is not limited to the embodiments described above. Any appropriate modifications of the embodiments described above based on the common technical knowledge, and any combinations of them are also included in embodiments of the present invention.

### INDUSTRIAL APPLICABILITY

An active matrix substrate of the present invention and a liquid crystal panel equipped with such an active matrix substrate are suitable for a liquid crystal television, for example.

### DESCRIPTION OF REFERENCE CHARACTERS

101-104 pixel
12a, 12c, 12A, 12C transistor
15x, 15y, 15z data signal line
16x, 16y scan signal line
17a, 17b, 17c, 17d pixel electrode
17A, 17B, 17C, 17D pixel electrode
17a′, 17b′, 17c′, 17d′ pixel electrode
17A′, 17B′, 17C′, 17D′ pixel electrode
18p, 18q, 18r, 18s storage capacitance wiring
21 organic gate insulating film
22 inorganic gate insulating film
24 semiconductor layer
25 inorganic interlayer insulating film
26 organic interlayer insulating film
27a drain lead-out wiring
37a, 37b, 137a capacitance electrode
38a, 38b capacitance electrode (second capacitance electrode)
57b capacitance electrode (third capacitance electrode)
39b, 39b′ storage capacitance electrode (conductive body)
41a contact hole (first contact hole)
42a contact hole (second contact hole)
43a contact hole (fourth contact hole)
44a contact hole (fifth contact hole)
51a thin film portion
67a contact hole (third contact hole)
84 liquid crystal display unit
601 television receiver
800 liquid crystal display device

1. An active matrix substrate, comprising a scan signal line, a data signal line, and a transistor connected to said scan signal line and said data signal line, wherein a first pixel electrode and a second pixel electrode are provided in a single pixel region, and said first pixel electrode is connected to said data signal line through said transistor, the active matrix substrate further comprising:
a capacitance electrode electrically connected to one of said first pixel electrode and said second pixel electrode,
wherein said capacitance electrode is connected to said one of said first and second pixel electrodes through first and second contact holes, and forms a capacitance with the other one of said first and second pixel electrodes, and
wherein one of conductive electrodes of said transistor is connected to said first pixel electrode through a third contact hole.

2. The active matrix substrate according to claim 1, wherein said one of the conductive electrodes of said transistor is formed in the same layer with said capacitance electrode.

3. The active matrix substrate according to claim 1, wherein at least a portion of said capacitance electrode overlaps with said other one of the pixel electrodes through an interlayer insulating film that covers a channel of said transistor.

4. The active matrix substrate according to claim 1,
wherein perimeters of said first and second pixel electrodes are constituted of a plurality of sides; one side of said first pixel electrode and one side of said second pixel electrode are adjacent to each other; and said capacitance electrode is disposed to overlap a portion of a gap between said adjacent sides, and to overlap a portion of said first pixel electrode and a portion of said second pixel electrode.

5. The active matrix substrate according to claim 1,
wherein said one of the conductive electrodes of said transistor and said capacitance electrode are isolated from each other,
wherein said capacitance electrode is connected to said first pixel electrode through said first and second contact holes, and
wherein a capacitance is formed between said capacitance electrode and said second pixel electrode.

6. The active matrix substrate according to claim 1, wherein said capacitance electrode is connected to said second pixel electrode through first and second contact holes, and forms a capacitance with said first pixel electrode.

7. The active matrix substrate according to claim 1, wherein said first and second pixel electrodes are disposed in a column direction, while the scan signal line extends in a row direction.

8. The active matrix substrate according to claim 7,
wherein, with respect to two pixel regions disposed adjacent to each other in the row direction, said first pixel electrode in one of the pixel regions and said second pixel electrode in the other one of the pixel regions are adjacent to each other in the row direction.

9. The active matrix substrate according to claim 1, wherein said first pixel electrode surrounds said second pixel electrode.

10. The active matrix substrate according to claim 1, wherein said second pixel electrode surrounds said first pixel electrode.

11. The active matrix substrate according to claim 1, further comprising a storage capacitance wiring that forms a capacitance with said one of the pixel electrodes or a conductive body electrically connected to said one of the pixel electrodes, and that forms a capacitance with said other one of the pixel electrodes or a conductive body electrically connected to said other one of the pixel electrodes.

12. The active matrix substrate according to claim 11, wherein said storage capacitance wiring extends in the same direction as the scan signal line, passing through the center of said pixel region.

13. The active matrix substrate according to claim 11, wherein said capacitance electrode forms a capacitance with said storage capacitance wiring.

14. The active matrix substrate according to claim 3,
wherein said interlayer insulating film is composed of an inorganic insulating film and an organic insulating film that is thicker than the inorganic insulating film, and
wherein said organic insulating film is removed at least from a portion of an area where said interlayer insulating film overlaps with said capacitance electrode.

15. The active matrix substrate according to claim 14,
wherein said interlayer insulating film has a thin film portion from which said organic insulating film is removed, the thin film portion including a region overlapping with a portion of said capacitance electrode, and
wherein said capacitance electrode is disposed along a direction in which the scan signal line extends, and said capacitance electrode extends across two sides of said thin film portion that are facing each other.

16. The active matrix substrate according to claim 15, wherein said thin film portion overlaps with either said first or second pixel electrode.

17. The active matrix substrate according to claim 1, wherein a gap between said first and second pixel electrodes functions as an alignment control structure.

18. The active matrix substrate according to claim 1,
wherein said first pixel electrode surrounds said second pixel electrode,
wherein a perimeter of said second pixel electrode includes two sides that are parallel to each other,
wherein a perimeter of said first pixel electrode includes a side facing one of said two sides through a first gap, and a side facing the other of said two sides through a second gap, and
wherein said capacitance electrode is disposed to extend across said first gap and said second gap, and to overlap a portion of said first pixel electrode and a portion of said second pixel electrode.

19. The active matrix substrate according to claim 1, further comprising:
a third pixel electrode electrically connected to said first pixel electrode in said one pixel region, in addition to the first and second pixel electrodes, wherein said capacitance electrode is connected to said first pixel electrode through the first and second contact holes, and forms a capacitance with said second pixel electrode; and
a second capacitance electrode that is connected to said third pixel electrode through fourth and fifth contact holes and that forms a capacitance with said second pixel electrode.

20. The active matrix substrate according to claim 1, further comprising:
a third pixel electrode that is electrically connected to said first pixel electrode in said single pixel region in addition to the first and second pixel electrodes, wherein said capacitance electrode is connected to said second pixel electrode through the first and second contact holes, and forms a capacitance with said first pixel electrode; and
a second capacitance electrode that is connected to said second pixel electrode through fourth and fifth contact holes, and that forms a capacitance with said third pixel electrode.

21. The active matrix substrate according to claim 1, further comprising:
a third pixel electrode in said single pixel region, in addition to the first and second pixel electrodes, wherein said capacitance electrode is connected to said first pixel electrode through the first and second contact holes, and forms a capacitance with said second pixel electrode; and
a second capacitance electrode that is connected to the first pixel electrode through fourth and fifth contact holes, and that forms a capacitance with said third pixel electrode.

22. The active matrix substrate according to claim 1, further comprising:
a third pixel electrode in said single pixel region, in addition to the first and second pixel electrodes,
wherein said capacitance electrode is connected to said second pixel electrode through the first and second contact holes, and forms a capacitance with said first pixel electrode; and
a second capacitance electrode that is connected to said third pixel electrode through fourth and fifth contact holes, and that forms a capacitance with said first pixel electrode.

23. The active matrix substrate according to claim 19, further comprising first and second storage capacitance wirings in said pixel region,
wherein said capacitance electrode forms a capacitance with said first storage capacitance wiring, and said second capacitance electrode forms a capacitance with said second storage capacitance wiring.

24. The active matrix substrate according to claim 1, wherein said capacitance electrode is formed in the same layer with said scan signal line.

25. The active matrix substrate according to claim 24, wherein said capacitance electrode overlaps the other one of said pixel electrodes through a gate insulating film that covers said scan signal line and an interlayer insulating film that covers a channel of said transistor.

26. The active matrix substrate according to claim 25, further comprising a third capacitance electrode that overlaps said capacitance electrode through said gate insulating film and that is electrically connected to said other one of said pixel electrodes, wherein said capacitance electrode forms a capacitance with said third capacitance electrode.

27. The active matrix substrate according to claim 26, wherein said third capacitance electrode overlaps said other one of said pixel electrodes through said interlayer insulating film.

28. The active matrix substrate according to claim 26, wherein said third capacitance electrode is electrically connected to said other one of said pixel electrodes through two contact holes.

29. The active matrix substrate according to claim 25, wherein said capacitance electrode and said one of said pixel electrodes are connected to each other through said first and second contact holes running through said gate insulating film and said interlayer insulating film.

30. A liquid crystal panel comprising the active matrix substrate according to claim 1.

31. A liquid crystal display unit comprising the liquid crystal panel according to claim 30 and drivers.

32. A liquid crystal display device comprising the liquid crystal display unit according to claim 31 and a light source device.

33. A television receiver comprising the liquid crystal display device according to claim 32 and a tuner unit receiving television broadcasting.
